(19) United States
(12) Patent Application Publication
(10) Pub. No.: US 2024/0412460 A1
(43) Pub. Date: Dec. 12, 2024

(54) SYSTEMS, APPARATUSES, INTERFACES, AND METHODS FOR VIRTUAL CONTROL CONSTRUCTS, EYE MOVEMENT OBJECT CONTROLLERS, AND VIRTUAL TRAINING

(71) Applicant: QUANTUM INTERFACE, LLC, Austin, TX (US)

(72) Inventors: Jonathan Josephson, Austin, TX (US); Robert W. Strozier, Houston, TX (US)

(21) Appl. No.: 16/625,553

(22) PCT Filed: Jun. 21, 2018
(86) PCT No.: PCT/US2018/038803

§ 371 Date: Aug. 31, 2022

Related U.S. Application Data
(60) Provisional application No. 62/523,066, filed on Jun. 21, 2017.
(60) Provisional application No. 62/529,362, filed on Jul. 6, 2017.
(60) Provisional application No. 62/545,928, filed on Aug. 15, 2017.
(60) Provisional application No. 62/545,929, filed on Aug. 15, 2017.
(60) Provisional application No. 62/546,651, filed on Aug. 17, 2017.
(60) Provisional application No. 62/546,997, filed on Aug. 17, 2017.

(51) Int. Cl. G06T 19/00; G06F 3/01

(52) U.S. Cl. CPC G06T 19/00; G06F 3/013; G06F 3/017

(57) ABSTRACT

Apparatuses, systems, interfaces, and methods for implementing the apparatuses, systems, and interfaces include: (a) a dynamic 3D environment generation subsystem including an eye or head tracking device, one or more motion sensors, one or more processors, and one or more display devices displaying bands superimposed on environment with bands that control movement through the environment; (b) training systems where trainer and trainee movement are superimposed and scaled to improve movement conformity and mastery of movements; and (c) eye or head tracking systems for selecting/activating/confirming icons or objects based on motion and micro duration holds.

### RELATED APPLICATIONS

This application is a 35 U.S.C. & 371 National Phase Application of PCT/US 18/38803 filed Jun. 21, 2018 published as WO/2018/237172 on Dec. 27, 2018, which is claims the benefit of and priority to U.S. Provisional Patent Application Ser. Nos. (a) 62/523,066 filed Jun. 21, 2017 (21 Jun. 2017); (b) 62/529,362 filed Jul. 6, 2017 (6 Jul. 2017); (c) 62/545,928 Aug. 15, 2017 (15 Aug. 2017); (d) 62/545,929 filed Aug. 15, 2017 (15 Aug. 2017); (e) 62/546,651 filed Aug. 17, 2017 (17 Aug. 2017); and (f) 62/546,997 filed Aug. 17, 2017 (17 Aug. 2017).

### BACKGROUND OF THE DISCLOSURE

### 1. Field of the Disclosure

Embodiments of this disclosure relate to systems, apparatuses, and/or interfaces and methods for implementing them on or in a computer, where the systems, apparatuses, and/or interfaces and methods of interacting with 3D or nD environments using at least two user interface devices. Embodiments of this disclosure relate to systems, interfaces, apparatuses including the interfaces, and methods for implementing the systems, apparatuses, and interfaces, where the systems and interfaces permit motion-based mimicking techniques and motion-based virtual training. Embodiments of the present disclosure relate to interfaces, systems and methods using motion based eye tracking.

More particularly, embodiments of this disclosure relate to systems, apparatuses, and/or interfaces and methods for implementing them on or in a computer, where the systems, apparatuses, and/or interfaces and methods of interacting with 3D or n-dimensional (nD) environments using at least two user interface devices, where the systems, apparatuses, and/or interfaces include at least one motion sensor, at least one processing unit, and at least two user feedback unit for controlling, interacting, and manipulating motion in 2D, 3D, and/or nD environments. Embodiments of this disclosure relate to systems, interfaces, apparatuses including the interfaces, and methods for implementing the systems, apparatuses, and interfaces, where the systems and interfaces permit mimicking techniques and motion-based processing to enhance virtual training, where the method implementing the systems includes capturing an exercise performed by the trainee and the trainer, overlaying the captured trainee exercise onto the capture trainer exercise, constructing a polygon fitted surface or a tessellated surface representation of the trainee and the trainer, scaling the representations (time and space), running the scaled, tessellated, overlay representations through the captured exercises, comparing the two exercises to illustrate differences, and repeating the step until the trainee movements conform or substantially conform to the trainer movements, all controlled using motion based processing. Embodiments of the present disclosure relate to interfaces, systems and methods using motion based eye tracking, wherein the interface includes at least one eye tracking sensor, at least one processing unit, at least one display devices, and a power supply and the methods receive sensor data corresponding to eye motion from the sensor and processing the eye motion into command functions to scroll through plurality of icons or object displayed on the screen, to select an icon or object based on motion or motion and micro duration holds, to select and activate based on motion, or motion and micro duration holds, and/or to select, activate, attribute control, and confirm based on motion, or motion and micro duration holds.

### 2. Description of the Related Art

Selection interfaces are ubiquitous throughout computer software and user interface software. Most of these interfaces require motion and selection operations controlled by hard selection protocols such as tapping, clicking, double tapping, double clicking, keys strokes, gestures, or other so-called hard selection protocols.

In previous applications, the inventor and inventors have described motion based systems and interfaces that utilize motion and changes in motion direction to invoke command functions such as scrolling and simultaneously selection and activation commands. See for example U.S. Pat. Nos. 7,831,932 and 7,861,188, incorporated herein by operation of the closing paragraph of the specification.

More recently, the inventor and inventors have described motion based systems and interfaces that utilize velocity and/or acceleration as well as motion direction to invoke command functions such as scrolling and simultaneously selection and activation commands. See for example U.S. Provisional Patent Application Ser. No. 61/885,453 filed Oct. 1, 2013 (1 Oct. 2013).

While there are many systems and interfaces for permitting users to select and activate a target object(s) from lists and/or sublists of target object(s) using movement properties, where the movement properties act to discriminate and attract or manipulate or influence the target object(s) or attributes of target object(s). Multiple layers of objects may have attributes changes, where the attribute of one layer may be different or to a different degree than other layers, but they are all affected and relational in some way.

Many interfaces have been constructed to interact with, control, and/or manipulate objects and attributes associated therewith so that a user is better able to view, select and activate objects and/or attributes.

Recently, motion based interfaces have been disclosed. These interfaces use motion as the mechanism for viewing, selecting, differentiating, and activating virtual and/or real objects and/or attributes. However, there is still in need in the art for improved motion based interfaces that present dynamic environments for viewing, selecting, differentiating, and activating virtual and/or real objects and/or attributes based on object and/or attribute properties, user preferences, user recent interface interactions, user long term interface interactions, or mixtures and combinations thereof.

While many systems and methods have been purposed for allowing users to interact with virtual reality environments, there is still a need in the art for improved systems and methods for training and mimicking systems. While many systems and methods have been purposed for allowing users to interact with virtual reality environments, there is still a need in the art for improved systems and methods for interacting with virtual reality environments.

### SUMMARY OF THE DISCLOSURE

General Systems, Apparatuses, and/or Interfaces

Embodiments of this disclosure provide systems, apparatuses, and/or interfaces and methods for implementing them on or in a computer, a computer system, or a distributed computing environment, where the systems, apparatuses, and/or interfaces include at least one (one or a plurality of) user feedback unit, at least one motion sensor having active sensing zones or active viewing fields, and at least one processing unit in communication with the at least on user feedback unit and the at least one motion sensor and utilize motion or movement properties sensed by the at least one motion sensor, solely or partially, to control one or more real and/or virtual objects and/or their attributes. These objects may be real or virtual things, zones, volumes, entities, attributes, and/or characteristics or represent real devices and/or attributed associated therewith. The systems, apparatuses, and/or interfaces may also attract, repulse, or otherwise effect object due to other objects being moved in an attractive manner, a repulsive manner, or a combination thereof, or based upon an angle or proximity to a particular object or objects.

### Methods

Embodiments of this disclosure provide methods for implementing the systems, apparatuses, and/or interfaces including the steps of sensing movement via the at least one motion sensor, selecting and activating selectable objects, selecting and activating members of a selectable list of virtual and/or real objects, selecting and activating selectable attributes associated with the objects, selecting and activating and adjusting selectable attributes, zones, areas, or combinations thereof, where the systems, apparatuses, and/or interfaces include at least one user feedback unit, at least one motion sensor (or data received therefrom), at least one processing unit in communication with the user feedback units and the motion sensors or receive motion sensor data and a virtual control construct. The methods include the step of determining movement within different zones of virtual control construct and outputting output signals associated therewith to the at least one processing unit to control objects in 3D or nD environments.

Embodiments of this disclosure provide methods for implementing the systems, apparatuses, and/or interfaces including the steps of sensing movement via the at least one motion sensor, selecting and activating selectable objects, selecting and activating members of a selectable list of virtual and/or real objects, selecting and activating selectable attributes associated with the objects, selecting and activating and adjusting selectable attributes, zones, areas, or combinations thereof, where the systems, apparatuses, and/or interfaces include at least one user feedback unit, at least one motion sensor (or data received therefrom), at least one processing unit in communication with the user feedback units and the motion sensors or receive motion sensor data and an optional handheld controller. The methods include the steps of detecting movement or the controller and/or pressure on one or a plurality of areas or regions on the controller and outputting output signals associated therewith to the at least one processing unit to control objects in 3D or nD environments.

### Systems, Methods and Interfaces Including at Least Two User Feedback Devices

Embodiments of this disclosure relate to systems, apparatuses, and/or interfaces and methods for implementing them on or in a computer, where the systems, apparatuses, and/or interfaces and methods are constructed to interact with 3D or n-dimensional (nD) environments using at least two user interface devices.

The systems, apparatuses, and/or interfaces include at least one motion sensor, at least one processing unit, and at least two user feedback units. The systems, apparatuses, and/or interfaces permit the control, interact, manipulate, traverse, and/or navigate 2D, 3D, and/or nD environments. The feedback units generally comprise a display device and an eye and/or head tracking device, where each devices includes a cursor controlling, interacting with, manipulating, traversing, and/or navigating a 2D, 3D, or nD environment.

Embodiments of this disclosure provide apparatuses comprising an interface configured to receive first input corresponding to first movement of at least one cursor in a handheld controller or virtual version thereof controlling device; and
receiving second input corresponding to moving the device within a VR or AR
environment corresponding to the device moving in the real world; and a processor configured to:
initiate at a display device, display of the device in the environment; and
initiate, at the display device, display of an indication that the device has moved in
the real world in accord with the movement in the environment.
   In other embodiments, the apparatuses further comprise the display device. In other embodiments, the first input and the second input are received from the same input device. In other embodiments, the apparatuses further comprise the input device. In other embodiments, the input device comprises an eye tracking device or a motion sensor. In other embodiments, the first input is received from a first input device and wherein the second input is received from a second input device that is distinct from the first input device.

### Apparatuses and Systems

Embodiments of this disclosure provide motion-based apparatuses and/or systems for pre selecting attributes and/or combinations of attributes before assigning or being associating with a selectable object or a plurality of selectable objects, or selecting a selectable object or a plurality of selectable objects and setting attributes associated with one, some or all of the selected selectable objects based on movement in directions that are associated with the attributes. Because these attribute control objects are associated with movement directions, these attribute control objects comprise directionally activatable attributes or attribute objects—meaning that the attribute control objects are associated with specific movement directions, which may be pre-set or pre-defined or assigned when a selectable object is pre-selected from attribute setting or before the intended object is selected. The apparatuses and/or systems include at least one motion sensor having at least one active zone or output from at least one motion sensor having at least one active zone, at least one processing unit, at least one user interface, and at least one real and/or virtual object under control thereof, where some or all of the components are in one-way or two-way communication with each other depending on the configuration of the apparatuses and/or systems. In certain embodiments, the at least one user interface include at least one user feedback unit, where the at least one user feedback unit permits user discernible output and computer discernible input. Each motion sensor, processing unit, user interface, and the real object may include its own source of power or the apparatuses and/or systems may include at least one power supply, at least one battery backup, and/or communication software and hardware. Each motion sensor detects movement within its active sensing zone(s), generates a sensor output signal(s), and sends or forwards the output signal(s) to the at least one the processing unit. The at least one processing unit converts the output signal(s) into command and control outputs. Of course, these components, the user interfaces, the user feedback units, the motion sensors, and the processing units, may all be combined in whole or part. The command and control outputs may include start commands, which activate the user interfaces, the user feedback units and may generate a user discernible selection or cursor object. User discernible means that the selection or cursor object is capable of being sensed by one of the five senses of an animal or a human, e.g., visual, audio, audiovisual, tactile, haptic, touch, (or other skin contact), neurological, temperature (e.g., hot or cold), smell or odor, taste or flavor, and/or any combination thereof. However, the selection or cursor object may also be invisible and/or non-discernible—just a virtual element used internally in applying the sensed motion or movement.

### Methods

Embodiments of this disclosure provide methods for implementing the selection protocol using the apparatuses and/or systems of this disclosure. The methods include activating the apparatuses or systems by detecting movement within an active zone of a motion sensor sufficient to satisfy one activation movement threshold criterion or a plurality of activation movement threshold criteria causing activation of the apparatuses or systems. After activation, the methods may cause the apparatuses or systems to populate a user feedback unit of a user interface with one or a plurality of selectable objects and optionally, a visible selection object. Once populated, the methods include monitoring the motion sensors for movement. If the sensed movement is sufficient to satisfy one selection movement threshold criterion or a plurality of selection movement threshold criteria, then a direction of the movement is used to select attributes and combinations of attributes before assigning or being associating with objects, or to pre-select one of the selectable objects. If the movement direction is insufficient to discriminate between a particular selectable object from others selectable objects, then additional movement may be required to discriminate between the selectable objects in the general direction of the motion until the particular or desired selectable object is ascertained. Once a particular or desired selectable object has been determined, the methods cause the desired selectable object to be pre-selected, referred to here as the pre-selected object, and changes a location and/or one or more attributes and/or display attributes of the pre-selected object. The methods may also lock out or freeze out the non-pre-selected objects and changes locations and/or one or more display attributions of the non-pre-selected objects. For example, the pre selected object may move to the center and undergo a change in one or a plurality of display attributes, while the non-pre-selected object may fade or undergo other changes to their attributes, display attributes and/or move to the edges of a display area of the user feedback unit. After or simultaneously, the methods display attributes associated with the pre-selected object within the display area and may assign a direction to each of its attributes turning them into directionally activatable attributes or attribute control objects. These directionally activatable attributes or attribute control objects need not be actually displayed as long as a direction is associated with each one. Additionally, the directionally activatable attributes or attribute objects may be set through the above outline selection process before the attributes are actually associated with an object. This pre setting directionally activatable attributes or attribute objects maybe general attributes that may later be associated with one or more specific objects. Now that directions have been associated with the pre-selected object attributes, the methods use further sensed movement satisfying one selection movement threshold criterion or a plurality of selection movement threshold criteria to activate the directionally activatable attributes or attribute objects in accord with a direction of the further sensed movement. If the movement is continuous, then directional components of the motions are determined and correlated with the directions of the directionally activatable attributes or attribute objects so that the apparatuses or systems will activate the directionally activatable attributes or attribute objects in the sequence determined from the movement component sequence and process the activated directionally activatable attribute or attribute object. Further movement may permit adjustment of a value of the attribute if the attribute is an adjustable attribute or selection of a member of a list if the attribute is a table of setting or drilling down a list or menu tree if the attribute is a menu and then adjusting or setting an adjustable or settable attribute. Alternatively, the movement may be stepwise, where the movement stops and the direction is correlated with a given directionally activatable attribute or attribute object and that attribute is activated and acted upon further as needed. At any time, the movement may activate a back function, a reset function, a set function, a set and activate function, or an exit function. The back function, send control back one step at a time or multiple steps depending on the manner in which the back function is activated—fast movement toward, slow movement toward, movement toward an hold, etc. The reset function resets the systems or apparatuses back to the point where the display area displays the selectable objects or any predetermined point. The set function sets the values of the directionally activatable attributes or attribute objects and resets the systems and apparatuses back to the point where the display area displays the selectable objects or any desired or predetermined point, using contextual values, environmental values or any other values or combinations of values that create a criteria for set points, attributes or other predetermined intended actions or criteria. The exit function exits the systems and set the system back to sleep mode.

### Virtual Training

Embodiments of this disclosure provide methods including (a) receiving the trainee images and/or image sequences and trainer images and/or image sequences from at least one motion sensor, (b) overlaying the captured trainee images and/or image sequence onto the capture trainer images and/or image sequences in at least one processing unit, (c) constructing a polygon fitted surface or a tessellated surface representation of the trainee and the trainer in the at least one processing unit, (d) applying the trainee surface representation to the trainee images and/or image sequence and the trainer surface representation to the trainer images and/or image sequence to construct a trainee polygon fitted or tessellated surface images and/or polygon fitted or tessellated surface image sequence and a trainer polygon fitted or tessellated surface images and/or polygon fitted or tessellated surface image sequence in the at least one processing unit, (e) time and space scaling the trainee polygon fitted or tessellated surface images and/or polygon fitted or tessellated surface image sequence and the trainer polygon fitted or tessellated surface images and/or polygon fitted or tessellated surface image sequence in the at least one processing unit, (f) overlaying the scaled trainee polygon fitted or tessellated surface images and/or polygon fitted or tessellated surface image sequence onto the scaled trainer polygon fitted or tessellated surface images and/or polygon fitted or tessellated surface image sequence in the at least one processing unit, (g) comparing the trainee and the trainer scaled polygon fitted or tessellated surface images and/or polygon fitted or tessellated surface image sequences to illustrate differences, and repeating the step until the trainee movements conform or substantially conform to the trainer movements in the at least one processing unit. The invocation and manipulation of all aspects of the method are performed via motion based processing without the need for a hard invocation protocol such as a mouse click, a tap on a screen, or similar interrupt driven execution protocol or process.

### General Systems, Apparatuses, Interfaces, and Methods

Embodiments of this disclosure relate to systems, apparatuses, interfaces, and methods of this disclosure for implementing the systems, apparatuses, and/or interfaces are based on attractive or manipulative selection invoked solely and partially by motion sensed by motion sensors associated with the systems, apparatuses, and/or interfaces. The manipulative selection actions may be attractive, repulsive, or a relative affect due to other objects being moved in an attractive manner, a repulsive manner, an influencing manner, or a combination thereof, or based upon an angle or proximity to a desired object or objects. The systems, apparatuses, and/or interfaces account for the manipulative effects based upon proximity, direction, angle, distance/displacement, duration, velocity and/or acceleration of at least one selection object toward a desired object or set of objects. The objects may comprise real or virtual objects, real world devices, software, software components, attributes, active areas of sensors, and/or fields of EMF or other waveforms or any controllable thing and may be remotely controlled. The motion of the selection object or objects may be a machine, an animal or a body part or parts thereof, a human or a body part or parts thereof, or a real world item, a field, matter, or a waveform under the control of a human, a machine, an animal, or a software program or a software system.

### General Apparatuses and Systems

Embodiments of this disclosure provide systems, apparatuses, and/or interfaces for selecting and activating virtual and/or real objects and/or subobject and/or attributes associated therewith. The apparatuses include at least one user interface. The interfaces include at least one (one or a plurality of) user feedback unit (feedback units may be devices, systems or feedback methods), at least one motion sensor having active sensing zones or active view fields, and at least one processing unit in communication with the user feedback units, and the motion sensors. The interfaces may also include at least one power supply, at least one battery backup, and communications software and hardware for remote control and/or remote monitoring. The motion sensors detect motion or movement within their active sensing zones, generate sensor output signals, and send or forward the output signals to the processing units. The processing units convert the output signals into command and control outputs. Of course, these components, user interfaces, user feedback units, motion sensors, and processing units, may all be combined in whole or part. The apparatuses may also include at least one object, real or virtual (i.e., the object may be an physical or virtual (software) attribute as well, or a combination thereof), under the control of the apparatus via the processing units. The command and control outputs may include start commands, which activate the user interface, the user feedback units and may generate a user discernible selection or cursor object. By user discernible the inventor means that the selection or cursor object is capable of being sensed by one of the five senses of an animal or a human, e.g., visual, audio, audiovisual, tactile or touch, hot or cold, smell or odor, taste or flavor, neurological, or any combination thereof. However, the selection or cursor object may also be invisible and/or non-discernible—just a virtual element used internally in applying the sensed motion or movement, and may also be an area or volumetric zone or representation of a zone.

Once activated, the user interfaces via the user feedback units may also display at least one selectable object, groups of objects or zones. Alternatively, once activated, movement of the selection object will cause a selectable object or a group of selectable objects or a pre-selected selectable object or a group of pre-selected selectable objects or zone to appear, to move toward the selection object, or to move at an angle to the selection object, or away from the selection object for the purpose of eventually choosing a particular selectable object or a particular group of selectable objects or selectable subobjects and/or attributes associated with particular object(s) or controllable attributes associate with particular object(s). The pre-selected selectable object or the group of pre selected selectable objects are the displayed object(s) that are most closely aligned with the movement and/or movement properties of the selection object or the movement and/or movement properties without visible a selection object. For examples, if the sensed initial motion or movement was in the +y direction, then the user interface may cause the user feedback unit(s) to evidence those selectable objects that are associated with the +y direction and attract those in the specific direction toward the selection object. The selection object may be visualized on a display, or indicated in any other means or may be invisible tied to the movement such as by sound in a 2D, 3D, a virtual reality (VR) environment or augmented reality (AR), or not be represented as an object at all—the user may see the effect of the movement on the objects and be able to infer the affected area based on the movement.

### Methods

Embodiments of this disclosure provide methods for implementing the selection protocol using the user interfaces of this disclosure. The methods include selecting and activating selectable objects, selecting and activating members of a selectable list of virtual and/or real objects, selecting and activating selectable attributes associated with the objects, selecting and activating and adjusting selectable attributes, zones, areas, or combinations thereof, where the interfaces include at least one display or other user feedback unit, at least one motion sensor (or data received therefrom), and at least one processing unit in communication with the user feedback units and the motion sensors or motion sensor data. The interfaces also may include power supplies, battery backups, and communications software and hardware for remote control and/or remote monitoring. The methods include sensing motion or movement sensed by the motion sensor(s), generating an output signal and sending the output signal to the processing unit. The methods also include converting the output signal into a command output via the processing unit. The command output may be a start command, which activates the feedback unit or activates the feedback unit and generates at least one selection or cursor object or activates the feedback unit and generates at least one selectable object or activates the feedback unit and generates at least one selection or cursor object and at least one selectable object. The selection object may be discernible or not (displayed or not). The motion may be generated by an animal or body part or parts, a human or body part or parts, a machine, or a real world object under control of an animal, a human, or a robot or robotic system, especially when the motion being sensed is within a 3D active sensing volume or zone. Once activated, the methods monitor sensed motion or movement within the active zone(s) of the motion sensor(s), which is used to move the selection object on or within the user feedback unit in accord with the motion properties (direction, angle, distance/displacement, duration, velocity, acceleration, and changes of one or more of these properties) toward a selectable object or a group of selectable objects or a pre-selected object or a group of pre-selected objects, zones or areas. At the same time, the methods either move the non-selected objects away from the selection object(s), cause the non-selected object to fade, disappear or other change other properties of the non-selected objects, or combinations thereof. The pre-selected object or the group of pre-selected objects are the selectable object(s) that are most closely aligned with the direction of motion of the selection object.

### General Eye/Head Tracking Apparatuses, Systems, and Interfaces

In certain embodiments the interface operates as follows. The at least one eye tracking sensor senses eye motion or movement as the eye, eyes, or head traverse a plurality of selectable icons or objects displayed on the at least one display device. The at least one processing unit may be configured to receive an output signal(s) from the at least one eye tracking senor as the eye, eyes, and/or head traverse the icons or objects. The at least one processing unit may also be configured to (1) immediately activate a particular icon or object, when the eye movement moves in, on, or at the particular icon or object; or (2) activate a particular icon or object, when the eye movement moves in, on or at the particular icon or object and stops for a microhold in, on, or at the particular icon or object. The at least one processing unit may also be configured to display a list of attribute icons or object, if the particular object or icon has associated attributes. The at least one processing unit may also be configured to receive output signal(s) from the at least one eye tracking sensor relating to further eye movement towards a particular attribute icon and to activate the attribute icon. The particular attribute icon may be (1) an adjustable attribute so that further eye movement in one direction will increase the value of the attribute, while eye movement the opposite direction will decrease the value of the attribute, (2) the particular attribute icon may be associated with a sublist, where further eye movement towards as item in the sublist will activate the item, or (3) the particular attribute icon may be associated with values set for in a matrix format, where further eye movement in, on, or at a matric location will set the attribute value. In certain, embodiments, the at least one processing unit may also highlight a particular icon or object, when the eye movement moves in, on, or at the particular icon or object, where the highlighting may be enlargement or any other highlighting effect the will discriminate the particular icon or object from the other icons or displays. Additionally, the enlargement may cover non-selected icon or objects that are deactivated by the eye movement in, on, or at the particular icon or object.

In other embodiments the interface operates as follows. The at least one eye tracking sensor senses eye motion or movement as the eye, eyes, or head traverse a plurality of selectable icons or objects displayed on the at least one display device. The at least one processing unit may be configured to receive an output signal(s) from the at least one eye tracking senor as the eye, eyes, and/or head traverse the icons or objects. The at least one processing unit may also be configured to highlight a particular icon or object, when the eye movement moves in, on, or at the particular icon or object. The at least one processing unit may also be configured to (1) receive further eye movement in, on, or at a portion of the highlighted icon or object to confirm the selection of the particular icon or object; and (2) activate the particular icon or object after eye movement confirmation. Alternately, the at least one processing unit may also be configured to (1) receive further eye movement in, on, or at a area or portion of the highlighted icon or object to confirm selection; and (2) to immediately activate the particular icon or object. In another alternative, the at least one processing unit may also be configured to (1) receive further eye movement in, on, or at a portion of the highlighted icon or object and stop for a microhold to confirm selection; and (2) activate the particular icon or object after the microhold confirmation. The at least one processing unit is also configured to display a list of attribute icons or object, if the particular object or icon has associated attributes. The at least one processing unit is also configured to receive output signal(s) from the at least one eye tracking sensor relating to further eye movement towards a particular attribute icon and to activate the attribute icon and a microhold in, on, or at the particular attribute icon. The particular attribute icon may be (1) an adjustable attribute so that further eye movement in one direction will increase the value of the attribute, while eye movement the opposite direction will decrease the value of the attribute, (2) the particular attribute icon may be associated with a sublist, where further eye movement towards as item in the sublist will activate the item, or (3) the particular attribute icon may be associated with values set for in a matrix format, where further eye movement in, on, or at a matric location will set the attribute value. In certain, embodiments, the at least one processing unit may also highlight a particular icon or object, when the eye movement moves in, on, or at the particular icon or object, where the highlighting may be enlargement or any other highlighting effect the will discriminate the particular icon or object from the other icons or displays. Additionally, the enlargement may cover non-selected icon or objects that are deactivated by the eye movement in, on, or at the particular icon or object.

In other embodiments the interface operates as follows. The at least one eye tracking sensor senses eye motion or movement as the eye, eyes, or head traverse a plurality of selectable icons or objects displayed on the at least one display device. The at least one processing unit may be configured to (1) receive an output signal(s) from the at least one eye tracking senor as the eye, eyes, and/or head traverse the icons or objects; (2) highlight a particular icon or object, when the eye movement moves in, on, or at the particular icon or object; (3) display a confirmation icon within the highlighted icon or object, (4) receive a microhold on the confirmation icon; and (5) activate the highlighted icon. The at least one processing unit is also configured to display a list of attribute icons or object, if the particular object or icon has associated attributes. The at least one processing unit is also configured to receive output signal(s) from the at least one eye tracking sensor relating to further eye movement towards a particular attribute icon and to activate the attribute icon and a microhold in, on, or at the particular attribute icon. The particular attribute icon may be (1) an adjustable attribute so that further eye movement in one direction will increase the value of the attribute, while eye movement the opposite direction will decrease the value of the attribute, (2) the particular attribute icon may be associated with a sublist, where further eye movement towards as item in the sublist will activate the item, or (3) the particular attribute icon may be associated with values set for in a matrix format, where further eye movement in, on, or at a matric location will set the attribute value. In certain, embodiments, the at least one processing unit may also highlight a particular icon or object, when the eye movement moves in, on, or at the particular icon or object, where the highlighting may be enlargement or any other highlighting effect the will discriminate the particular icon or object from the other icons or displays. Additionally, the enlargement may cover non-selected icon or objects that are deactivated by the eye movement in, on, or at the particular icon or object.

### General Eye/Head Tracking Methods

In other embodiments, the processing unit maybe configured to highlight each icon or object as the eye movement passes onto, at, into an icon or object and activate the icon only if the eye movement includes a change in direction within the icon or object screen area, otherwise the icon or object is restored to its normal configuration.

It should be recognized that eye movement that continues beyond the highlight icon will result in the processing unit removing the highlighting and await further eye movement. It should also be recognized that the processing unit may be configured to only populate the display after a threshold movement event occurs or after a correct login event occurs, which may be a biokinetic idenitifier.

### BRIEF DESCRIPTION OF THE DRAWINGS OF THE DISCLOSURE

The disclosure can be better understood with reference to the following detailed description together with the appended illustrative drawings in which like elements are numbered the same:

Interacting with nD Environments Using Multiple User Feedback Devices

FIGS. 1A-K depict screen shots or images or views of an embodiment of systems, apparatuses, and/or interfaces of this disclosure using two user feedback devices, a display device displaying a 3D environment and eye/head-tracking glasses projecting a control interface into or onto the 3D environment such as a VR or AR environment.

FIG. 2 depicts an other embodiment of an embodiment of systems, apparatuses, and/or interfaces of this disclosure using two user feedback devices, a display device displaying a 3D environment and eye/head-tracking glasses projecting a control interface into or onto the 3D environment such as a VR or AR environment.

FIG. 3A depicts an other embodiment of an embodiment of systems, apparatuses, and/or interfaces of this disclosure using two user feedback devices, a display device displaying a 3D environment and eye/head-tracking glasses projecting a control interface into or onto the 3D environment such as a VR or AR environment.

FIG. 3B depicts an other embodiment of an embodiment of systems, apparatuses, and/or interfaces of this disclosure using two user feedback devices, a display device displaying a 3D environment and eye/head-tracking glasses projecting a control interface into or onto the 3D environment such as a VR or AR environment.

FIG. 4 depicts an other embodiment of an embodiment of systems, apparatuses, and/or interfaces of this disclosure using two user feedback devices, a display device displaying a 3D environment and eye/head-tracking glasses projecting a control interface into or onto the 3D environment such as a VR or AR environment using a 3D construct.

FIGS. 5A-D depict an other embodiment of an embodiment of systems, apparatuses, and/or interfaces of this disclosure using two user feedback devices, a display device displaying a 3D environment and eye/head-tracking glasses projecting a control interface into or onto the 3D environment such as a VR or AR environment.

### Virtual Training

FIG. 6A depicts an embodiment of a schematic flow chart of a method of training.

FIG. 6B depicts another embodiment of a schematic flow chart of a method of training.

FIG. 6C depicts another embodiment of a schematic flow chart of a method of training.

### Eye Tracking Interface

FIG. 7A depicts a display including a plurality of selectable icons or objects A-JJ arranged in a column row configuration and an optional banner.

FIG. 7B depicts the display of FIG. 7A, wherein an eye tracking sensor senses eye movement towards a particular object or icon, icon O.

FIG. 7C depicts the display of FIG. 7B, wherein icon O expands as the eye motion approaches and/or enters icon O and a microhold on, in or at the enlarged icon O immediately activates icon O.

FIG. 7D depicts the activated icon O shown here surrounded by a plurality of attribute icon a-h, which may be selected and activated and/or adjusted after icon O selection.

FIG. 7E depicts the display of FIG. 7C, wherein icon O is expanded and a confirmation icon \textcircled{↑} is displayed in an upper right hand area, corner, or quadrant of icon O.

FIG. 7F depicts the display of FIG. 7E, wherein the eye tracking sensor senses motion toward confirmation icon \textcircled{↑}.

FIG. 7G depicts activation of icon O due to a microhold at, in, or on confirmation icon \textcircled{↑}.

FIG. 7H depicts the display of FIG. 7F, wherein a microhold at, in or on confirmation icon \textcircled{↑} causes a plurality of attribute objects a-c to be displayed to a left side of icon O.

FIG. 7I depicts the display of FIG. 7H, wherein the eye tracking sensor senses motion towards attribute c, which activates icon O with the attribute c invoked as shown in FIG. 7J. In all of FIG. 7B-J, the optional banner contains information indicating which icon is being processed at any given time and is included simply as an optional secondary information feature.

FIG. 8A depicts a display including a plurality of selectable icons or objects A-O arranged in a column row configuration.

FIG. 8B depicts the display of FIG. 8A, wherein an eye tracking sensor senses eye movement towards a particular object or icon, icon G, where the movement is shown by an arrow headed path or line.

FIG. 8C depicts the display of FIG. 8B, wherein icon G expands as the eye movement approaches and/or enters icon G.

FIG. 8D depicts the immediate activation of icon G.

FIG. 8E depicts the display of FIG. 8C, wherein the eye tracking sensor senses motion from a center of icon G to a top portion of icon G, which acts to confirm the selection of icon G.

FIG. 8F depicts the activation icon G shown surrounded by attributes a-h.

FIG. 8G depicts the display of FIG. 8F, wherein eye tracking sensor senses motion toward attribute h, which activate attribute h or allows the adjustment of attribute h.

FIG. 8H depicts the display of FIG. 8E, wherein icon O is shown surrounded by attributes a-h.

FIG. 8I depicts the display of FIG. 8E, wherein eye tracking sensor senses motion towards attribute c.

FIG. 8J depicts the activation icon G with the attribute c invoked. In all of FIG. 8B-I, the banner indicates which icon is being processed at any given time and is included simply as a secondary information feature and is optional.

FIG. 9A depicts a display.

FIG. 9B depicts the display of FIG. 9A, wherein an eye tracking sensor senses eye motion/movement above a threshold movement causing the display of a plurality of selectable icons or objects arranged in a circular configuration about a center of the display.

FIG. 9C depicts the display of FIG. 9B, wherein the eye tracking sensor senses eye movement from a center of the display towards icon K.

FIG. 9D depicts the immediate activation of icon K.

FIG. 9E depicts the display of FIG. 9C, wherein icon K is expanded and centered surrounded by attribute icons a-h.

FIG. 9F depicts the display of FIG. 9E, wherein the eye tracking sensor senses eye motion/movement towards attribute b.

FIG. 9G depicts the activation of icon K with attribute b invoked.

FIG. 9H depicts the display of FIG. 9C, wherein icon K is shown surrounded by attribute icon a-h.

FIG. 9I depicts the display of FIG. 9G, wherein the eye tracking sensor senses eye motion/movement towards attribute b.

FIG. 9J depicts the activation of icon K with the attribute b invoked.

### DEFINITIONS USED IN THE DISCLOSURE

The term “at least one” means one or more or one or a plurality, additionally, these three terms may be used interchangeably within this application. For example, at least one device means one or more devices or one device and a plurality of devices.

The term “one or a plurality” means one item or a plurality of items.

The term “about” means that a value of a given quantity is within ±20% of the stated value. In other embodiments, the value is within ±15% of the stated value. In other embodiments, the value is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value.

The term “substantially” means that a value of a given quantity is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value. In other embodiments, the value is within ±0.5% of the stated value. In other embodiments, the value is within ±0.1% of the stated value.

The term “motion” and “movement” are often used interchangeably and mean motion or movement that is capable of being detected by a motion sensor within an active zone of the sensor. Thus, if the sensor is a forward viewing sensor and is capable of sensing motion within a forward extending conical active zone, then movement of anything within that active zone that meets certain threshold detection criteria, will result in a motion sensor output, where the output may include at least direction, angle, distance/displacement, duration (time), velocity, and/or acceleration. Moreover, if the sensor is a touch screen or multitouch screen sensor and is capable of sensing motion on its sensing surface, then movement of anything on that active zone that meets certain threshold detection criteria, will result in a motion sensor output, where the output may include at least direction, angle, distance/displacement, duration (time), velocity, and/or acceleration. Of course, the sensors do not need to have threshold detection criteria, but may simply generate output anytime motion or any kind is detected. The processing units can then determine whether the motion is an actionable motion or movement and a non-actionable motion or movement.

The term “motion sensor” or “motion sensing component” means any sensor or component capable of sensing motion of any kind by anything with an active zone—area or volume, regardless of whether the sensor's or component's primary function is motion sensing. Of course, the same is true of sensor arrays regardless of the types of sensors in the arrays or for any combination of sensors and sensor arrays.

The term “eye tracking sensor” means any sensor capable of tracking eye movement such as eye tracking glasses, eye tracking cameras, or any other eye tracking sensor.

The term “head tracking sensor” means any sensor capable of tracking head movement such as head tracking helmets, eye tracking glasses, head tracking cameras, or any other head tracking sensor.

The term “real object” or “real world object” means real world device, attribute, or article that is capable of being controlled by a processing unit. Real objects include objects or articles that have real world presence including physical, mechanical, electro-mechanical, magnetic, electro magnetic, electrical, or electronic devices, waveform devices, or any other real world device that may be controlled by a processing unit.

The term “virtual object” means any construct generated in or attribute associated with a virtual world or by a computer and may be displayed by a display device and that are capable of being controlled by a processing unit. Virtual objects include objects that have no real world presence, but are still controllable by a processing unit. These objects include elements within a software system, product or program such as icons, list elements, menu elements, applications, files, folders, archives, generated graphic objects, 1D, 2D, 3D, and/or nD graphic images or objects, generated real world objects such as generated people, generated animals, generated devices, generated plants, generated landscapes and landscape objects, generate seascapes and seascape objects, generated skyscapes or skyscape objects, 1D, 2D, 3D, and/or nD zones, 2D, 3D, and/or nD areas, 1D, 2D, 3D, and/or nD groups of zones, 2D, 3D, and/or nD groups or areas, volumes, attributes or characteristics such as quantity, shape, zonal, field, affecting influence changes or the like, or any other generated real world or imaginary objects or attributes. Augmented and/or Mixed reality is a combination of real and virtual objects and attributes.

The term “entity” means a human or an animal or robot or robotic system (autonomous or non-autonomous or virtual representation of a real or imaginary entity.

The term “entity object” means a human or a part of a human (fingers, hands, toes, feet, arms, legs, eyes, head, body, etc.), an animal or a part of an animal (fingers, hands, toes, feet, arms, legs, eyes, head, body, etc.), or a real world object under the control of a human or an animal or a robot and include such articles as pointers, sticks, or any other real world object that can be directly or indirectly controlled by a human or animal or a robot. In VR/AR environments, the entity object may also include virtual objects.

The term “mixtures” mean different objects, attributes, data, data types or any other feature that may be mixed together or controlled together.

The term “combinations” mean different objects, attributes, data, data types or any other feature that may be packages or bundled together but remain separate.

The term “sensor data” mean data derived from at least one sensor including user data, motion data, environment data, temporal data, contextual data, historical data, waveform data, other types of data, and/or mixtures and combinations thereof.

The term “user data” mean user attributes, attributes of entities under the control of the user, attributes of members under the control of the user, information or contextual information associated with the user, or mixtures and combinations thereof.

The terms “user features”, “entity features”, and “member features” means features including: (a) overall user, entity, or member shape, texture, proportions, information, matter, energy, state, layer, size, surface, zone, area, any other overall feature, attribute or characteristic, and/or mixtures or combinations thereof, (b) specific user, entity, or member part shape, texture, proportions, characteristics, any other part feature, and/or mixtures or combinations thereof, (c) particular user, entity, or member dynamic shape, texture, proportions, characteristics, any other part feature, and/or mixtures or combinations thereof, and (d) mixtures or combinations thereof. For certain software programs, routines, and/or elements, features may represent the manner in which the program, routine, and/or element interact with other software programs, routines, and/or elements operate or are controlled. All such features may be controlled, manipulated, and/or adjusted by the motion based systems, apparatuses, and/or interfaces of this disclosure.

The term “motion or movement data” mean one or a plurality of motion/movement properties detectable by motion sensor or sensors capable of sensing motion/movement.

The term “motion or movement properties” mean properties associated with the motion data including motion/movement direction (linear, curvilinear, circular, elliptical, etc.), motion/movement distance/displacement, motion/movement duration (time), motion/movement velocity (linear, angular, etc.), motion/movement acceleration (linear, angular, etc.), motion signature or profile—manner of motion/movement (motion/movement properties associated with the user, users, objects, areas, zones, or combinations of thereof), dynamic motion properties such as motion in a given situation, motion learned by the system based on user interaction with the systems, motion characteristics based on the dynamics of the environment, influences or affectations, changes in any of these attributes, and/or mixtures or combinations thereof. Motion or movement based data is not restricted to the movement of a single body, body part, and/or member under the control of an entity, but may include movement of one or any combination of movements of any entity and/or entity object. Additionally, the actual body, body part and/or member's identity is also considered a movement attribute. Thus, the systems/apparatuses, and/or interfaces of this disclosure may use the identity of the body, body part and/or member to select between different set of objects that have been pre defined or determined base on environment, context, and/or temporal data.

The term “gesture” or“predetermine movement pattern” means a predefined movement or posture preformed in a particular manner such as closing a fist lifting a finger that is captured compared to a set of predefined movements that are tied via a lookup table to a single function and if and only if, the movement is one of the predefined movements does a gesture based system actually go to the lookup and invoke the predefined function.

The term “environment data” mean data associated with the user's surrounding or environment such as location (GPS, etc.), type of location (home, office, store, highway, road, etc.), extent of the location, context, frequency of use or reference, attributes, characteristics, and/or mixtures or combinations thereof.

The term “temporal data” mean data associated with duration of motion/movement, events, actions, interactions, etc., time of day, day of month, month of year, any other temporal data, and/or mixtures or combinations thereof.

The term “historical data” means data associated with past events and characteristics of the user, the objects, the environment and the context gathered or collected by the systems over time, or any combinations of these.

The term “contextual data” mean data associated with user activities, environment activities, environmental states, frequency of use or association, orientation of objects, devices or users, association with other devices and systems, temporal activities, any other content or contextual data, and/or mixtures or combinations thereof.

The term “simultaneous” or “simultaneously” means that an action occurs either at the same time or within a small period of time. Thus, a sequence of events are considered to be simultaneous if they occur concurrently or at the same time or occur in rapid succession over a short period of time, where the short period of time ranges from about 1 nanosecond to 5 second. In other embodiments, the period ranges from about 1 nanosecond to 1 second. In other embodiments, the period ranges from about 1 nanosecond to 0.5 seconds. In other embodiments, the period ranges from about 1 nanosecond to 0.1 seconds. In other embodiments, the period ranges from about 1 nanosecond to 1 millisecond. In other embodiments, the period ranges from about 1 nanosecond to 1 microsecond. It should be recognized that any value of time between any stated range is also covered.

The term “and/or” means mixtures or combinations thereof so that whether an “and/or” connectors is used, the “and/or” in the phrase or clause or sentence may end with “and mixtures or combinations thereof”.

The term “spaced apart” means for example that objects displayed in a window of a display device are separated one from another in a manner that improves an ability for the systems, apparatuses, and/or interfaces to discriminate between objects based on movement sensed by motion sensors associated with the systems, apparatuses, and/or interfaces.

The term “maximally spaced apart” means that objects displayed in a window of a display device are separated one from another in a manner that maximizes a separation between the objects to improve an ability for the systems, apparatuses, and/or interfaces to discriminate between objects based on motion/movement sensed by motion sensors associated with the systems, apparatuses, and/or interfaces.

The term “hold” means to remain stationary at a display location for a finite duration generally between about 1 μs to about 2 s.

The term “brief hold” means to remain stationary at a display location for a finite duration generally between about 1 μs to about 1 s.

The term “microhold” or “micro duration hold” means to remain stationary at a display location for a finite duration generally between about 1 ms to about 500 ms. In certain embodiments, the microhold is between about 10 ms to about 500 ms. In certain embodiments, the microhold is between about 100 ms to about 500 ms. In certain embodiments, the microhold is between about 200 ms to about 500 ms.

### DETAILED DESCRIPTION OF THE DISCLOSURE

Attractive/Repulsive/Manipulative Apparatuses, Systems, and/or Interfaces

The inventor has found that selection attractive or manipulative apparatuses, systems, and/or interfaces maybe constructed that use motion or movement within an active sensor zone of a motion sensor translated to motion or movement of a selection object (seen or unseen) on or within a user feedback device: 1) to discriminate between selectable objects based on the motion, 2) to attract target selectable objects towards the selection object based on properties of the sensed motion including direction, angle, distance/displacement, duration, speed, acceleration, or changes thereof, and 3) to select and simultaneously, synchronously or asynchronously activate a particular or target selectable object or a specific group of selectable objects or controllable area or an attribute or attributes upon “contact” of the selection object with the target selectable object(s), where contact means that: 1) the selection object actually touches or moves inside the target selectable object, 2) touches or moves inside an active zone (area or volume) surrounding the target selectable object, 3) the selection object and the target selectable object merge, 4) a triggering event occurs based on a close approach to the target selectable object(s) or its associated active zone or 5) a triggering event based on a predicted selection meeting a threshold certainty. The touch, merge, or triggering event causes the processing unit to select and activate the object(s), select and activate object attribute lists, select, activate and adjustments of an adjustable attribute. The objects may represent real and/or virtual objects including: 1) real world devices under the control of the apparatuses, systems, or interfaces, 2) real world device attributes and real world device controllable attributes, 3) software including software products, software systems, software components, software objects, software attributes, active areas of sensors, 4) generated EMF fields, RF fields, microwave fields, or other generated fields, 5) electromagnetic waveforms, sonic waveforms, ultrasonic waveforms, or any other waveform or entity, and/or 6) mixture and combinations thereof. The apparatuses, systems and interfaces of this disclosure may also include remote control units in wired or wireless communication therewith. The inventor has also found that a velocity (speed and direction) of motion or movement or any other movement property may be used by the apparatuses, systems, or interfaces to pull or attract one or a group of selectable objects toward a selection object and increasing speed may be used to increase a rate of the attraction of the objects, while decreasing motion speed may be used to slower a rate of attraction of the objects. The inventors have also found that as the attracted object move toward the selection object, they may be augmented in some way such as changed size, changed color, changed shape, changed line thickness of the form of the object, highlighted, changed to blinking, or combinations thereof. Simultaneously, synchronously or asynchronously, submenus or subobjects may also move or change in relation to the movements or changes of the selected objects. Simultaneously, synchronously or asynchronously, the non-selected objects may move away from the selection object(s). It should be noted that whenever a word object is used, it also includes the meaning of objects, and these objects maybe simultaneously performing separate, simultaneous, synchronous or asynchronous, and/or combined command functions or used by the processing units to issue combinational functions.

Embodiments of this disclosure relate to systems, interfaces, interactive user interfaces effective for navigating large amounts of information on small touchscreen devices, apparatuses including the interfaces, and methods for implementing the systems and interfaces where the systems and interfaces implement a 3D control methodology using 2D movements, where selection attractive or manipulation systems and interfaces use movement of in the xy plane in a ring format to simulate 3D movement for motion based selection and activation. The 3D movement methodology permits object selection and discrimination between displayed objects and attract a target object, objects or groups of objects, or fields of objects or object attributes toward, away or at angles to or from the selection object, where the direction and speed of motion controls discrimination and attraction. Embodiments also include interactive interfaces for navigating large amounts of data, information, attributes and/or controls on small devices such as wearable smart watches, sections or areas of wearable fabric or other sensor or embedded sensor surfaces or sensing abilities, as well as in Virtual Reality (VR) or Augmented Reality (AR) environments, including glasses, contacts, touchless and touch environments, and 2D, 3D, and/or nD (n-dimensional) environments. This more specifically, in wearable devices, such as watches, music players, health monitors and devices, etc. allows for the control of attributes and information by sensing motion on any surface or surfaces of the device(s), or above or around the surfaces, or through remote controls. The systems may be autonomous, or work in combination with other systems or devices, such as a watch, a phone, biomedical or neurological devices, drones, etc., headphones, remote display, etc. The selection object may be a group of objects or a field, with a consistent or gradient inherent characteristic, created by any kind of waveform as well, and may be visible, an overlay or translucent, or partially displayed, or not visible, and may be an average of objects, such as the center of mass of a hand and fingers, a single body part, multiple body and/or objects under the control of a person, or a zone, such as an area representing the gaze of an eye(s) or any virtual representation of objects, fields or controls that do the same.

in certain embodiments, as the selection object moves toward a target object, the target object will get bigger as it moves toward the selection object. It is important to conceptualize the effect we are looking for. The effect may be analogized to the effects of gravity on objects in space. Two objects in space are attracted to each other by gravity proportional to the product of their masses and inversely proportional to the square of the distance between the objects. As the objects move toward each other, the gravitational force increases pulling them toward each other faster and faster. The rate of attraction increases as the distance decreases, and they become larger as they get closer. Contrarily, if the objects are close and one is moved away, the gravitational force decreases and the objects get smaller. In the present disclosure, motion of the selection object away from a selectable object may act as a rest, returning the display back to the original selection screen or back to the last selection screen much like a “back” or “undo” event. Thus, if the user feedback unit (e.g., display) is one level down from the top display, then movement away from any selectable object, would restore the display back to the main level. If the display was at some sublevel, then movement away from selectable objects in this sublevel would move up a sublevel. Thus, motion away from selectable objects acts to drill up, while motion toward selectable objects that have sublevels results in a drill down operation. Of course, if the selectable object is directly activatable, then motion toward it selects and activates it. Thus, if the object is an executable routine such as taking a picture, then contact with the selection object, contact with its active area, or triggered by a predictive threshold certainty selection selects and simultaneously, synchronously or asynchronously activates the object. Once the interface is activated, the selection object and a default menu of items may be activated on or within the user feedback unit. If the direction of motion towards the selectable object or proximity to the active area around the selectable object is such that the probability of selection is increased, the default menu of items may appear or move into a selectable position, or take the place of the initial object before the object is actually selected such that by moving into the active area or by moving in a direction such that a commit to the object occurs, and simultaneously, synchronously or asynchronously causes the subobjects or submenus to move into a position ready to be selected by just moving in their direction to cause selection or activation or both, or by moving in their direction until reaching an active area in proximity to the objects such that selection, activation or a combination of the two occurs. The selection object and the selectable objects (menu objects) are each assigned a mass equivalent or gravitational value of 1. The difference between what happens as the selection object moves in the display area towards a selectable object in the present interface, as opposed to real life, is that the selectable objects only feel the gravitation effect from the selection object and not from the other selectable objects. Thus, in the present disclosure, the selectable object is an attractor, while the selectable objects are non-interactive, or possibly even repulsive to each other. So as the selection object is moved in response to motion by a user within the motion sensors active zone—such as motion of a finger in the active zone—the processing unit maps the motion and generates corresponding movement or motion of the selection object towards selectable objects in the general direction of the motion. The processing unit then determines the projected direction of motion and based on the projected direction of motion, allows the gravitational field or attractive force of the selection object to be felt by the predicted selectable object or objects that are most closely aligned with the direction of motion. These objects may also include submenus or subobjects that move in relation to the movement of the selected object(s). This effect would be much like a field moving and expanding or fields interacting with fields, where the objects inside the field(s) would spread apart and move such that unique angles from the selection object become present so movement towards a selectable object or group of objects can be discerned from movement towards a different object or group of objects, or continued motion in the direction of the second or more of objects in a line would cause the objects to not be selected that had been touched or had close proximity, but rather the selection would be made when the motion stops, or the last object in the direction of motion is reached, and it would be selected. The processing unit causes the display to move those object toward the selectable object. The manner in which the selectable object moves may be to move at a constant velocity towards a selection object or to accelerate toward the selection object with the magnitude of the acceleration increasing as the movement focuses in on the selectable object. The distance moved by the person and the speed or acceleration may further compound the rate of attraction or movement of the selectable object towards the selection object. In certain situations, a negative attractive force or gravitational effect may be used when it is more desired that the selected objects move away from the user. Such motion of the objects would be opposite of that described above as attractive. As motion continues, the processing unit is able to better discriminate between competing selectable objects and the one or ones more closely aligned are pulled closer and separated, while others recede back to their original positions or are removed or fade. If the motion is directly toward a particular selectable object with a certainty above a threshold value, which has a certainty for example greater than 50%, then the selection and selectable objects merge and the selectable object is simultaneously, synchronously or asynchronously selected and activated. Alternatively, the selectable object may be selected prior to merging with the selection object if the direction, angle, distance/displacement, duration, speed and/or acceleration of the selection object is such that the probability of the selectable object is enough to cause selection, or if the movement is such that proximity to the activation area surrounding the selectable object is such that the threshold for selection, activation or both occurs. Motion continues until the processing unit is able to determine that a selectable object has a selection threshold of greater than 50%, meaning that it more likely than not the correct target object has been selected. In certain embodiments, the selection threshold will be at least 60%. In other embodiments, the selection threshold will be at least 70%. In other embodiments, the selection threshold will be at least 80%. In yet other embodiments, the selection threshold will be at least 90%. Alternatively, the selection may be relative so that the selection certainty may be such that the certainty associated with one particular object is higher by 50% or more than the certainties associated with other potentially selectable objects.

in certain embodiments, the selection object will actually appear on the display screen, while in other embodiments, the selection object will exist only virtually in the processor software. For example, for motion sensors that require physical contact for activation such as touch screens, the selection object maybe displayed and/or virtual, with motion on the screen used to determine which selectable objects from a default collection of selectable objects will be moved toward a perceived or predefined location of a virtual section object or toward the selection object in the case of a displayed selection object, while a virtual object simply exists in software such as at a center of the display or a default position to which selectable object are attracted, when the motion aligns with their locations on the default selection. In the case of motion sensors that have active zones such as cameras, IR sensors, sonic sensors, or other sensors capable of detecting motion within an active zone and creating an output representing that motion to a processing unit that is capable of determining direction, angle, distance/displacement, duration, speed and/or acceleration properties of the sensed or detected motion, the selection object is generally virtual and motion of one or more body parts of a user is used to attract a selectable object or a group of selectable objects to the location of the selection object and predictive software is used to narrow the group of selectable objects and zero in on a particular selectable object, objects, objects and attributes, and/or attributes. In certain embodiments, the interface is activated from a sleep condition by movement of a user or user body part in to the active zone of the motion sensor or sensors associated with the interface. Once activated, the feedback unit such as a display associated with the interface displays or evidences in a user discernible manner a default set of selectable objects or a top level set of selectable objects. The selectable objects may be clustered in related groups of similar objects or evenly distributed about a centroid of attraction if no selection object is generated on the display or in or on another type of feedback unit. If one motion sensor is sensitive to eye motion, then motion of the eyes will be used to attract and discriminate between potential target objects on the feedback unit such as a display screen. If the interface is an eye only interface, then eye motion is used to attract and discriminate selectable objects to the centroid, with selection and activation occurring when a selection threshold is exceeded—greater than 50% confidence that one selectable object is more closely aligned with the direction of motion than all other objects. The speed and/or acceleration of the motion along with the direction are further used to enhance discrimination by pulling potential target objects toward the centroid quicker and increasing their size and/or increasing their relative separation. Proximity to the selectable object may also be used to confirm the selection. Alternatively, if the interface is an eye and other body part interface, then eye motion will act as the primary motion driver, with motion of the other body part acting as a confirmation of eye movement selections. Thus, if eye motion has narrowed the selectable objects to a group, which may or may not dynamically change the perspective of the user (zoom in/out, pan, tilt, roll, or any combination of changes) motion of the other body part may be used by the processing unit to further discriminate and/or select/activate a particular object or if a particular object meets the threshold and is merging with the centroid, then motion of the object body part may be used to confirm or reject the selection regardless of the threshold confidence. In other embodiments, the motion sensor and processing unit may have a set of predetermined actions that are invoked by a given structure of a body part or a given combined motion of two or more body parts. For example, upon activation, if the motion sensor is capable of analyzing images, a hand holding up different number of figures from zero, a fist, to five, an open hand may cause the processing unit to display different base menus. For example, a fist may cause the processing unit to display the top level menu, while a single finger may cause the processing unit to display a particular submenu. Once a particular set of selectable objects is displayed, then motion attracts the target object, which is simultaneously, synchronously or asynchronously selected and activated. In other embodiments, confirmation may include a noised generated by the uses such as a word, a vocal noise, a predefined vocal noise, a clap, a snap, or other audio controlled sound generated by the user; in other embodiments, confirmation may be visual, audio or haptic effects or a combination of such effects. In certain embodiments, the confirmation may be dynamic, a variable sound, color, shape, feel, temperature, distortion, or any other effect or combination of thereof.

In other embodiments, the methods for implementing the systems, apparatuses, and/or interfaces of this disclosure include the steps of sensing circular movement via a motion sensor, where the circular movement is sufficient to activate a scroll wheel, scrolling through a list associated with the scroll wheel, where movement close to the center causes a faster scroll, while movement further from the center causes a slower scroll and simultaneously, synchronously or asynchronously faster circular movement causes a faster scroll while slower circular movement causes slower scroll. When the user stops the circular motion, even for a very brief time, or changes direction such that it can be discerned to be no longer circular (such as moving in a z-axis when the circular motion is in an xy plane) the list becomes static so that the user may move to a particular object, hold over a particular object, or change motion direction at or near a particular object. The whole wheel or a partial amount or portion of the wheel may be displayed or just an arc may be displayed where scrolling moves up and down the arc. These actions cause the processing unit to select the particular object, to simultaneously, synchronously or asynchronously select and activate the particular object, or to simultaneously, synchronously or asynchronously select, activate, and control an attribute of the object. By beginning the circular motion again, anywhere on the screen, scrolling recommences immediately. Of course, scrolling could be through a list of values, or actually be controlling values as well, and all motions may be in 2D, 3D, and/or nil) environments as well.

In other embodiments, the methods for implementing the systems, apparatuses, and/or interfaces of this disclosure include the steps of displaying an arcuate menu layouts of selectable objects on a display field, sensing movement toward an object pulling the object toward the user's location, user's movement, or center based on a direction, a distance/displacement, a duration, a speed and/or an acceleration of the movement, as the selected object moves toward user or the center, displaying subobjects appear distributed in an arcuate spaced apart configuration about the selected object. The apparatus, system and methods can repeat the sensing and displaying operations. In all cases, singular or multiple subobjects or submenus may be displayed between the user and the primary object, behind, below, or anywhere else as desired for the interaction effect.

In other embodiments, the methods for implementing the systems, apparatuses, and/or interfaces of this disclosure include the steps of predicting an object's selection based on the properties of the sensed movement, where the properties includes direction, angle, distance/displacement, duration, speed, acceleration, changes thereof, or combinations thereof. For example, faster speed may increase predictability, while slower speed may decrease predictability or vice versa. Alternatively, moving averages may be used to extrapolate the desired object desired such as vector averages, linear and non-linear functions, including filters and multiple outputs form one or more sensors. Along with this is the “gravitational”, “electric” and/or “magnetic” attractive or repulsive effects utilized by the methods and systems, whereby the selectable objects move towards the user or selection object and accelerates towards the user or selection object as the user or selection object and selectable objects come closer together. This may also occur by the user beginning motion towards a particular selectable object, the particular selectable object begins to accelerate towards the user or the selection object, and the user and the selection object stops moving, but the particular selectable object continues to accelerate towards the user or selection object. In the certain embodiments, the opposite effect occurs as the user or selection objects moves away—starting close to each other, the particular selectable object moves away quickly, but slows down its rate of repulsion as distance is increased, making a very smooth look. In different uses, the particular selectable object might accelerate away or return immediately to its original or predetermined position. In any of these circumstances, a dynamic interaction is occurring between the user or selection object and the particular selectable object(s), where selecting and controlling, and deselecting and controlling can occur, including selecting and controlling or deselecting and controlling associated submenus or subobjects and/or associated attributes, adjustable or invocable.

In other embodiments, the methods for implementing the systems, apparatuses, and/or interfaces of this disclosure include the steps of detecting at least one bio-kinetic characteristic of a user such as a fingerprint, fingerprints, a palm print, retinal print, size, shape, and texture of fingers, palm, eye(s), hand(s), face, etc. or at least one EMF, acoustic, thermal or optical characteristic detectable by sonic sensors, thermal sensors, optical sensors, capacitive sensors, resistive sensors, or other sensor capable of detecting EMF fields, other dynamic wave form, or other characteristics, or combinations thereof emanating from a user, including specific movements and measurements of movements of body parts such as fingers or eyes that provide unique markers for each individual, determining an identity of the user from the bio-kinetic characteristics, and sensing movement as set forth herein. In this way, the existing sensor for motion may also recognize the user uniquely, as well as the motion event associated with the user. This recognition may be further enhanced by using two or more body parts or bio-kinetic characteristics (e.g., two fingers), and even further by body parts performing a particular task such as being squeezed together, when the user enters in a sensor field. Other bio-kinetic and/or biometric characteristics may also be used for unique user identification such as skin characteristics and ratio to joint length and spacing. Further examples include the relationship between the finger(s), hands or other body parts and the wave, acoustic, magnetic, EMF, or other interference pattern created by the body parts creates a unique constant and may be used as a unique digital signature. For instance, a finger in a 3D acoustic or EMF field would create unique null and peak points or a unique null and peak pattern, so the “noise” of interacting with a field may actually help to create unique identifiers. This may be further discriminated by moving a certain distance, where the motion may be uniquely identified by small tremors, variations, or the like, further magnified by interference patterns in the noise. This type of unique identification maybe used in touch and touchless applications, but may be most apparent when using a touchless sensor or an array of touchless sensors, where interference patterns (for example using acoustic sensors) may be present due to the size and shape of the hands or fingers, or the like. Further uniqueness may be determined by including motion as another unique variable, which may help in security verification. Furthermore, by establishing a base user's bio-kinetic signature or authorization, slight variations per bio-kinetic transaction or event may be used to uniquely identify each event as well, so a user would be positively and uniquely identified to authorize a merchant transaction, but the unique speed, angles, and variations, even at a wave form and/or wave form noise level could be used to uniquely identify one transaction as compared to another.

In other embodiments, the methods for implementing the apparatuses, systems, and/or interfaces include the steps of sensing movement of a first body part such as an eye, etc., tracking the first body part movement until it stops, pauses or holds on an object, within an active zone of an object, or sufficient close to the active zone of the object to insure select certainty to a threshold degree of certainty, preliminarily selecting the object, sensing movement of a second body part such as finger, hand, foot, etc., confirming the preliminary selection and selecting the object. The selection may then cause the processing unit to invoke one of the command and control functions including issuing a scroll function, a simultaneous, synchronous, or asynchronous select and scroll function, a simultaneous, synchronous, or asynchronous select and activate function, a simultaneous, synchronous, or asynchronous select, activate, and attribute adjustment function, or a combination thereof, and controlling attributes by further movement of the first or second body parts or activating the objects if the object is subject to direct activation. These selection procedures may be include tracking eye motion/movement to initiate a scrolling function through a list or over a list by the eye motion/movement or further eye motion/movement toward the list or over the list and tracking movement of another body part to select a particular member of the list such as moving a finger or hand, which motion/movement may also be used to confirm the selection and selecting an object or a group of objects or an attribute or a group of attributes. In certain embodiments, if object configuration is predetermined such that an object in the middle of several objects, then the eye may move somewhere else, but hand motion continues to scroll or control attributes or combinations thereof, independent of the eyes. Hand and eyes may work together or independently, or a combination in and out of the two. Thus, movements may be compound, sequential, simultaneous, synchronous or asynchronous, partially compound, compound in part, or combinations thereof, the requisite movement to scroll and select or select and confirm may involve movement of two or more body parts, which are used to invoke one of the command and control functions of this disclosure—selection and activation, selection and attribute adjustment, selection and submenu or object scrolling, or combination thereof. In certain embodiments, if the object configuration is predetermined such that an object is in the middle of several other objects, then once scrolling begins, the systems, apparatuses, and/or interfaces may release the eyes so that the eyes may move somewhere else for performing other actions, while hand motion continues to scroll, select and/or control attributes or combinations thereof, independent of eye movement. Thus, the systems, apparatuses, and/or interfaces may use hand and eye movement (movement of two or more body parts) in a cooperative manner, in a coupled manner, or in an independent manner to cause the systems, apparatuses, and/or interfaces to control controllable object in different ways. The movements may be independent, coupled, compound, sequential, simultaneous or concurrent, and/or complex, i.e., combining one or more of independent, coupled, compound, sequential, or simultaneous or concurrent movements.

In other embodiments, the methods for implementing the apparatuses, systems, and/or interfaces include the steps of capturing a movement of a user during a selection procedure or a plurality of selection procedures to produce a raw user movement dataset. The apparatuses, systems, interfaces, and/or methods also include the step of reducing the raw user movement dataset to produce a refined user movement dataset, where the refinement may include reducing the movement to a plurality of linked vectors, to a fit curve, to a spline fit curve, to any other curve fitting format having reduced storage size, a reduced data point collection, or to any other fitting format. The apparatuses, systems, interfaces, and/or methods also include the step of storing the raw user movement dataset or the refined user movement dataset in an appropriate database for storage, retrieval, and/or use by the systems, apparatuses, interfaces, and/or methods of this disclosure. The apparatuses, systems, interfaces, and/or methods also include the step of analyzing the raw user movement dataset and/or refined user movement dataset to produce a predictive tool for improving the prediction of a user's selection procedures using the motion based system or to produce a forensic tool for identifying the past behavior of the user or to produce a training tool for training the user interface to improve user interaction with the interface.

In other embodiments, the methods for implementing the systems, apparatuses, and/or interfaces include the steps of sensing movement of a plurality of body parts simultaneously, synchronously, or asynchronously or substantially simultaneously, synchronously, or asynchronously and converting the sensed movement into control functions for simultaneously, synchronously, or asynchronously controlling an object, a plurality of objects, and/or attributes associated therewith. The apparatuses, systems, interfaces, and/or methods also include controlling an attribute or a plurality of attributes, or activating an object or a plurality of objects, or any combination thereof. For example, placing a hand on a top of a domed surface for controlling a UAV, sensing movement of the hand on the dome, where a direction of movement correlates with a direction of flight, sensing changes in the movement on the top of the domed surface, where the changes correlate with changes in direction, angle, distance/displacement, duration, speed, or acceleration of functions, and simultaneously, synchronously, or asynchronously sensing movement of one or more fingers, where movement of the fingers may control other features of the UAV such as pitch, yaw, roll, camera focusing, missile firing, etc. with an independent finger(s) movement, while the hand, palm or other designated area of the hand is controlling the UAV, either through remaining stationary (continuing last known command) or while the hand is moving, accelerating, or changing distance, displacement (in 2D or 3D or in a flexible or deformable medium), or direction of acceleration. In certain embodiments where the display device is a flexible device such as a flexible screen or flexible dome, the movement may also include deforming the surface of the flexible device, changing a pressure on the surface, inside the volume of the dome, or similar surface and/or volumetric deformations. These deformations may be used in conjunction with the other motions.

In other embodiments, the methods for implementing the systems, apparatuses, and/or interfaces include the steps of populating a display field with displayed primary objects and hidden secondary objects, where the primary objects include menus, programs, applications, attributes, devices, etc. and secondary objects include submenus, attributes, preferences, etc. The methods and systems also include sensing movement, highlighting one or more primary objects most closely aligned with a direction of the movement, predicting a primary object based on the movement, and simultaneously, synchronously, or asynchronously: (a) selecting the primary object, (b) displaying secondary objects most closely aligned with the direction of motion in a spaced apart configuration, (c) pulling the primary and secondary objects toward a center of the display field or to a pre determined area of the display field, and/or (d) removing, fading, or making inactive the unselected primary and secondary objects until making active again.

Alternately, zones in between primary and/or secondary objects may act as activating areas or subroutines that would act the same as the objects. For instance, if someone were to move in between two objects in 2D (a watch or mobile device), 3D space (virtual reality environments and altered reality environments), nD space (n-dimensional space such as x, y, z, t space represented in VR or AR environments) objects in the background may be rotated to the front and the front objects may be rotated towards the back, or to a different level.

In other embodiments, the methods for implementing the systems, apparatuses, and/or interfaces include the steps of populating a display field with displayed primary objects and offset active fields associated with the displayed primary objects, where the primary objects include menus, object lists, alphabetic characters, numeric characters, symbol characters, other text based characters. The methods and systems also include sensing movement, highlighting one or more primary objects most closely aligned with a direction of the movement, predicting a primary object based on the movement, context, and/or movement and context, and simultaneously, synchronously, or asynchronously: (a) selecting the primary object, (b) displaying secondary (tertiary or deeper) objects most closely aligned with the direction of motion/movement in a spaced apart configuration, (c) pulling the primary and secondary or deeper objects toward a center of the display field or to a pre-determined area of the display field, and/or (d) removing, making inactive, or fading or otherwise indicating a non-selection status of the unselected primary, secondary, and deeper level objects.

In other embodiments, the methods for implementing the systems, apparatuses, and/or interfaces include the steps of sensing movement of an eye and simultaneously, synchronously, asynchronously, or sequentially moving elements of a list within a fixed window or viewing pane of a display field or a display or an active object hidden or visible through elements arranged in a 2D, 3D, and/or nD matrix within the display field, where eye movement anywhere, in any direction in a display field regardless of the arrangement of elements such as icons moves through the set of selectable objects. Of course the window may be moved with the movement of the eye to accomplish the same scrolling through a set of lists or objects, or a different result may occur by the use of both eye position in relation to a display or volume (perspective), as other motions occur, simultaneously, synchronously, asynchronously, or sequentially. Thus, scrolling does not have to be in a linear fashion, the intent is to select an object and/or attribute and/or other selectable items regardless of the manner of motion—linear, arcuate, angular, circular, spiral, random, or the like.

Once an object of interest is to be selected, then selection is accomplished either by movement of the eye in a different direction, holding the eye in place for a period of time over an object, movement of a different body part, or any other movement or movement type that affects the selection of an object, attribute, audio event, facial posture, and/or biometric or bio-kinetic event. These same steps may be used with body only or a combination of multiple body parts and eye or head gaze or movement.

In other embodiments, the methods for implementing the systems, apparatuses, and/or interfaces include the steps of sensing movement of an eye, selecting an object, an object attribute or both by moving the eye in a pre-described change of direction such that the change of direction would be known and be different than a random eye movement, or a movement associated with the scroll (scroll being defined by moving the eye all over the screen or volume of objects with the intent to choose). Of course the eye may be replaced by any body part or object under the control of a body part.

In other embodiments, the methods for implementing the systems, apparatuses, and/or interfaces include the steps of sensing eye movement via a motion sensor, selecting an object displayed in a display field when the eye pauses at an object for a dwell time sufficient for the motion sensor to detect the pause and simultaneously, synchronously, asynchronously, or sequentially activating the selected object, repeating the sensing and selecting until the object is either activatable or an attribute capable of direct control. In certain embodiments, the methods also comprise predicting the object to be selected from characteristics of the movement and/or characteristics of the manner in which the user moves. In other embodiments, eye tracking—using gaze instead of motion for selection/control via eye focusing (dwell time or gaze time) on an object and a body motion (finger, hand, etc.) scrolls through an associated attribute list associated with the object, or selects a submenu associated with the object. Eye gaze selects a submenu object and body motion confirms selection (selection does not occur without body motion), so body motion actually affects object selection.

In other embodiments, eye tracking—using motion for selection/control—eye movement is used to select a first word in a sentence of a word document. Selection is confirmed by body motion of a finger (e.g., right finger) which holds the position. Eye movement is then tracked to the last word in the sentence and another finger (e.g., the left finger) confirms selection. Selected sentence is highlighted due to second motion defining the boundary of selection. The same effect may be had by moving the same finger towards the second eye position (the end of the sentence or word). Movement of one of the fingers towards the side of the monitor (movement is in different direction than the confirmation move) sends a command to delete the sentence. Alternatively, movement of eye to a different location, followed by both fingers moving generally towards that location results in the sentence being copied to the location at which the eyes stopped. This may also be used in combination with a gesture or with combinations of motions and gestures such as eye movement and other body movements concurrently—multiple inputs at once such as UAV controls described below.

In other embodiments, looking at the center of picture or article and then moving one finger away from center of picture or center of body enlarges the picture or article (zoom in). Moving finger towards center of picture makes picture smaller (zoom out). What is important to understand here is that an eye gaze point, a direction of gaze, or a motion of the eye provides a reference point for body motion and location to be compared. For instance, moving a body part (say a finger) a certain distance away from the center of a picture in a touch or touchless, 2D or 3D environment (area or volume as well), may provide a different view. For example, if the eye(s) were looking at a central point in an area, one view would appear, while if the eye(s) were looking at an edge point in an area, a different view would appear. The relative distance of the motion would change, and the relative direction may change as well, and even a dynamic change involving both eye(s) and finger, could provide yet another change of motion. For example, by looking at the end of a stick and using the finger to move the other end of it, the pivot point would be the end the eyes were looking at. By looking at the middle of the stick, then using the finger to rotate the end, the stick would pivot around the middle. Each of these movement may be used to control different attributes of a picture, screen, display, window, or volume of a 3D projection, etc. What now takes two fingers may be replaced by one due to the eye(s) acting as the missing finger.

These concepts are useable to manipulate the view of pictures, images, 3D data or higher dimensional data, 3D renderings, 3D building renderings, 3D plant and facility renderings, or any other type of 3D or higher dimensional (nD) pictures, images, or renderings. These manipulations of displays, pictures, screens, etc. may also be performed without the coincidental use of the eye, but rather by using the motion of a finger or object under the control or a user, such as by moving from one lower corner of a bezel, screen, or frame (virtual or real) diagonally to the opposite upper corner to control one attribute, such as zooming in, while moving from one upper corner diagonally to the other lower corner would perform a different function, for example zooming out. This motion may be performed as a gesture, where the attribute change might occur in at predefined levels, or may be controlled variably so the zoom in/out function may be a function of time, space, and/or distance. By moving from one side or edge to another, the same predefined level of change, or variable change may occur on the display, picture, frame, or the like. For example, a TV screen displaying a picture and zoom-in may be performed by moving from a bottom left corner of the frame or bezel, or an identifiable region (even off the screen) to an upper right portion. As the user moves, the picture is magnified (zoom-in). By starting in an upper right corner and moving toward a lower left, the system causes the picture to be reduced in size (zoom-out) in a relational manner to the distance or speed the user moves. If the user makes a quick diagonally downward movement from one upper corner to the other lower corner, the picture may be reduced by 50% (for example). This eliminates the need for using two fingers that is currently popular as a pinch/zoom function.

By the user moving from a right side of the frame or bezel or predefined location towards a left side, an aspect ratio of the picture may be changed so as to make the picture tall and skinny. By moving from a top edge toward a bottom edge, the picture may cause the picture to appear short and wide. By moving two fingers from one upper corner diagonally towards a lower corner, or from side to side, a “cropping” function may be used to select certain aspects of the picture.

By taking one finger and placing it near the edge of a picture, frame, or bezel, but not so near as to be identified as desiring to use a size or crop control, and moving in a rotational or circular direction, the picture could be rotated variably, or if done in a quick gestural motion, the picture might rotate a predefined amount, for instance 90 degrees left or right, depending on the direction of the motion.

By moving within a central area of a picture, the picture may be moved “panned” variably by a desired amount or panned a preset amount, say 50% of the frame, by making a gestural or dynamic motion in the direction of a desired panning. Likewise, these same motions may be used in a 3D environment for simple manipulation of object attributes. These are not specific motions using predefined pivot points as is currently used in CAD programs, but is rather a way of using the body (eyes or fingers for example) in broad areas. These same motions may be applied to any display, projected display or other similar device. In a mobile device, where many icons (objects) exist on one screen, where the icons include folders of “nested” objects, by moving from one lower corner of the device or screen diagonally toward an upper corner, the display may zoom in, meaning the objects would appear magnified, but fewer would be displayed. By moving from an upper right corner diagonally downward, the icons would become smaller, and more could be seen on the same display. Moving in a circular motion near an edge of the display may cause rotation of the icons, providing scrolling through lists and pages of icons. Moving from one edge to an opposite edge would change the aspect ratio of the displayed objects, making the screen of icons appear shorter and wider, or taller and skinny, based on the direction moved.

In other embodiments, looking at a menu object then moving a finger away from object or center of body opens up sub menus. If the object represents a software program such as excel, moving away opens up spreadsheet fully or variably depending on how much movement is made (expanding spreadsheet window).

In other embodiments, instead of being a program accessed through an icon, the program may occupy part of a 3D space that the user interacts with or a field coupled to the program acting as a sensor for the program through which the user to interacts with the program. In other embodiments, if object represents a software program such as Excel and several (say 4) spreadsheets are open at once, movement away from the object shows 4 spread sheet icons. The effect is much like pulling curtain away from a window to reveal the software programs that are opened. The software programs might be represented as “dynamic fields”, each program with its own color, say red for excel, blue for word, etc. The objects or aspects or attributes of each field may be manipulated by using motion. For instance, if a center of the field is considered to be an origin of a volumetric space about the objects or value, moving at an exterior of the field cause a compound effect on the volume as a whole due to having a greater x value, a greater y value, or a great z value—say the maximum value of the field is 5 (x, y, or z), moving at a 5 point would be a multiplier effect of 5 compared to moving at a value of 1 (x, y, or z) providing a gradient of values to interact with. The inverse may also be used, where moving at a greater distance from the origin may provide less of an effect on part or the whole of the field and corresponding values. Changes in color, shape, size, density, audio characteristics, or any combination of these and other forms of representation of values could occur, which may also help the user or users to understand the effects of motion on the fields. These may be preview panes of the spreadsheets or any other icons representing these. Moving back through each icon or moving the finger through each icon or preview pane, then moving away from the icon or center of the body selects the open programs and expands them equally on the desktop, or layers them on top of each other, etc. These actions may be combined, i.e. in AR/VR environments, where motion of the eyes and finger and another hand (or body) may each or in combination have a predetermined axis or axes to display menus and control attributes or choices that may be stationary or dynamic, and may interact with each other, so different combinations of eye, body and hand may provide the same results (redundantly), or different results based on the combination or sequence of motions and holds, gazes, and even pose or posture in combination with these. Thus, motion in multiple axes may move in compound ways to provide redundant or different effects, selection and attribute controls.

In other embodiments, four word processor documents (or any program or web pages) are open at once.

Movement from bottom right of the screen to top left reveals the document at bottom right of page, effect looks like pulling curtain back. Moving from top right to bottom left reveals a different document. Moving from across the top, and circling back across the bottom opens all, each in its quadrant, then moving through the desired documents and creating circle through the objects links them all together and merges the documents into one document. As another example, the user opens three spreadsheets and dynamically combines or separates the spreadsheets merely via motions or movements, variably per amount and direction, angle, distance/displacement, and/or duration of the motion or movement. Again, the software or virtual objects are dynamic fields, where moving in one area of the field may have a different result than moving in another area, and the combining or moving through the fields causes a combining of the software programs, and may be done dynamically. Furthermore, using the eyes to help identify specific points in the fields (2D or 3D) would aid in defining the appropriate layer or area of the software program (field) to be manipulated or interacted with. Dynamic layers within these fields may be represented and interacted with spatially in this manner. Some or all the objects may be affected proportionately or in some manner by the movement of one or more other objects in or near the field. Of course, the eyes may work in the same manner as a body part or in combination with other objects or body parts. In all cases, contextual, environmental, prioritized, and weighted averages or densities and probabilities may affect the interaction and aspect view of the field and the data or objects associated with the field(s). For instance, creating a graphic representation of values and data points containing RNA, DNA, family historical data, food consumption, exercise, etc., would interact differently if the user began interacting closer to the RNA zone than to the food consumption zone, and the filed would react differently in part or throughout as the user moved some elements closer to others or in a different sequence from one are to another. This dynamic interaction and visualization would be expressive of weighted values or combinations of elements to reveal different outcomes.

In other embodiments, the eye selects (acts like a cursor hovering over an object and object may or may not respond, such as changing color to identify it has been selected), then a motion or gesture of eye or a different body part confirms and disengages the eyes for further processing.

In other embodiments, the eye selects or tracks and a motion or movement or gesture of second body part causes a change in an attribute of the tracked object—such as popping or destroying the object, zooming, changing the color of the object, etc. finger is still in control of the object.

In other embodiments, eye selects, and when body motion and eye motion are used, working simultaneously, synchronously, asynchronously, or sequentially, a different result occurs compared to when eye motion is independent of body motion, e.g., eye(s) tracks a bubble, finger moves to zoom, movement of the finger selects the bubble and now eye movement will rotate the bubble based upon the point of gaze or change an attribute of the bubble, or the eye may gaze and select and/or control a different object while the finger continues selection and/or control of the first objector a sequential combination could occur, such as first pointing with the finger, then gazing at a section of the bubble may produce a different result than looking first and then moving a finger; again a further difference may occur by using eyes, then a finger, then two fingers than would occur by using the same body parts in a different order.

In other embodiments, the methods for implementing the systems, apparatuses, and/or interfaces include the steps of: controlling helicopter with one hand on a domed interface, where several fingers and hand all move together and move separately. In this way, the whole movement of the hand controls the movement of the helicopter in altitude, direction, yaw, pitch and roll, while the fingers may also move simultaneously, synchronously, asynchronously, or sequentially to control cameras, artillery, or other controls or attributes, or both. Thus, the systems, apparatuses and interfaces may process multiple movement outputs from one or a plurality of motion sensors simultaneously, congruently, or sequentially, where the movements may be dependent, partially dependent, partially coupled, fully coupled, partially independent or fully independently. The term dependent means that one movement is dominant and all other movements are dependent on the dominant movement. For examples, in control of a UAV or traversing a VR/AR environment, the set of controllables may including altitude, direction, angle, distance/displacement, duration, speed, velocity, acceleration, yaw, pitch, roll, etc., where in certain circumstances, altitude may be the dominate controllable and all other are dependent on the altitude being so that all other controllables are performed at a designated altitude. The term partially dependent means that a set of movement outputs include a dominate output and the other member of the set are dependent on the dominant movement. For example considering the same set of controllables, velocity and altitude may be independent and other sets tied to each one of them. The term partially coupled means that some of the movement outputs are coupled to each other so that they act in a pre-defined or predetermine manner, while other are independent. For example considering the same controllables, altitude, direction, angle, distance/displacement, duration, velocity and acceleration may be coupled as the UAV is traveling a predefined path, while the other controllables are independently controllable.

The term fully coupled means that all of the movement outputs are coupled to each other so that they act in a pre-defined or predetermine manner. For example, all of the UAV sensors may all be coupled so that all of the sensors are tracking one specific target. The term partially independent means that some of the movement outputs are independent, while some are either dependent or coupled. For example, all of the sensor may be tracking one specific target, while the UAV positioning controls may all be independently controlled. The term fully independent means that each movement output is processed independently of the other outputs. Thus, movement of multiple inputs may be simultaneously, synchronously, asynchronously, sequentially, congruently or independently utilized to control objects and attributes thereof.

In certain embodiments, the perspective of the user as gravitational effects and object selections are made in 3D space. For instance, as we move in 3D space towards subobjects, using our previously submitted gravitational and predictive effects, each selection may change the entire perspective of the user so the next choices are in the center of view or in the best perspective. This may include rotational aspects of perspective, the goal being to keep the required movement of the user small and as centered as possible in the interface real estate. This is really showing the aspect, viewpoint or perspective of the user, and is relative. Since we are saying the objects and fields may be moved, or saying the user may move around the field, it is really a relative.

In other embodiments, the methods for implementing the systems, apparatuses, and/or interfaces include the steps of sensing movement of a button or knob with motion controls associated therewith, either on top of or in 3D, 3 space, on sides (whatever the shape), predicting which gestures are called by direction, distance/displacement, angle, duration, and/or speed of motion (maybe amendment to gravitational/predictive application). By definition, a gesture has a pose-movement-pose then lookup table, then command if values equal values in lookup table. We may start with a pose, and predict the gesture by beginning to move in the direction of the final pose. As we continue to move, we would be scrolling through a list of predicted gestures until we may find the most probable desired gesture, causing the command of the gesture to be triggered before the gesture is completed. Predicted gestures could be dynamically shown in a list of choices and represented by objects or text or colors or by some other means in a display. As we continue to move, predicted end results of gestures would be dynamically displayed and located in such a place that once the correct one appears, movement towards that object, representing the correct gesture, would select and activate the gestural command. In this way, a gesture could be predicted and executed before the totality of the gesture is completed, increasing speed and providing more variables for the user.

For example, in a keyboard application, current software use shapes of gestures to predict words. Google uses zones of letters (a group of letters), and combinations of zones (gestures) to predict words. We would use the same gesture-based system, except we be able to predict which zone the user is moving towards based upon one or more movement properties, meaning we would not have to actually move into the zone to finish the gesture, but moving towards the zone would select or bring up choice bubbles, and moving towards the bubble would select that bubble. Once a word is chose, a menu of expanding option could show, so one could create a sentence by moving through a sentence “tree”.

In another example, instead of using a gesture such as “a pinch” gesture to select something in a touchless environment, movement towards making that gesture would actually trigger the same command. So instead of having to actually touch the finger to the thumb, just moving the finger towards the thumb would cause the same effect to occur. Most helpful in combination gestures where a finger pointing gesture is followed by a pinching gesture to then move a virtual object. By predicting the gesture, after the point gesture, the beginning movement of the pinch gesture would be faster than having to finalize the pinching motion.

In other embodiments, the methods for implementing the systems, apparatuses, and/or interfaces include the steps of: sensing movement via a motion sensor within a display field displaying a list of letters from an alphabet, predicting a letter or a group of letters based on the motion, if movement is aligned with a single letter, simultaneously, synchronously, asynchronously, or sequentially selecting the letter or simultaneously, synchronously, asynchronously, or sequentially moving the group of letter forward until a discrimination between letters in the group is predictively certain and simultaneously, synchronously, asynchronously, or sequentially selecting the letter, sensing a change in a direction of motion, predicting a second letter or a second group of letter based on the motion, if movement is aligned with a single letter, simultaneously, synchronously, asynchronously, or sequentially selecting the letter or simultaneously, synchronously, asynchronously, or sequentially moving the group of letters forward until a discrimination between letters in the group is predictively certain and simultaneously, synchronously, asynchronously, or sequentially select the letter, either after the first letter selection or the second letter selection or both, display a list of potential words beginning with either the first letter or the second letter, selecting a word from the word list by movement of a second body part simultaneously, synchronously, asynchronously or sequentially selected the word and resetting the original letter display, and repeating the steps until a message is completed.

Thus, the current design selects a letter simply by changing one or more motion properties at or near a letter. A faster process would be to use movement toward a letter, then changing one or more motion properties before reaching the letter and moving towards a next letter and changing one or more motion properties again before getting to the next letter may better predict words, and might change the first letter selection. Selection bubbles may appear and be changing while moving, so one or more movement properties may be used to predict the word, not necessarily having to move over the exact letter or very close to it, though moving over the exact letter may be a positive selection of that letter and this effect could be better verified by a slight pausing or slowing down of movement. (Of course, this may be combined with current button like actions or lift-off events or touch-up events, and more than one finger or hand may be used, both simultaneously, synchronously, asynchronously, or sequentially to provide the spelling and typing actions.) This is most effective in a touchless environment where relative motion can be leveraged to predict words on a keyboard rather than the actual distance required to move from key to key. The distance from a projected keyboard and movement of finger using angles of motion to predict letters. Predictive word bubbles may be selected with a z movement. Move below the letters of a keyboard to select, or shape the letter buttons in such a way that they extend downward (like a tear drop) so actual letters can be seen while selecting instead of covering the letters (the touch or active zones are offset from the actual keys. This may also be used with predictive motions to create a very fast keyboard where relative motions are used to predict keys and words while more easily being able to see the key letters. Bubbles may also appear above or besides the keys, or around them, including in an arcuate or radial fashion to further select predicted results by moving towards the suggested words.

In other embodiments, the methods for implementing the systems, apparatuses, and/or interfaces include the steps of: maintaining all software applications in an instant on configuration—on, but inactive, resident, but not active, so that once selected the application which is merely dormant, is fully activate instantaneously (or may be described as a different focus of the object), sensing movement via a motion sensor with a display field including application objects distributed on the display in a spaced apart configuration, preferably, in a maximally spaced apart configuration so that the movement results in a fast predict selection of an application object, pulling an application object or a group of application objects toward a center of the display field, if movement is aligned with a single application, simultaneously, synchronously, asynchronously, or sequentially select and instant on the application, or continue monitoring the movement until a discrimination between application objects is predictively certain and simultaneously, synchronously, asynchronously, or sequentially selecting and activating the application object.

Thus, the industry must begin to start looking at everything as always on and what is on is always interactive, and may have different levels of interactivity. For instance, software should be an interactive field. Excel and word should be interactive fields where motion through them may combine or select areas, which correspond to cells and texts being intertwined with the motion. Excel sheets should be part of the same 3D field, not separate pages, and should have depth so their aspects can be combined in volume. The software desktop experience needs a depth where the desktop is the cover of a volume, and rolling back the desktop from different corners reveals different programs that are active and have different colors, such as word being revealed when moving from bottom right to top left and being a blue field, excel being revealed when moving from top left to bottom right and being red; moving right to left lifts desktop cover and reveals all applications in volume, each application with its own field and color in 3D space.

In other embodiments, the systems, apparatuses, and/or interfaces include an active screen area having a delete or backspace region. When the user moves the active object (cursor) toward the delete or backspace region, then the selected objects will be released one at a time or in groups or completely depending on attributes of movement toward the delete of backspace region. Thus, if the movement is slow and steady, then the selected objects are released one at a time. If the movement is fast, then multiple selected objects are released. Thus, the delete or backspace region is variable. For example, if the active display region represents a cell phone dialing pad (with the number distributed in any desired configuration from a traditional grid configuration to a arcuate configuration about the active object, or in any other desirable configuration), when by moving the active object toward the delete or backspace region, numbers will be removed from the number, which may be displayed in a number display region of the display. Alternatively, touching the backspace region would back up one letter; moving from right to left in the backspace region would delete (backspace) a corresponding amount of letters based on the distance (and/or speed) of the movement, The deletion could occur when the motion is stopped, paused, or a lift off event is detected. Alternatively, a swiping motion (jerk, or fast acceleration) could result in the deletion (backspace) the entire word. All these may or may not require a lift off event, but the motion dictates the amount deleted or released objects such as letters, numbers, or other types of objects. The same is true with the delete key, except the direction would be forward instead of backwards. Lastly, the same may be true in a radial menu (or linear or spatial), where the initial motion towards an object or on an object, or in a zone associated with an object, that has a variable attribute. The motion associated with or towards that object may provide immediate control.

In other embodiments, the systems, apparatuses, and/or interfaces utilize eye movement to select and body part movement is used to confirm or activate the selection. Thus, eye movement is used as the selective movement, while the object remains in the selected state, then the body part movement confirms the selection and activates the selected object. Thus, specifically stated the eye or eyes look in a different direction or area, and the last selected object would remain selected until a different object is selected by motion of the eyes or body, or until a time-out deselects the object. An object may be also selected by an eye gaze, and this selection would continue even when the eye or eyes are no longer looking at the object. The object would remain selected unless a different selectable object is looked at, or unless a timeout deselects the object occurs.

In all of the embodiments set forth above, the motion or movement may also comprise lift off events, where a finger or other body part or parts are in direct contract with a touch sensitive feedback device such as a touch screen, then the acceptable forms of motion or movement will comprise touching the screen, moving on or across the screen, lifting off from the screen (lift off events), holding still on the screen at a particular location, holding still after first contact, holding still after scroll commencement, holding still after attribute adjustment to continue an particular adjustment, holding still for different periods of time, moving fast or slow, moving fast or slow or different periods of time, accelerating or decelerating, accelerating or decelerating for different periods of time, changing direction, changing distance/displacement, changing duration, changing speed, changing velocity, changing acceleration, changing direction for different periods of time, changing speed for different periods of time, changing velocity for different periods of time, changing acceleration for different periods of time, or any combinations of these motions may be used by the systems and methods to invoke command and control over real world or virtual world controllable objects using on the motion only. Lift off or other events could “freeze” the state of menu, object or attribute selection, or combination of these, until another event occurs to move to a different event or state, or a time-out function resets the system or application to a preconfigured state or location. A virtual lift off could accomplish the same effect in a VR, AR or real environment, by moving in a different direction or designated direction with no physical lift off event. Of course, if certain objects that are invoked by the motion sensitive processing of the systems and methods of this disclosure require hard select protocols—mouse clicks, finger touches, etc., the invoked object's internal function will not be augmented by the systems or methods of this disclosure unless the invoked object permits or supports system integration. In place of physical or virtual lift offs or confirmations could be sounds, colors or contextual or environmental triggers.

The systems, apparatuses, and/or interfaces and the methods for implementing them are disclosed herein where command functions for selection and/or control of real and/or virtual objects may be generated based on a change in velocity at constant direction, a change in direction at constant velocity, a change in both direction and velocity, a change in a rate of velocity, or a change in a rate of acceleration or a change in distance/displacement and time. Once detected by an detector or sensor, these changes may be used by a processing unit to issue commands for controlling real and/or virtual objects. A selection or combination scroll, selection, and attribute selection may occur upon the first movement. Such motion may be associated with doors opening and closing in any direction, golf swings, virtual or real world games, light moving ahead of a runner, but staying with a walker, or any other motion having compound properties such as direction, angle, distance/displacement, duration, velocity, acceleration, and changes in any one or all of these primary properties; thus, direction, angle, distance/displacement, duration, velocity, and acceleration may be considered primary motion properties, while changes in these primary properties may be considered secondary motion or movement properties. The system may then be capable of differentially handling of primary and secondary motion or movement properties. Thus, the primary properties may cause primary functions to be issued, while secondary properties may cause primary function to be issued, but may also cause the modification of primary function and/or secondary functions to be issued. For example, if a primary function comprises a predetermined selection format, the secondary motion or movement properties may expand or contract the selection format.

In another example of this primary/secondary format for causing the system to generate command functions may involve an object display. Thus, by moving the object in a direction away from the user's eyes or using changes in angle, distance/displacement, velocity, acceleration/or time, the state of the display may change, such as from a graphic to a combination graphic and text, to a text display only, while moving side to side or moving a finger or eyes from side to side may scroll the displayed objects or change the font or graphic size, while moving the head to a different position in space might reveal or control attributes or submenus of the object. Thus, these changes in motions may be discrete, compounded, or include changes in velocity, acceleration and rates of these changes to provide different results for the user. These examples illustrate two concepts: 1) the ability to have compound motions which provide different results that the motions separately or sequentially, and (2) the ability to change states or attributes, such as graphics to text solely or in combination with single or compound motions, or with multiple inputs, such as verbal, touch, facial expressions, or bio-kinetically, all working together to give different results, or to provide the same results in different ways.

It must be recognized that the present disclosure while based on the use of sensed velocity, acceleration, and changes and rates of changes in these properties to effect control of real world objects and/or virtual objects, the present disclosure may also use other properties of the sensed motion in combination with sensed velocity, acceleration, and changes in these properties to effect control of real world and/or virtual objects, where the other properties include direction, angle, distance/displacement, duration and change in direction, angle, distance/displacement, duration of motion, where the motion has a constant velocity. For example, if the motion sensor(s) senses velocity, acceleration, changes in velocity, changes in acceleration, and/or combinations thereof that is used for primary control of the objects via motion of a primary sensed human, animal, part thereof, real world object under the control of a human or animal, or robots under control of the human or animal, then sensing motion of a second body part may be used to confirm primary selection protocols or may be used to fine tune the selected command and control function. Thus, if the selection is for a group of objects, then the secondary motion or movement properties may be used to differentially control object attributes to achieve a desired final state of the objects.

For example, suppose the apparatuses of this disclosure control lighting in a building. There are banks of lights on or in all four walls (recessed or mounted) and on or in the ceiling (recessed or mounted). The user has already selected and activated lights from a selection menu using motion to activate the apparatus and motion to select and activate the lights from a list of selectable menu items such as sound system, lights, cameras, video system, etc. Now that lights has been selected from the menu, movement to the right would select and activate the lights on the right wall. Movement straight down would turn all of the lights of the right wall down—dim the lights. Movement straight up would turn all of the lights on the right wall up—brighten. The velocity of the movement down or up would control the rate that the lights were dimmed or brighten. Stopping movement would stop the adjustment or removing the body, body part or object under the user control within the motion sensing area would stop the adjustment.

For even more sophisticated control using motion or movement properties, the user may move within the motion sensor active area to map out a downward concave arc, which would cause the lights on the right wall to dim proportionally to the arc distance from the lights. Thus, the right lights would be more dimmed in the center of the wall and less dimmed toward the ends of the wall.

Alternatively, if the movement was convex downward, then the light would dim with the center being dimmed the least and the ends the most. Concave up and convex up would cause differential brightening of the lights in accord with the nature of the curve.

Now, the apparatus may also use the velocity of the movement of the mapping out the concave or convex movement to further change the dimming or brightening of the lights. Using velocity, starting off slowly and increasing speed in a downward motion would cause the lights on the wall to be dimmed more as the motion moved down. Thus, the lights at one end of the wall would be dimmed less than the lights at the other end of the wall.

Now, suppose that the motion is a S-shape, then the light would be dimmed or brightened in a S-shaped configuration. Again, velocity may be used to change the amount of dimming or brightening in different lights simply by changing the velocity of movement. Thus, by slowing the movement, those lights would be dimmed or brightened less than when the movement is speed up. By changing the rate of velocity—acceleration—further refinements of the lighting configuration may be obtained.

Now suppose that all the lights in the room have been selected, then circular or spiral motion would permit the user to adjust all of the lights, with direction, angle, distance/displacement, duration, velocity and acceleration properties being used to dim and/or brighten all the lights in accord with the movement relative to the lights in the room. For the ceiling lights, the circular motion may move up or down in the z direction to affect the luminosity of the ceiling lights. Thus, through the sensing of motion or movement within an active sensor zone—area and especially volume, a user can use simple or complex motion to differentially control large numbers of devices simultaneously, synchronously, asynchronously or sequentially. By scrolling through the area (pointing the finger at each light) and stopping motion at each light desired it would be selected, then moving in a different direction would allow for attribute of only the selected lights. The same would hold for virtual objects in a 2D or 3D (VR/AR) environment. Thus, a user is able to select groups of objects that may represent real or virtual objects and once the group is selected, movement of the user may adjust all object and/or device attribute collectively. This feature is especially useful when the interface is associated with a large number of object, subobjects, and/or devices and the user wants to selected groups of these objects, subobjects, and/or devices so that they may be controlled collectively. Thus, the user may navigate through the objects, subobjects and/or devices and select any number of them by moving to each object pausing so that the system recognizes to add the object to the group. Once the group is defined, the user would be able to save the group as a predefined group or just leave it as a temporary group. Regardless, the group would not act as a single object for the remainder of the session. The group may be deselected by moving outside of the active field of sensor, sensors, and/or sensor arrays.

This differential control through the use of sensed complex motion permits a user to nearly instantaneously change lighting configurations, sound configurations, TV configurations, or any configuration of systems having a plurality of devices being simultaneously, synchronously, asynchronously, or sequentially controlled or of a single system having a plurality of objects or attributes capable of simultaneous, synchronous, asynchronous, or sequential control. For examples, in a computer game including large numbers of virtual objects such as troops, tanks, airplanes, etc., sensed complex motion would permit the user to quickly deploy, redeploy, rearrangement, manipulated and generally quickly reconfigure all controllable objects and/or attributes by simply conforming the movement of the objects to the movement of the user sensed by the motion detector. This same differential device and/or object control would find utility in military and law enforcement, where command personnel by motion or movement within a sensing zone of a motion sensor quickly deploy, redeploy, rearrangement, manipulated and generally quickly reconfigure all assets to address a rapidly changing situation.

The all of these scenarios set forth above are designed to illustrate the control of a large number of devices using properties and/or characteristics of the sensed motion including, without limitation, relative distance of the motion for each object (real like a person in a room using his/her hand as the object for which motion is being sensed or virtual representations of the objects in a virtual or rendered room on a display apparatus), direction of motion, distance/displacement of motion, duration of motion, speed of motion, acceleration of motion, changes an any of these properties, rates of changes in any of these properties, or mixtures and combinations thereof to control a single controllable attribute of the object such as lights. However, the systems, apparatuses, and methods of this disclosure are also capable of using motion or movement properties and/or characteristics to control two, three, or more attributes of an object. Additionally, the systems, apparatuses, and methods of this disclosure are also capable of using motion or movement properties and/or characteristics from a plurality of moving objects within a motion sensing zone to control different attributes of a collection of objects. For example, if the lights in the above figures are capable of color as well as brighten, then the motion or movement properties and/or characteristic may be used to simultaneously, synchronously, asynchronously or sequentially change color and intensity of the lights or one sensed motion could control intensity, while another sensed motion could control color. For example, if an artist wanted to paint a picture on a computer generated canvas, then motion or movement properties and/or characteristic would allow the artist to control the pixel properties of each pixel on the display using the properties of the sensed motion from one, two, three, etc. sensed motions. Thus, the systems, apparatuses, and methods of this disclosure are capable of converting the motion or movement properties associated with each and every object being controlled based on the instantaneous properties values as the motion traverse the object in real space or virtual space.

The systems, apparatuses and methods of this disclosure activate upon motion being sensed by one or more motion sensors. This sensed motion then activates the systems and apparatuses causing the systems and apparatuses to process the motion and its properties activating a selection object and a plurality of selectable objects. Once activated, the motion or movement properties cause movement of the selection object accordingly, which will cause a pre-selected object or a group of pre-selected objects, to move toward the selection object, where the pre-selected object or the group of pre-selected objects are the selectable object(s) that are most closely aligned with the direction of motion, which may be evidenced by the user feedback units by corresponding motion of the selection object. Another aspect of the systems or apparatuses of this disclosure is that the faster the selection object moves toward the pre-selected object or the group of preselected objects, the faster the pre-selected object or the group of preselected objects move toward the selection object. Another aspect of the systems or apparatuses of this disclosure is that as the pre-selected object or the group of pre-selected objects move toward the selection object, the pre-selected object or the group of pre selected objects may increase in size, change color, become highlighted, provide other forms of feedback, or a combination thereof. Another aspect of the systems or apparatuses of this disclosure is that movement away from the objects or groups of objects may result in the objects moving away at a greater or accelerated speed from the selection object(s). Another aspect of the systems or apparatuses of this disclosure is that as motion continues, the motion will start to discriminate between members of the group of pre-selected object(s) until the motion results in the selection of a single selectable object or a coupled group of selectable objects. Once the selection object and the target selectable object touch, active areas surrounding the objection touch, a threshold distance between the object is achieved, or a probability of selection exceeds an activation threshold, the target object is selected and non-selected display objects are removed from the display, change color or shape, or fade away or any such attribute so as to recognize them as not selected. The systems or apparatuses of this disclosure may center the selected object in a center of the user feedback unit or center the selected object at or near a location where the motion was first sensed. The selected object may be in a corner of a display—on the side the thumb is on when using a phone, and the next level menu is displayed slightly further away, from the selected object, possibly arcuately, so the next motion is close to the first, usually working the user back and forth in the general area of the center of the display. If the object is an executable object such as taking a photo, turning on a device, etc., then the execution is simultaneous, synchronous, asynchronous or sequential with selection. If the object is a submenu, sublist or list of attributes associated with the selected object, then the submenu members, sublist members or attributes are displayed on the screen in a spaced apart format. The same procedure used to select the selected object is then used to select a member of the submenu, sublist or attribute list. Thus, the interfaces have a gravity like or anti-gravity like action on display objects. As the selection object(s) moves, it attracts an object or objects in alignment with the direction of the selection object's motion pulling those object(s) toward it and may simultaneously, synchronously, asynchronously or sequentially repel non-selected items away or indicate non-selection in any other manner so as to discriminate between selected and non-selected objects As motion continues, the pull increases on the object most aligned with the direction of motion, further accelerating the object toward the selection object until they touch or merge or reach a threshold distance determined as an activation threshold. The touch or merge or threshold value being reached causes the processing unit to select and activate the object(s). Additionally, the sensed motion may be one or more motions detected by one or more movements within the active zones of the motion sensor(s) giving rise to multiple sensed motions and multiple command function that may be invoked simultaneously, synchronously, asynchronously or sequentially. The sensors may be arrayed to form sensor arrays. If the object is an executable object such as taking a photo, turning on a device, etc., then the execution is simultaneous, synchronous, asynchronous or sequential with selection. If the object is a submenu, sublist or list of attributes associated with the selected object, then the submenu members, sublist members or attributes are displayed on the screen in a spaced apart format. The same procedure used to select the selected object is then used to select a member of the submenu, sublist or attribute list. Thus, the interfaces have a gravity like action on display objects. As the selection object moves, it attracts an object or objects in alignment with the direction of the selection object's motion pulling those object toward it. As motion continues, the pull increases on the object most aligned with the direction of motion, further accelerating the object toward the selection object until they touch or merge or reach a threshold distance determined as an activation threshold to make a selection. The touch, merge or threshold event causes the processing unit to select and activate the object.

The sensed motion may result not only in activation of the systems, apparatuses, and/or interfaces, but may be result in select, attribute control, activation, actuation, scroll or combination thereof.

In other embodiments, the systems, apparatuses, and/or interfaces may utilize different unit feedback formats including haptic or tactile outputs, audio outputs, any other cognizable feedback formats to indicate or evident user interaction with the systems, apparatuses, and/or interfaces. For example, if the user moving through radial zones, different objects may produce different buzzes or sounds, and the intensity or pitch may change while moving in that zone to indicate whether the object is in front of or behind the user.

Compound motions may also be used so as to provide different control function than the motions made separately or sequentially. This includes combination attributes and changes of both state and attribute, such as tilting the device to see graphics, graphics and text or text, along with changing scale based on the state of the objects, while providing other controls simultaneously, synchronously, asynchronously, sequentially or independently, such as scrolling, zooming in/out, or selecting while changing state. These features may also be used to control chemicals being added to a vessel, while simultaneously, synchronously, asynchronously or sequentially controlling the amount. These features may also be used to change between operating systems such as between Windows® 8 and Windows® 7 with a tilt while moving icons or scrolling through programs at the same time.

Audible or other communication medium may be used to confirm object selection or in conjunction with motion so as to provide desired commands (multimodal) or to provide the same control commands in different ways.

In other embodiments, the systems, apparatuses, and/or interfaces and the methods for implementing them may also include artificial intelligence components that learn from a user's interaction with the systems, apparatuses, and/or interfaces including movement characteristics, environmental characteristics (e.g., motion sensor types, processing unit types, or other environment properties), controllable object environmental characteristics, etc. to improve the performance of the systems, apparatuses, and/or interfaces and to improve prediction capability of the systems, apparatuses, and/or interfaces to anticipate user activities.

Embodiments of this disclosure further relate to systems for selecting and activating virtual or real objects and their controllable attributes including at least one motion sensor having an active sensing zone, at least one processing unit, at least one power supply unit, and one object or a plurality of objects under the control of the processing units. The sensors, processing units, and power supply units are in electrical communication with each other. The motion sensors sense motion including motion or movement properties within the active zones, generate at least one output signal, and send the output signals to the processing units. The processing units convert the output signals into at least one command function. The command functions include (1) a start function, (2) a scroll function, (3) a select function, (4) an attribute function, (5) an attribute control function, (6) a simultaneous, synchronous, asynchronous or sequential control function including: (a) a select and scroll function, (b) a select, scroll and activate function, (c) a select, scroll, activate, and attribute control function, (d) a select and activate function, (e) a select and attribute control function, (f) a select, activate, and attribute control function, or (g) combinations thereof, or (7) combinations thereof. The start functions activate at least one selection or cursor object and a plurality of selectable objects upon first sensing motion by the motion sensors and selectable objects aligned with the motion direction move toward the selection object or become differentiated from non-aligned selectable objects and motion continues until a target selectable object or a plurality of target selectable objects are discriminated from non-target selectable objects resulting in activation of the target object or objects. The motion or movement properties include a touch, a lift off, a direction, a distance/displacement, a duration, a velocity, an acceleration, a change in direction, a change in distance/displacement, a change in duration, a change in velocity, a change in acceleration, a rate of change of direction, a rate of change of distance/displacement, a rate of change of duration, a rate of change of velocity, a rate of change of acceleration, stops, holds, timed holds, or mixtures and combinations thereof. The objects comprise real world objects, virtual objects and mixtures or combinations thereof, where the real world objects include physical, mechanical, electro-mechanical, magnetic, electro-magnetic, electrical, or electronic devices or any other real world device that can be controlled by a processing unit and the virtual objects include any construct generated in a virtual world or by a computer and displayed by a display device and that are capable of being controlled by a processing unit. The attributes comprise activatable, executable and/or adjustable attributes associated with the objects. The changes in motion or movement properties are changes discernible by the motion sensors sensor outputs, and/or the processing units.

In certain embodiments, the start functions further activate the user feedback units and the selection objects and the selectable objects are discernible via the motion sensors in response to movement of an animal, human, robot, robotic system, part or parts thereof, or combinations thereof within the motion sensor active zones. In other embodiments, the system further includes at least on user feedback unit, at least one battery backup unit, communication hardware and software, at least one remote control unit, or mixtures and combinations thereof, where the sensors, processing units, power supply units, the user feedback units, the battery backup units, the remote control units are in electrical communication with each other. In other embodiments, faster motion causes a faster movement of the target object or objects toward the selection object or causes a greater differentiation of the target object or object from the non-target object or objects. In other embodiments, if the activated objects or objects have subobjects and/or attributes associated therewith, then as the objects move toward the selection object, the subobjects and/or attributes appear and become more discernible as object selection becomes more certain. In other embodiments, once the target object or objects have been selected, then further motion within the active zones of the motion sensors causes selectable subobjects or selectable attributes aligned with the motion direction to move towards the selection object(s) or become differentiated from non aligned selectable subobjects or selectable attributes and motion continues until a target selectable subobject or attribute or a plurality of target selectable objects and/or attributes are discriminated from non-target selectable subobjects and/or attributes resulting in activation of the target subobject, attribute, subobjects, or attributes. In other embodiments, the motion sensor is selected from the group consisting of digital cameras, optical scanners, optical roller ball devices, touch pads, inductive pads, capacitive pads, holographic devices, laser tracking devices, thermal devices, acoustic devices, any other device capable of sensing motion, arrays of motion sensors, and mixtures or combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, computer operating systems, virtual reality systems, augmented reality systems, graphics systems, business software systems, word processor systems, internet browsers, accounting systems, military systems, control systems, other software systems, programs, routines, objects and/or elements, remote control systems, or mixtures and combinations thereof. In other embodiments, if the timed hold is brief, then the processing unit causes an attribute to be adjusted to a preset level. In other embodiments, if the timed hold is continued, then the processing unit causes an attribute to undergo a high value/low value cycle that ends when the hold is removed. In other embodiments, the timed hold causes an attribute value to change so that (1) if the attribute is at its maximum value, the timed hold causes the attribute value to decrease at a predetermined rate, until the timed hold is removed, (2) if the attribute value is at its minimum value, then the timed hold causes the attribute value to increase at a predetermined rate, until the timed hold is removed, (3) if the attribute value is not the maximum or minimum value, then the timed hold causes randomly selects the rate and direction of attribute value change or changes the attribute to allow maximum control, or (4) the timed hold causes a continuous change in the attribute value in a direction of the initial motion until the timed hold is removed. In other embodiments, the motion sensors sense a second motion including second motion or movement properties within the active zones, generate at least one output signal, and send the output signals to the processing units, and the processing units convert the output signals into a confirmation command confirming the selection or at least one second command function for controlling different objects or different object attributes. In other embodiments, the motion sensors sense motions including motion or movement properties of two or more animals, humans, robots, or parts thereof, or objects under the control of humans, animals, and/or robots within the active zones, generate output signals corresponding to the motions, and send the output signals to the processing units, and the processing units convert the output signals into command function or confirmation commands or combinations thereof implemented simultaneously, synchronously, asynchronously or sequentially, where the start functions activate a plurality of selection or cursor objects and a plurality of selectable objects upon first sensing motion by the motion sensor and selectable objects aligned with the motion directions move toward the selection objects or become differentiated from non-aligned selectable objects and the motions continue until target selectable objects or pluralities of target selectable objects are discriminated from non-target selectable objects resulting in activation of the target objects and the confirmation commands confirm the selections.

The inventors have found that systems and methods implemented on a processing unit such as a computer may be constructed that permit the creation of dynamic environments for object and/or attribute display, manipulation, differentiation, and/or interaction, where the systems include one processing unit or a plurality of processing units, one motion sensor or a plurality of motion sensors, one user interface or a plurality of user interfaces and dynamic environment software for generating, displaying, and manipulating the dynamic environments and the objects and/or attributes included therein. The dynamic environments are produced via user interaction with the sensor(s), which are in electronic communication with the processing unit(s), and comprise a set of objects and associated attributes displayed on the user interface(s) so that the objects and/or attributes are differentiated one from the other. The differentiation may evidence priority, directionality, content, type, activation procedures, activation parameters, control features, other properties that are associated with the objects and/or attributes or combinations thereof. The differentiation and distribution of the objects and/or attributes may change based on user interaction with the motion sensors and/or locations of the motion sensors, where at least one motion sensor or sensor output is associated with a mobile or stationary device or where at least one motion sensor or sensor output is associated with a mobile device and at least one motion sensor or sensor output is associated with a stationary device, and mixtures or combinations thereof. Of course, these same procedures may be used with objects and/or attributes at any level of drill down.

In certain embodiments, the systems and methods of this disclosure activation of the system causes a plurality of selectable objects to be displayed on a display device of a user interface associated with the systems. The selectable objects may be represent: (1) objects that may directly invoked, (2) objects that have a single attribute, (3) objects that have a plurality of attributes, (4) objects that are lists or menus that may include sublists or submenus, (5) any other selectable item, or (6) mixtures and combinations thereof. The objects may represent virtual or real objects. Virtual objects may be any object that represents an internal software component. Real object may be executable programs or software application or may be real world devices that may be controlled by the systems and/or methods. The displayed selectable objects may be a default set of selectable objects, pre-defined set of selectable objects, or a dynamically generated set of selectable objects, generated based on locations of the sensors associated with mobile devices and the motion sensors associated with stationary devices. The systems and methods permit the selectable objects to interact with the user dynamically so that object motion within the environments better correlates with the user ability to interact with the objects. The user interactions include, but are not limited to: (a) object discrimination based on sensed motion, (b) object selection base on sensed motion, (c) menu drill down based on sensed motion, (d) menu drill up based on sensed motion, (e) object selection and activation based on sensed motion and on the nature of the selectable object, (f) scroll/selection/activation based on sensed motion and on the nature of the selectable object, and (g) any combination of the afore listed interactions associated with a collection of linked objects, where the linking may be pre-defined, based on user gained interaction knowledge, or dynamically generated based on the user, sensor locations, and the nature of the sensed motion. The systems and methods may also associate one or a plurality of object differentiation properties with the displayed selectable objects, where the nature of the differentiation for each object may be predefined, defined based on user gained interaction knowledge, or dynamically generated based on the user, sensor locations, and/or the nature of the sensed motion. The differentiation properties include, but are not limited to: color; color shading; spectral attributes associated with the shading; highlighting; flashing; rate of flashing; flickering; rate of flickering; shape; size; movement of the objects such as oscillation, side to side motion, up and down motion, in and out motion, circular motion, elliptical motion, zooming in and out, etc.; rate of motion; pulsating; rate of pulsating; visual texture; touch texture; sounds such as tones, squeals, beeps, chirps, music, etc.; changes of the sounds; rate of changes in the sounds; any user discernible object differentiation properties, or any mixture and combination thereof. The differentiation may signify to the user a sense of direction, object priority, object sensitivity, etc., all helpful to the user for dynamic differentiation of selectable objects displayed on the display derived from the user, sensed motion, and/or the location of the mobile and stationary sensors.

For example, one displayed object may pulsate (slight zooming in and out, or expanding and contracting) at a first rate, while another displayed object may pulsate a second rate, where the first and second rates may be the same or different, and a faster pulsation rate may be associated with a sense of urgency relative to objects having a slower rate of pulsation. These rates may change in a pre-defined manner, a manner based on knowledge of the user, or dynamically based on the user, sensor locations, and/or the nature of the sensed motion.

In another example, a set of objects may slightly move to the right faster than they move back to the left, indicating that the user should approach the objects from the right, instead from another direction.

In certain embodiments, a main object may have one or a plurality of sub-objects moving (constant or variable rate and/or direction) around or near the main object, indicating the nature of the sub-objects. In this case, sub-objects revolving around the main object may represent that they need to be interacted with in a dynamic, motion-based way, whereas the main object may be interacted with in a static manner such as a vocal command, hitting a button, clicking, or by any other non-dynamic or static interaction.

In other embodiments, a main object may have a certain color, such as blue, and its associated sub-objects have shades of blue, especially where the sub-objects dynamically transition from blue to off-blue or blue-green or other related colors, displaying they come from the primary blue object, whereas a red Object next to the blue one might have sub-objects that transition to orange, while a sub-object that transitions to purple might represent it is a sub-set of blue and red and can be accessed through either.

In other embodiments, the objects or sub-objects may fade in or out, representing changes of state based on a time period that the user interacts with them. By fading out, the systems may be notifying the user that the program or application (e.g., water flow in a building) will be entering a sleep or interruption state. The rate of the fade out may indicate how quickly the program or application transitions into a sleep state and how quickly they reactivate. A fade-in might relay the information that the object will automatically initiate over a given time automatically vs. manually.

In other embodiments, an array of objects, such as the screen of applications on a mobile device, the objects pulsing might represent programs that are active, whereas the objects that are static might represent programs that are inactive. Programs that are pulsing at a slower rate might represent programs running occasionally in the background. Of course, other dynamic indicators, such as changes in color, intensity, translucency, size, shape, or any recognizable attribute, may be used to relay information to the user.

Another example of the operation of the systems and methods of this disclosure may be in a medical context. In such a case, the objects displayed on the user interface may be an array of sensors active in an operating room including, but not limited to, oxygen sensors, blood flow sensors, pulse rate sensors, heart beat rate, blood pressure sensors, brain activity sensors, etc. The different dynamic changes in color, shape, size, sound, and/or movement of the objects may represent data associated with the sensors, providing multiple points of information in a simple, compounded way to the user. If color represented oxygen level, size represented pressure, and dynamic movement of the object represented heartbeat, one object could represent a great deal of information to the user.

The characteristics of associated sub-objects seen simultaneously, synchronously, asynchronously or sequentially after the primary objects are selected and may likewise provide much more information than just letting the user know more information exists—in this case, the primary object would be labeled with the corresponding body position and the sub-object representing oxygen level past and current data might be pulsing or intensifying dynamically in color, while the blood pressure sub-object might be slightly growing larger or smaller with each heartbeat, representing minimal change in blood pressure, and the heartbeat might be represented by the object rotating CW, then CCW with each heartbeat.

In another example, one object (or word in a word document) swapping places with another might represent the need to change the word to provide better grammar for a sentence. Spelling changes might be represented by pulsing words, and words that are acceptable, but have a better common spelling might be represented by words that pulse at a slower rate. Dynamic changes of color might also be associated with the words or other characteristics to draw attention to the user and give secondary information at the same time, such as which words that might be too high or too low of a grade level for the reader in school books.

Thus, any combination of dynamic characteristics maybe used to provide more information to the user than a static form of information, and may be used in conjunction with the static information characteristic.

In certain embodiments, objects (such as application icons) may have several possible states and display states. An object may be in an unselected state, a present state (available for selection but with no probability of being selected yet), a pre-selected (now probable, but not meeting a threshold criteria for being selected), a selected state (selected but not opened or having an execute command yet issued), or an actuated state (selected and having an attribute executed (i.e., on (vs. off), variable control ready to change based on moving up or down, or a submenu is displayed and ready to be selected). If the object is in a group of objects, as the user moves towards that group, the zone and/or the group of objects may display or present a different characteristic that represents they are ready to be selected; this may be identified as a pre-selected state. In each state, the objects may display different characteristics to convey information to the user, such as change of shape, size, color, sound, smell, feel, pulse rate, different dynamic directional animations, etc. For instance, before a user touches a mobile device (one with a touch sensor), the objects may be in an unselected state, displaying no attribute other than the common static display currently employed. Once a user touches the screen, the items that need attention might change in color (present, but no different probability of being selected than any others). As the user begins to move in the direction of an object desired, the more likely objects may begin to display differently, such as increasing in size, or begin pulsing, and as the probability increases, the pulse rate may increase, but objects in more urgent need of attention may pulse differently or even faster than others in the same group or zone—pre-selected. Once the correct object(s) is selected, it may show and even different state, such as displaying subobjects, changing color, or making a sound, but it still may not be open or actuated yet. If the attribute is volume control, it may be selected, but would not control volume until it is actuated by moving up or down, adjusting the volume. Of course, objects in an unselected state may show dynamic characteristics (pulsing for example) as well to convey information to the user, such as activity or priority. In this way, it may have a dynamic characteristic while in a static state.

In another example, for applications in the corner of a mobile device, when, head or eye gaze is directed towards that zone or objects, they may be in an unselected, preselected, or selected but not actuated state, and they may demonstrate dynamic indicators/attributes to convey intent, attributes, sub-attributes, or mixed or combination content or attributes with changing environments. They may display differently at any state, or only at one particular state (such as selected), and this may be a preset value, or something dynamic, such as contextual or environmental factors. An example of this last dynamic characteristic indicator would be in a vehicle or virtual reality display where the song playlist would cause a pulsing effect on preferred songs, but different songs would pulse differently when another occupant or player enters the environment, indicating the suggested objects would change due a combination of user preferences, and the dynamic display characteristics of all or some of the objects would change to indicate a combination preferential selections).

The dynamic environment systems of this disclosure may also be used in virtual reality systems and/or augmented reality systems so that players or users of these virtual reality systems and/or augmented reality systems through motion and motion properties are able to select, target, and/or deselect features, menus, objects, constructs, constructions, user attributes, weapons, personal attributes, personal features, any other selectable or user definable features or attributes of the virtual space or augmented reality space. Thus, as a user enters first enters a virtual reality space or augment reality space, all of the selectable or definable features and/or attributes of the space would be displayed about the user in any desired form—2D and/or 3D semicircular or hemispherical array with user at center, 2D and/or 3D circular or spherical array with user at center, 2D and/or 3D matrix array with user at center or off-center, any other 2D and/or 3D display of features and attributes, or mixtures and combinations thereof. As the user moves a body part associated with the motion detectors used to interface with the space (visual—eye tracking sensors, hand part sensors—gloves or the like, body sensors—body suits, or other sensors), the sensed motions and motion properties such as direction, angle, distance/displacement, duration, speed, acceleration, and/or changes in any of these motion properties cause features and/or attributes to display differently based on state and information to display to the user, and may move toward the user based on the motion and motion or movement properties of the object and/or the user, while the other features and/or attributes stay static or move away from the user. An example of this is to move towards a particular tree in a group of trees in a game. As the user looks toward a particular tree, the tree might shake while the others sway gently, as the user moves toward the tree, the tree may begin to move towards the user at a faster rate, if has a special prize associated with it, or at a slower rate in no prize. If the special prize is a one of a kind attribute, the tree may change color or size at it moves towards the user and the user is moving towards the tree. Once the tree is selected via a threshold event, it may change shape into the prize it held, and then the start to act like that prize when it is selected by the user moving the hand towards a designated area of the object enough to actuate. These different attributes or characteristics are part of a dynamic environment where the speed, direction, angle, distance/displacement, duration, state, display characteristics and attributes are affected by motion of the user and object, or any combination of these. In another example, where it is desired to choose one object, as the motion or motion properties of user(s), object(s) or both continue, the features and/or attributes are further of user, objects or both are discriminated, and the target features and/or attributes may move closer. Once the target is fully differentiated, then all subfeatures and/or subobjects may become visible. As motion continues, features and/or attributes and/or subfeatures and/or subobjects are selected and the user gains the characteristics or features the user desires in the space. All of the displayed features and/or attributes and/or subfeatures and/or subobjects may also include highlighting features such as sound (chirping, beeping, singing, etc.), vibration, back and forth movement, up and down movement, circular movement, etc.***

Embodiments of this disclosure relate broadly to computing devices, comprising at least one sensor or sensor output configured to capture data including user data, motion data, environment data, temporal data, contextual data, and/or mixtures and combinations thereof. The computing device also includes at least one processing unit configured, based on the captured data, to generate at least one command function. The command functions comprise: (1) a single control function including (a) a start function, (b) a scroll function, (c) a select function, (d) an attribute function, (e) an activate function, or (f) mixtures and combinations thereof. The command functions also comprise: (2) a simultaneous, synchronous, asynchronous, or sequential control function including (a) a combination of two or more of the functions (1a-1e), (b) a combination of three or more of the functions (1a-1e), (c) a combination of four or more of the functions (1a-1e), (d) mixtures and combinations thereof. The command functions may also comprise (3) mixtures and combinations of any of the above functions. In certain embodiments, the at least one sensor comprises touch pads, touchless pads, inductive sensors, capacitive sensors, optical sensors, acoustic sensors, thermal sensors, optoacoustic sensors, electromagnetic field (EMF) sensors, wave or waveform sensors, strain gauges, accelerometers, any other sensor that senses movement or changes in movement, or mixtures and combinations thereof. In other embodiments, a first control function is a single control function. In other embodiments, a first control function is a single control function and a second function is a simultaneous, synchronous, asynchronous or sequential control function. In other embodiments, a first control function is a simultaneous, synchronous, asynchronous or sequential control function. In other embodiments, a first control function is a simultaneous, synchronous, asynchronous or sequential control function and a second function is a simultaneous, synchronous, asynchronous or sequential control function. In other embodiments, a plurality of single and simultaneous, synchronous, asynchronous or sequential control functions are actuated by user determined motion.

Embodiments of this disclosure relate broadly to computer implemented methods, comprising under the control of a processing unit configured with executable instructions, receiving data from at least one sensor configured to capture the data, where the captured data includes user data, motion data, environment data, temporal data, contextual data, or mixtures and combinations thereof. The methods also comprise processing the captured data to determine a type or types of the captured data; analyzing the type or types of the captured data; and invoking a control function corresponding to the analyzed data. The control functions comprise: (1) a single control function including: (a) a start function, (b) a scroll function, (c) a select function, (d) an attribute function, (e) an activate function, or (f) mixtures and combinations thereof, or (2) a simultaneous, synchronous, asynchronous or sequential control function including: (a) a combination of two or more of the functions (1a-1e), (b) a combination of three or more of the functions (1a-1e), (c) a combination of four or more of the functions (1a-1e), (d) mixtures and combinations thereof, or (3) mixtures and combinations thereof. In certain embodiments, the at least one sensor comprises touch pads, touchless pads, inductive sensors, capacitive sensors, optical sensors, acoustic sensors, thermal sensors, optoacoustic sensors, electromagnetic field (EMF) sensors, strain gauges, accelerometers, any other sensor that senses movement or changes in movement, or mixtures and combinations thereof. In other embodiments, a first control function is a single control function. In other embodiments, a first control function is a single control function and a second function is a simultaneous, synchronous, asynchronous or sequential control function. In other embodiments, a first control function is a simultaneous, synchronous, asynchronous or sequential control function. In other embodiments, a first control function is a simultaneous, synchronous, asynchronous or sequential control function and a second function is a simultaneous, synchronous, asynchronous or sequential control function. In other embodiments, a plurality of single and simultaneous, synchronous, asynchronous or sequential control functions are actuated by user determined motion.

Embodiments of this disclosure relate broadly to non-transitory computer readable storage media storing one or more sequences of instructions that, when executed by one or more processing units, cause a computing system to: (a) receive data from at least one sensor configured to capture the data, where the captured data includes user data, motion data, environment data, temporal data, contextual data, or mixtures and combinations thereof; (b) process the captured data to determine a type or types of the captured data; (c) analyze the type or types of the captured data; and (d) invoke a control function corresponding to the analyzed data. The control functions comprise (1) a single control function including: (a) a start function, (b) a scroll function, (c) a select function, (d) an attribute function, (e) an activate function, or (f) mixtures and combinations thereof, or (2) a simultaneous, synchronous, asynchronous or sequential control function including: (a) a combination of two or more of the functions (1a-1e), (b) a combination of three or more of the functions (1a-1e), (c) a combination of four or more of the functions (1a-1e), (d) mixtures and combinations thereof, or (3) mixtures and combinations thereof. In certain embodiments, the at least one sensor comprises touch pads, touchless pads, inductive sensors, capacitive sensors, optical sensors, acoustic sensors, thermal sensors, optoacoustic sensors, electromagnetic field (EMF) sensors, strain gauges, accelerometers, any other sensor that senses movement or changes in movement, or mixtures and combinations thereof. In other embodiments, a first control function is a single control function. In other embodiments, a first control function is a single control function and a second function is a simultaneous, synchronous, asynchronous or sequential control function. In other embodiments, a first control function is a simultaneous, synchronous, asynchronous or sequential control function. In other embodiments, a first control function is a simultaneous, synchronous, asynchronous or sequential control function and a second function is a simultaneous, synchronous, asynchronous or sequential control function. In other embodiments, a plurality of single and simultaneous, synchronous, asynchronous or sequential control functions are actuated by user determined motion.

Embodiments of this disclosure relate broadly to computer-implemented systems comprising a digital processing device comprising at least one processor, an operating system configured to perform executable instructions, and a memory; a computer program including instructions executable by the digital processing device to create a gesture-based navigation environment. The environment comprises a software module configured to receive input data from a motion sensor, the input data representing navigational gestures of a user; a software module configured to present one or more primary menu items; and a software module configured to present a plurality of secondary menu items in response to receipt of input data representing a navigational gesture of the user indicating selection of a primary menu item, the secondary menu items arranged in a curvilinear orientation about the selected primary menu item. The environment operates such that in response to receipt of input data representing a navigational gesture of the user comprising motion substantially parallel to the curvilinear orientation, the plurality of secondary menu items scrolls about the curvilinear orientation; in response to receipt of input data representing a navigational gesture of the user substantially perpendicular to the curvilinear orientation, an intended secondary menu item in line with the direction of the navigational gesture is scaled and moved opposite to the direction of the navigational gesture to facilitate user access. In certain embodiments, the processing device or unit is a smart watch and the motion sensor is a touchscreen display.

Embodiments of this disclosure relate broadly to non-transitory computer-readable storage media encoded with a computer program including instructions executable by a processor to create a gesture-based or motion-based navigation environment comprising: a software module configured to receive input data from a motion sensor, the input data representing navigational movement of a user; a software module configured to present one or more primary menu items; and a software module configured to present a plurality of secondary menu items in response to receipt of input data representing a navigational gesture or movement of the user indicating selection of a primary menu item, the secondary menu items arranged in a curvilinear orientation about the selected primary menu item. The environment operates such that in response to receipt of input data representing a navigational gesture or movement of the user comprising motion substantially parallel to the curvilinear orientation, the plurality of secondary menu items scrolls about the curvilinear orientation; and in response to receipt of input data representing a navigational gesture or movement of the user substantially perpendicular to the curvilinear orientation, an intended secondary menu item in line with the direction of the navigational gesture or movement is scaled and moved opposite to the direction of the navigational gesture or movement to facilitate user access. In certain embodiments, the processor is a smart watch or wearable device and the motion sensor is a touchscreen display.

Embodiments of this disclosure relate broadly to systems for selecting and activating virtual or real objects and their controllable attributes comprising: at least one motion sensor having an active sensing zone, at least one processing unit, at least one power supply unit, one object or a plurality of objects under the control of the processing units. The sensors, processing units, and power supply units are in electrical communication with each other. The motion sensors sense motion including motion or movement properties within the active zones, generate at least one output signal, and send the output signals to the processing units. The processing units convert the output signals into
at least one command function. The command functions comprise: (1) a start function, (2) a scroll function, (3) a select function, (4) an attribute function, (5) an attribute control function, (6) a simultaneous, synchronous, asynchronous, or sequential control function, and/or (7) combinations thereof. The simultaneous, synchronous, asynchronous, or sequential control functions include: (a) a select and scroll function, (b) a select, scroll and activate function, (c) a select, scroll, activate, and attribute control function, (d) a select and activate function, (e) a select and attribute control function, (f) a select, activate, and attribute control function, or (g) combinations thereof. The start functions activate at least one selection or cursor object
and a plurality of selectable objects upon first sensing motion by the motion sensors and selectable objects aligned with the motion direction move toward the selection object or become differentiated from non-aligned selectable objects and motion continues until a target selectable object or a plurality of target selectable objects are discriminated from non-target selectable objects resulting in activation of the target object or objects. The motion or movement properties include a touch, a lift off, an angle, a direction, a distance/displacement, a duration, a velocity, an acceleration, a change in direction, a change in distance/displacement, a change in duration, a change in velocity, a change in acceleration, a rate of change of direction, a rate of change of distance/displacement, a rate of change of duration, a rate of change of velocity, a rate of change of acceleration, stops, holds, timed holds, and/or mixtures and combinations thereof. The objects comprise real world objects, virtual objects and mixtures or combinations thereof, where the real world objects include physical, mechanical, electro-mechanical, magnetic, electro-magnetic, electrical, or electronic devices or any other real world device that can be controlled by a processing unit and the virtual objects include any construct generated in a virtual world or by a computer and displayed by a display device and that are capable of being controlled by a processing unit. The attributes comprise selectable, activatable, executable and/or adjustable attributes associated with the objects. The changes in motion or movement properties are changes discernible by the motion sensors and/or
the processing units. In certain embodiments, the start functions further activate the user feedback units and the selection objects and the selectable objects are discernible via the motion sensors in response to movement of an animal, human, robot, robotic system, part or parts thereof, or combinations thereof within the motion sensor active zones. In other embodiments, the systems further comprise: at least on user feedback unit, at least one battery backup unit, communication hardware and software, at least one remote control unit, or mixtures and combinations thereof. The sensors, processing units, power supply units, the user feedback units, the battery backup units, the remote control units are in electrical communication with each other. In other embodiments, the systems further comprise: at least one battery backup unit, where the battery backup units are in electrical communication with the other hardware and units. In other embodiments, faster motion causes a faster movement of the target object or objects toward the selection object or objects or causes a greater differentiation of the target object or objects from non-target object or objects. In other embodiments, the non-target object or objects move away from the selection object as the target object or objects move toward the selection object or objects to aid in object differentiation. In other embodiments, the target objects and/or the non-target objects are displayed in list, group, or array forms and are either partially or wholly visible or partially or wholly invisible. In other embodiments, if the activated object or objects have subobjects and/or attributes associated therewith, then as the object or objects move toward the selection object, the subobjects and/or attributes appear and become more discernible as the target object or objects becomes more certain. In other embodiments, the target subobjects and/or the non-target subobjects are displayed in list, group, or array forms and are either partially or wholly visible or partially or wholly invisible. In other embodiments, once the target object or objects have been selected, then further motion within the active zones of the motion sensors causes selectable subobjects or selectable attributes aligned with the motion direction to move towards, away and/or at an angle to the selection object(s) or become differentiated from non-aligned selectable subobjects or selectable attributes and motion continues until a target selectable subobject or attribute or a plurality of target selectable objects and/or attributes are discriminated from non-target selectable subobjects and/or attributes resulting in activation of the target subobject, attribute, subobjects, or attributes. In other embodiments, the motion sensor is selected from the group consisting of digital cameras, optical scanners, optical roller ball devices, touch pads, inductive pads, capacitive pads, holographic devices, laser tracking devices, thermal devices, acoustic devices, any other device capable of sensing motion, arrays of motion sensors, waveform sensors, sensing devices, and mixtures or combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, computer operating systems, software elements, software routines, graphics systems, business software systems, word processor systems, internet browsers, accounting systems, military software systems, virtual reality systems, augmented reality systems, mixed reality systems, software controlling mixed, augmented, and/or virtual reality environments, biometric systems, neurological systems, drone controls, and systems, software control systems, other software systems, programs, routines, objects and/or elements, remote control systems, and/or mixtures and combinations thereof. In other embodiments, if the timed hold is brief, then the processing unit causes an attribute to be adjusted to a preset level. In other embodiments, if the timed hold is continued, then the processing unit causes an attribute to undergo a high value/low value cycle that ends when the hold is removed. In other embodiments, the timed hold causes an attribute value to change so that (1) if the attribute is at its maximum value, the timed hold causes the attribute value to decrease at a predetermined rate, until the timed hold is removed, (2) if the attribute value is at its minimum value, then the timed hold causes the attribute value to increase at a predetermined rate, until the timed hold is removed, (3) if the attribute value is not the maximum or minimum value, then the timed hold causes randomly selects the rate and direction of attribute value change or changes the attribute to allow maximum control, or (4) the timed hold causes a continuous change in the attribute value in a direction of the initial motion until the timed hold is removed. In other embodiments, the motion sensors sense a second motion including second motion or movement properties within the active zones, generate at least one output signal, and send the output signals to the processing units, and the processing units convert the output signals into a confirmation command confirming the selection or at least one second command function for controlling different objects or different object attributes. In other embodiments, the motion sensors sense motions including motion or movement properties of two or more animals, humans, robots, or parts thereof, or objects under the control of humans, animals, and/or robots within the activate zones, generate output signals corresponding to the motions, and send the output signals to the processing units, and the processing units convert the output signals into command function or confirmation commands or combinations thereof implemented simultaneously, synchronously, asynchronously, or sequentially, where the start functions activate a plurality of selection or cursor objects and a plurality of selectable objects upon first sensing motion by the motion sensor and selectable objects aligned (co-linear with or the same angle) with the motion directions move toward the selection objects or become differentiated from non-aligned selectable objects and the motions continue until target selectable objects or pluralities of target selectable objects are discriminated from non-target selectable objects resulting in activation of the target objects and the confirmation commands confirm the selections.

Embodiments of this disclosure relate broadly to methods for controlling objects comprising: sensing motion including motion or movement properties within an active sensing zone of at least one motion sensor, where the motion or movement properties include a direction, an angle, a distance/displacement, a duration, a velocity, an acceleration, a change in direction, a change in distance/displacement, a change in duration, a change in velocity, a change in acceleration, a rate of change of direction, a rate of change of distance/displacement, a rate of change of duration, a rate of change of velocity, a rate of change of acceleration, stops, holds, timed holds, and/or mixtures and combinations thereof, producing an output signal or a plurality of
output signals corresponding to the sensed motion, converting the output signal or signals via a processing unit in communication with the motion sensors into a command function or a plurality of command functions. The command functions comprise: (1) a start function, (2) a scroll function, (3) a select function, (4) an attribute function, (5) an attribute control function, (6) a simultaneous, synchronous, asynchronous, or sequential control function including: (a) a select and scroll function, (b) a select, scroll and activate function, (c) a select, scroll, activate, and attribute control function, (d) a select and activate function, (e) a select and attribute control function, (f) a select, activate, and attribute control function, or (g) combinations thereof, or (7) combinations thereof. The methods also include processing the command function or the command functions simultaneously, synchronously, asynchronously, or sequentially, where the start functions activate at least one selection or cursor object and a plurality of selectable objects upon first sensing motion by the motion sensor and selectable objects aligned with the motion direction move toward the selection object or become differentiated from non-aligned selectable objects and motion continues until a target selectable object or a plurality of target selectable objects are discriminated from non-target selectable objects resulting in activation of the target object or objects, where the motion or movement properties include a touch, a lift off, a direction, an angle, a distance/displacement, a duration, a velocity, an acceleration, a change in direction, a change in angle, a change in distance/displacement, a change in duration, a change in velocity, a change in acceleration, a rate of change of direction, a rate of change of distance/displacement, a rate of change of angle, a rate of change of duration, a rate of change of velocity, a rate of change of acceleration, stops, holds, timed holds, and/or mixtures and combinations thereof. The objects comprise real world objects, virtual objects, attributes associated therewith, and/or mixtures and combinations thereof, where the real world objects include physical, mechanical, electro-mechanical, magnetic, electro-magnetic, electrical, or electronic devices or any other real world device that can be controlled by a processing unit and the virtual objects include any construct generated in a virtual world or by a computer and displayed by a display device and that are capable of being controlled by a processing unit. The attributes comprise activatable, executable and/or adjustable attributes associated with the objects.

The changes in motion or movement properties are changes discernible by the motion sensors and/or the processing units. In certain embodiments, the motion sensor is selected from the group consisting of digital cameras, optical scanners, optical roller ball devices, touch pads, inductive pads, capacitive pads, holographic devices, laser tracking devices, thermal devices, acoustic devices, any other device capable of sensing motion, arrays of motion sensors, and mixtures or combinations thereof. In other embodiments, the objects include lighting devices, cameras, ovens, dishwashers, stoves, sound systems, display systems, alarm systems, control systems, medical devices, robots, robotic control systems, hot and cold water supply devices, air conditioning systems, heating systems, ventilation systems, air handling systems, computers and computer systems, chemical plant control systems, computer operating systems, systems, graphics systems, business software systems, word processor systems, internet browsers, accounting systems, military systems, virtual reality systems, augmented reality systems, control systems, other software systems, programs, routines, objects and/or elements, remote control systems, or mixtures and combinations thereof. In other embodiments, if the timed hold is brief, then the processing unit causes an attribute to be adjusted to a preset level. In other embodiments, if the timed hold is continued, then the processing unit causes an attribute to undergo a high value/low value cycle that ends when the hold is removed. In other embodiments, the timed hold causes an attribute value to change so that (1) if the attribute is at its maximum value, the timed hold causes the attribute value to decrease at a predetermined rate, until the timed hold is removed, (2) if the attribute value is at its minimum value, then the timed hold causes the attribute value to increase at a predetermined rate, until the timed hold is removed, (3) if the attribute value is not the maximum or minimum value, then the timed hold causes randomly selects the rate and direction of attribute value change or changes the attribute to allow maximum control, or (4) the timed hold causes a continuous change in the attribute value in a direction of the initial motion until the timed hold is removed. In other embodiments, the methods further comprise: sensing second motion including second motion or movement properties within the active sensing zone of the motion sensors, producing a second output signal or a plurality of second output signals corresponding to the second sensed motion, converting the second output signal or signals via the processing units in communication with the motion sensors into a second command function or a plurality of second command functions, and confirming the selection based on the second output signals, or processing the second command function or the second command functions and moving selectable objects aligned with the second motion direction toward the selection object or become differentiated from non-aligned selectable objects and motion continues until a second target selectable object or a plurality of second target selectable objects are discriminated from non-target second selectable objects resulting in activation of the second target object or objects, where the motion or movement properties include a touch, a lift off, a direction, an angle, a distance/displacement, a duration, a velocity, an acceleration, a change in direction, a change in angle, a change in distance/displacement, a change in duration, a change in velocity, a change in acceleration, a rate of change of direction, a rate of change of angle, a rate of change of distance/displacement, a rate of change of duration, a rate of change of velocity, a rate of change of acceleration, stops, holds, timed holds, and/or mixtures and combinations thereof. In certain embodiments, sensing motions including motion or movement properties of two or more animals, humans, robots, and/or parts thereof within the active zones of the motion sensors, producing output signals corresponding to the motions, converting the output signals into command function or confirmation commands or combinations thereof, where the start functions activate a plurality of selection or cursor objects and a plurality of selectable objects or attributes upon first sensing motion by the motion sensor and selectable objects aligned with the motion directions move toward the selection objects or become differentiated from non-aligned selectable objects and the motions continue until target selectable objects or pluralities of target selectable objects are discriminated from non-target selectable objects resulting in activation of the target objects and the confirmation commands confirm the selections.

### Object Control Wheels

The systems and methods of this disclosure include at least one motion sensor or output from at least one motion sensor, at least one processing unit, and at least one display device having an active window in which is displayed an object control wheel from a plurality of object control wheels. The same characteristics described to wheels may also apply to spheres, triangles, or other 2D or 3D shapes. Each object control wheel is constructed to correspond to a specific object and its associated attributes. Each object control wheel includes a central circle that is used to cycle through the plurality of object control wheels. Each object control wheel also includes a first active zone that permits direct control of directionally or spatially activatable attributes depending on a direction of movement within the first active zone and a second active zone that permits attribute scrolling and selection/activation or x and y movement of objects displayed in other active windows in the display device or in other display devices associated with the systems/apparatuses. Each active zone is in the shape of a shell surrounding the central circle, with the first active zone surrounding the central circle and the second active zone surrounding the first active zone. Of course, each object control wheel may also include other active zones, each permitting other types of control functions.

In certain embodiments, movement in the first active zone cause selection and direct control of the directionally activitable attributes, which may be directly adjustable attributes or multivalued attribute objects or any combination of directly adjustable attributes or multivalued attribute objects.

If the direction is associated with a directly adjustable attribute, then movement along the specific direction in a positive sense increases a value or performs the indicated control function of the directly adjustable attribute, while movement along the specific direction in a negative sense decreases the value or performs the indicated control function of the directly adjustable attribute. For example, if the directly adjustable attribute is volume, then movement in a positive sense increases volume, while movement in a negative sense decreases volume. Alternatively, if the directly adjustable attribute is a seek function of a radio tuner, then movement in a positive sense seeks for a higher numeric valued radio station, while movement in a negative sense settings seeks for a lower numeric valued radio station.

If the direction is associated with a multivalued attribute object, then movement in that specific direction will cause multiple attributes associated with the multivalued attribute object to be displayed so that further movement will allow attribute differentiation and activation. Again, if the activated attribute is a directly adjustable attribute, then value adjustment is direct, while if the activated attribute is another multivalued attribute object, then movement in that specific direction will cause multiple attributes associated with the multivalued attribute object to be displayed so that further movement will allow attribute differentiation and activation. Again, selection and/or activation is accomplished by movement alone or movement in conjunction with time holds, lift offs, taps (a single tap or double taps).

In certain embodiments, touching or touchless interaction with the second active zone causes attribute icon to be displayed within the second active zone in a spaced apart configuration. Arcuate movement within the second active zone scrolls through the icon and holding on an icon or moving in another direction at a desired icon will select and activate the attribute. If the attribute icon corresponds to a directly adjustable attribute, then movement in a positive or negative sense increases decrease the attribute value. If the attribute icon is a multivalued attribute object, then the multiple attributes or multivalued attribute objects will be displayed in a spaced apart configuration in the movement direction permitting further movement to select and activate the attribute or multivalued attribute object as described above.

In certain embodiments, if the selected object control wheel is associated with a 3D environment or a 3D searchable structure, then movement within the first active zone in a horizontal direction or x-direction will cause the 3D environment or structure to pane to right or left, while movement within the first active zone a vertical direction or y-direction will cause the 3D environment or structure to pane to up or down. Movement in any xy direction will cause the 3D environment or structure to pane in the specific xy direction.

In certain embodiments, touching or touchless interaction with the wheel within the second active zone and moving in an arcuate movement within the second active zone will cause the 3D environment or structure to rotate about a z-axis associated with the 3D environment or structure in a right hand or left hand manner.

In certain embodiments, touching or touchless interaction with the wheel within the second active zone and moving directly across the wheel to a point opposite the initial touch or interaction will cause the 3D environment or structure to rotate about an axis corresponding to the movement across the wheel. For example, movement across the wheel in an x-direction causes the 3D environment or structure to rotate about x-axis associated with the 3D environment or structure, while movement across the wheel in a y-direction causes the 3D environment or structure to rotate about y-axis associated with the 3D environment or structure.

In certain embodiments, touching or touchless interaction with the wheel within the second active zone and moving into the first active zone causes a point within the 3D environment or structure to move in a xy direction corresponding to movement within the first zone. Once the xy direction has been sketched out, lifting off and touching or touchless interaction within the second active zone and moving across the wheel will rotate the 3D environment or structure about an xy axis associated with the movement across the wheel. Moving into the first active zone causes the point within the 3D environment or structure to move in a z direction corresponding to movement within the first active zone. Of course, any axis may be used. This process may be repeated until the point is situated at a desired location within the 3D environment or structure. Additionally, the course of xyz movements may be recorded. If the 3D environment or structure is a town or city, then the course corresponds to a course that a real object such as a drone may follow to deliver an ordinance at the location or to delivery a package or other item to the location. If the 3D environment or structure is a virtual reality (VR) or augmented reality (AR) environment or game, then the course may be used to move a VR or AR asset to the location, to move a VR or AR object to the location, or to direction a VR or AR ordinance to the location.

In certain embodiments, touching or touchless interaction with the central circle and holding contact within the central circle for a period of about 1 second or more causes the system to cycle through the plurality of object control wheels, where each object control wheel is configured for the specific object. In other embodiments, the cycling through the wheels may be caused by increasing and decreasing pressure on the central circle is the display have pressure sensors. This same effect may occur by moving in an axis that represent the direction of pressure, without actually exerting pressure. In other embodiments, the central circle may include two zones, touching in or touchlessly interacting with one zone will moves up through the wheels, while the second zone moves down through the wheels. Each object wheel may include an icon in the central circle to identify the object for which the wheel is designed.

### Systems Including Controller Apparatuses

The inventor has found that controller apparatuses may be fabricated that detect motion and determine motion or movement properties to control physical or real objects, physical or real objects navigating through real world environments, virtual or augmented reality objects representing real objects in virtual or augmented representations of real environments, virtual or augmented reality objects in virtual or augmented reality environments, and/or virtual or augmented reality environments or attributes associated with any of these environments. The inventor has found that the apparatus may be in the form of apparatuses including a plurality of sensors, a sensor array and/or a plurality of sensor arrays, communication hardware and software, and at least one processing unit (generally, a digital processing unit) in communication with the sensors or sensor arrays and the communication hardware, where the sensors or arrays are capable of detecting motion and determining motion or movement properties in 1 dimension (e.g., x, y, z, t, θ, ϕ, etc.), 2 dimensions (e.g., xy, xz, yz, xt, yt, zt, rt, rθ, rϕ, θt, ϕt, etc.), 3 dimensions (e.g., xyz, rθh, rθϕ, etc.), 4 dimensions (e.g., xyzt, rθht, rθϕt, etc.), or higher dimensions. It should be recognized that in virtual or augmented reality environments, the dimensionality may be higher than 4, while in real environments, the time-space has only 4 dimensions, while the objects may have may more dimensions associated therewith, where the dimension may be attributes or parameters defining the object. The controller apparatuses of this disclosure may be used to control real devices such as manned or unmanned planes, drones, robots, boats, motor vehicles, trains, submarines, matter, space (and any attributes associated with these) and any other device that is capable of moving on land, sea, sky, outer space, or mixtures and combinations thereof. The controller apparatuses may also be used to control virtual or augmented reality objects representing real devices or attributes or control virtual or augmented reality objects that exist on in virtual or augmented reality environments.

Embodiments of the systems of this disclosure including apparatuses in the form of 3D constructs (solid, hollow, or mixture thereof) including at least one processing unit (e.g., a digital or analog processing unit), one or a plurality of sensors or sensor arrays, and communication software and hardware. The 3D constructs are designed to be held by a user. In certain embodiments, the sensors and/or sensor arrays include at least one gyroscope and at least one accelerometer. In other embodiments, the sensors or arrays may also include pressure sensors, temperature sensors, humidity sensors, field sensors, magnetometers, compass(es), optical sensors (UV, visible, NIR, IR, microwave, Rf, etc. sensors), acoustic sensors, any other sensor, or mixtures and combinations thereof. In other embodiments, the 3D constructs including regular 3D constructs such as spheres, ellipsoids, cylinders, prisms, pyramids, cubes, rectangular solids, icosahedrons, dodecahedrons, octahedrons, cones, tetrahedrons, or any other regular 3D construct, or irregular 3D constructs such as distorted and/or irregular versions of the regular 3D constructs.

Embodiments of the sensors and/or sensor arrays are configured in or on the solid object so that they are capable of sensing motion and motion or movement properties, when the 3D object is moved. The motion or movement properties including motion direction (linear, angular, rotational, etc., or mixtures and combinations thereof), motion distance/displacement, motion duration, motion velocity (linear, angular, rotational, etc., or mixtures and combinations thereof), motion acceleration (linear, angular, rotational, etc., or mixtures and combinations thereof), and/or changes in any of these properties over time. In other embodiments, the apparatus is in the form of an object including indentations or recesses for accommodating a user finger tips, fingers, or fingers and palm to facilitate holding of the apparatus. In other embodiments, the systems of this disclosure may include two or more such apparatuses being controlled by the same or multiple users. For example, a single user may be have one apparatus in each hand or two or more users may have apparatuses in one or both hands so that the systems of this disclosure detects motion from all apparatuses and determined motion or movement properties from all apparatuses and utilizes the collective motion to control physical or real objects, physical or real objects navigating through real world environments, virtual or augmented reality objects representing real objects in virtual or augmented representations of real environments, virtual or augmented reality objects in virtual or augmented reality environments, and/or virtual or augmented reality environments. These may also work with or include biometric, neurological, or other types of input or influencing forces.

Embodiments of the systems of this disclosure including apparatuses including at least one processing unit (e.g., a digital or analog processing unit), one or a plurality of sensors or sensor arrays, and communication software and hardware. In certain embodiments, the sensors and/or sensor arrays include at gyroscopes, accelerometers, compasses, magnetometers, pressure sensors, temperature sensors, humidity sensors, field sensors, optical sensors (UV, visible, NIR, IR, microwave, Rf, etc. sensors), acoustic sensors, any other sensor, or mixtures and combinations thereof. The sensors and/or arrays are configured to create a two-handed approach to navigate through virtual or augment reality environments or virtual or augmented reality representations of real environments, where the controllers are manifested in the virtual or augmented reality environment as virtual control objects.

The present disclosure describes apparatuses that provide easier ways to control real and/or virtual objects (e.g., real object include any real devices such as drones, entertainment systems, motor vehicles, air planes, etc. or virtual object include any virtual feature, construct, element, etc.). We have previously described the use of changes of motion and combinations of motion with touch, gestures and verbal interfaces and modalities to select, scroll, activate, and control objects and/or object attributes. Sensors now available, such as accelerometers, gyroscopes, compasses, GPS, near-field locators, optical cameras and sensors, etc., allow us to provide new ways to interact with and/or control real objects, virtual objects, real and virtual environment content, and/or real or virtual environments.

Embodiments of the controller apparatuses of this disclosure comprises a physical ball or sphere. This same controller may be used in or with a virtual environment or may be a virtual representation of a physical controller to control virtual and/or real objects, attributes, zones, data, etc. The controller apparatuses may be in the form of a ball (virtual ball in a virtual environment) or a physical ball or any 3D shape. The 3D shape may be symmetrical, asymmetrical, irregular, smooth, faceted, textured, colored, etc. In certain embodiments, the 3D constructs are symmetrical.

In other embodiments, the 3D constructs are spherical. In other embodiments, the 3D constructs are generally spherical having slight faceting with no sharp edges or corners. The controller may include sensors providing for detecting location and changes in location such as GPS data, NFC data, way point data, or any other location data and degrees of motion such as angular and/or rotational motion such as pitch, yaw, roll, etc., linear motion up (+z), down (−z), left (−x), right (+x), in (+y), out (−y), any other motion, changes of any motion over time (velocity, acceleration, etc.), and/or any combination thereof. In certain embodiments, the controller apparatuses of this disclosure are configured to control a drone, unmanned vehicle, unmanned space craft, unmanned boat, unmanned air plane, unmanned submergible, unmanned air ship, or other similar device, or for locomotion or influencing environments.

In certain embodiments, the ball controller may be activated by grasping it with the fingers (as opposed to holding it with an open palm) and moving of the ball correlates to the movement of the drone. In a virtual environment, moving close enough or in proximity with a grasped palm position, without having to actually be too close, would be the activation). Once the ball controller is activated, moving it upwards begins the command to move the drone upwards. The distance and speed moved upwards (or change in other movement properties) prescribes the vector(s), associated attributes, and any acceleration value. Beginning to move up begins the drone moving upwards, the further the ball controller is moved up, the faster the drone goes up. At the point the ball movement is stopped (a hold function), or by relaxing the grip on the ball controller, the current attribute and intensity continues. A change in direction of the ball controller changes the direction of the drone, based on real-time changes of vectoral motion of the ball controller, and intensity based on speed and distance of the ball controller moved. The range of motion correlates to the attribute control of the drone; i.e., once the ball controller is activated, −6 to 0 to +6 inches (total of 12 inches) represents the full range of attribute (such as 0 to 30 mph, or total distance ability of the device). It is preferable that the attribute ranges being in increments so small movements of the hand do not adversely affect the device. Compared with typical joystick controllers, where holding the sticks still keeps attributes at a current value, holding the ball controller still keeps the attributes the same by relaxing the grip a threshold amount.

Rotating the ball controller rotates the drone, based on acceleration, velocity, and direction of the ball controller motion. The systems of this disclosure may be designed so that rotation of the ball controller, while moving the ball controller cause the system to perform multiple selection and attribute control functions, synchronously, asynchronously or sequentially.

Another embodiment of the controllers of this disclosure may include a plurality of independently rotatable sections such as a top section(s), a horizontal middle section(s), a bottom section(s), a right section(s), a left section(s), a vertical middle section(s), other rotatable sections, and mixtures or combinations thereof. For examples, a spherical control apparatus may include a top section, a middle ring section, and a bottom section, which may be rotated independently. In other embodiments, the spherical controllers may include multiple sections and each section may include one or a plurality of rings. Controllers including multiple rotatable sections will provide more control aspects. Twisting action may be used to leverage motion so instead of moving the whole ball, a twist may cause the systems to execute an identical or similar control function, without moving the controller, i.e., the controller stays in place. A twist may also indicate a different device or groups of devices to be controlled by the same controller. The systems and methods may use twisting and moving to control objects and/or object attributes.

In other embodiments, the controller may include a vertical or horizontal member, such as a stick, rod, etc., attached, affixed or integral with a top, side, or bottom of the controller. The constructs may have a virtual extension of the physical extension pointing towards the ground or towards a desired location or direction for orientation or controls, such as a ray of light or a field distortion. The member may be used to keep the controller at a specific distance from the ground or other surface so that all motion is relative to the specific location of the controller relative to the member. It may also be used to guide the user in making decisions or providing other feedback or data for controls, decision-making, or locating of desired attributes or objects. Motion or movement about the member may also provide another layer of motion sensing and object and/or object attribute control.

The controller apparatuses may also be used in much the same way to navigate through virtual or augmented reality environment and/or space, except instead of controlling a physical device moving through a physical environment or a virtual or augmented reality representation of a physical environment, the systems and methods use controller motion to move through the virtual or augmented reality environment and/or space and/or to control VR/AR objects and VR/AR object attributes. For example, motion of the controller may cause a viewing angle to move (such as a camera through space), or may cause a scene to move in respect to a viewers perspective. In this way by moving the controller forward (away from the user), the environment may appear to move towards the user in the same perspective and leveraged way as descried above (12 inches equals 0 to full speed of virtual “motion” of the scene). By moving the controller through an arc from left to right, the direction of turning of the environment is performed. By moving controller away from the body at the same time, a forward moving and turning of the environment is performed. By moving the controller upwards, a moving of the sky or ceiling down is performed. All of these type of motions may be done in combination, and in a small actual range of movement. The systems and methods may also response to the tilting of the controller. Such tilting may be combined with directional and rotational movement to provide additional functionality. For example, moving, rotating and tilting may cause the system to move the physical object or VR/AR object in the indicated direction and rotation at an angle or at an offset determined by the tilt properties. A ring or other form of assistance may be attached or part of the controller to assist in holding on to the controller.

The systems and methods of the disclosure may also include a preview feature. The preview feature of the scene can be shown to represent the movement, while simultaneously, synchronously, asynchronously or sequentially showing the existing scene. With a hold, voice command, trigger or button push, a tighter grip or opening of the hand, the view would transition from the previous scene to the previewed scene in a “portal”, “jerk”, dissolve, or other transition display event so the user is at the new desired location. For instance, if a wall had a door and another room beyond the door, a grasping motion towards the controller and a movement of the controller towards the door (away from the body indicating moving forward), and a continued hold or even further motion away from the body, would take the user into the next room with a “ghost” or wire frame look of the new location is overlaid on top of the existing color scene, so both scenes may be seen simultaneously, synchronously, asynchronously or sequentially, but with enough of a different look that the user can tell the difference between the existing stationary scene and the moving, controllable previewed scene. Once the user “squeezes” the virtual device (or for a real device pulls a trigger or holds the device upright), the scene immediately transitions from the previous screen to the new location.

This same control may be performed with no devices being represented (using just hand or body motions), with a virtual controller being controlled by hand, body (eyes, etc.), or by motions of one or more real devices. Using two hands, a hand and a real or virtual device, or two real or virtual devices, more controls may be provided. With two points, a plane or zone, or two or more planes or zones, or two sets of 3-axis planes or zones, may be moved, controlled, and represented at once. Using the gaze of face, head or eyes could provide yet another set of planes and/or zones Two hands may form two edges of a virtual plane. A plane may be represented by one hand, possibly centered in a palm area and rotates as the hand is rotates. Two hands may therefore represent two different planes, and an intersection of these planes may be changed based upon a relative distance between the two hands and/or a relative angle formed by the two hands. Instead of moving two hands, two stick controllers, two ball controllers, or any other virtual or real controller. These may then be used to represent one previewed scene with one hand and another with the other hand, creating an entirely new way to move from one location to another, or by combining previews associated with each hand, then instantly being “moved” to this new hybrid location with a selection event. One hand may represent a color or an intensity or other attribute effect that provide overlaid information to the other hand displayed attributes. One hand laid directly over the other may perform a mirrored effect between the two with a gradient of effects between the two. One hand may perform a zoom-in or zoom out function while the other performs location selection or movement. So one may preview where they want to go and scale the view. Of course this may be performed with one hand, but two may provide a better experience.

Another benefit to this approach is that the apparent “horizon” or stable “line of site” remains for the viewer while a “ghosted”, foveated, or non-similar image is displayed simultaneously, synchronously, asynchronously or sequentially, so the user can virtually move through space without the nausea effects of moving the actual scene. This also allows the user to see where they have been (the actual scene) and where they are going (the preview), simultaneously, synchronously, asynchronously or sequentially. This same effect may be used to control a drone with an augmented reality set of glasses or device. On the glasses display, the image of the camera view of the drone (or any other device) may be displayed, so that the user sees what the camera is seeing. By virtually previewing the area (say by using a satellite image to create a virtual “world” around the drone), one may be able see through a virtual “eye”, while simultaneously, synchronously, asynchronously or sequentially seeing the real world through a real camera “eye”. Once the previewed area is selected, the device may then move to a new location with the camera view lining up with the previewed scene, or in whatever predetermined scaled amount desired. This may be done for any attribute such as viewing angle, sound, amplitude, orientation, color speed, or any combination of attributes. The same is true of head or eye tracking, or the ball example above. These are two different embodiments of the same principles.

### Methods for Secondary Device or Object Control

In certain embodiments, the systems, apparatuses, and/or interfaces of this disclosure and methods implementing them include using one device, say a phone, to control a display of another device, such as a second phone, where a menuing and controls of this disclosure installed on one device permits control the other device(s) and/or their associated displays, attributes, or hardware or software. This methodology would allow one object to control one or more objects even if the objects use different operating systems, have different environments, and/or have different hardware. This ability for one device or object to control other devices or objects is another example of the use case of our predictive dynamic motion controllers.

Deliberate Movement Differentiated from Spontaneous or Non-Deliberate Movement

In certain embodiments, the systems, apparatuses, and/or interfaces of this disclosure and the methods implementing them include sensing deliberate or intentional, generally predefined, movements, outputting the sensed movement as an output, and converting the output into a command and control function including, without limitation, a select function, an activate function, a scroll function, an attribute control function, and/or combination thereof. The deliberate or intentional movements may be associated with eye tracking or head tracking motion sensors or with any other motion sensor or deliberate or intentional movements associated with a specific body part or member under the control of an entity. The deliberate or intentional movements may be to move an eye or the eyes across a displayed selectable object, then to change a speed a predetermined amount so a desire function is invoked. For example, for the systems, apparatuses, and/or interfaces including a display and an eye-tracking sensor, when the user looks across a particular object or a set of objects or stares at a particular object or set of objects, then a particular function may be invoked such as a select function, a select and activate function or a select, activate and adjust attribute value function, but if the user looks across a face of the object at a preset speed, then a particular function may be invokes such as a select and activate function. It should be recognized that in the case of eye movement, the deliberate or intentional movements including its movement properties must be discernibly distinct from normal eye movement. In certain embodiments, the systems, apparatuses, and/or interfaces sense motion from one or more motion sensors and monitor the movement until the movement meets one or more criterion sufficient to distinguish the movement from normal eye movement-threshold criteria are satisfied. For example, the deliberate or intentional movement may be a slow but continuous movement, a pause at a corner and a look quickly towards another corner (diagonally), or some other change of rate of speed or acceleration that is distinguishable from normal eye movement.

Another example of deliberate or intentional movements may involve differentiating normal viewing behavior from viewing behavior that is deliberate. Users typically do not look directly at a middle of a displayed object, but rather look at the whole object or just below a center, i.e., the users focus is not on the center of the object. Thus, a deliberate movement may be just to stare at a center of an object or to stare at some other location in an object; provided, however, that the movement is sufficient for the systems, apparatuses, and/or interfaces to distinguish the movement from normal eye movement. A person may look at an object, and when it is determined by a sensor that an object is generally being looked at, a center or centroid of the object may be displayed differently (or just be active without appearing differently), such as a square or circle showing the centroid area so that the systems, apparatuses, and/or interfaces may use the motion sensor output associated with looking into the area or volume or moving through this area or volume and converting the output into a command and control function. Of course, the triggering area or volume may not be the center, but may be another location within the object. Therefore, looking at or towards an object may cause the systems, apparatuses, and/or interfaces to pre-select the object, but only when the user moves the gaze into the active area/volume (generally predefined) does the systems, apparatuses, and/or interfaces invoke a particular command and control function. Alternatively, the deliberate movements may involve moving across a predefined area, where speed of the motion does not matter, only that a traversal to a certain threshold is reached. Additionally, other movement properties (e.g., speed, velocity, and/or acceleration or changes of these) may be used as part of the predefined movement to invoke a particular function or functions. This same technique may be applied to users that have certain type of maladies that prevent them from smooth movement, the systems, apparatuses, and/or interfaces may be tailored to determine difference(s) between normal user movement and deliberate user movement even though the difference(s) may be subtle.

Constructs with Continuous Properties

In certain embodiments, the systems, apparatuses, and/or interfaces of this disclosure and the methods implementing them may utilize constructs having continuous properties (e.g., continuous values—analog—instead of discrete values—digital). In such environments (all objects are waveforms that are capable of interacting), the movement may navigate through the continuous properties with a change in movement or a deliberate movement may result in the selection of a particular value of a continuous property or a set of continuous properties. Thus, waveform and waveform interactions may be manipulated, adjusted, altered, etc. and viewed. Additionally, given interaction patterns may cause the systems, apparatuses, and/or interfaces to invoke a particular function or set of functions. Attribute may be a subset or other attribute of an object, but may also be associated with a change in a waveform, that is different from scrolling, in that scrolling must have integer values (or stops along a path). It like a guitar, where scrolling would be moving through frets, but sliding the string sideways (bending) the string produces frequency changes with no preset integer values, where systems, apparatuses, and/or interfaces may use both outputs to invoke a different function or set of functions, which may be predefined or determined from context on the fly.

### Real-time Prediction of User Intent

People move typically in a straighter line, and faster when they know what they want or are choosing something. In certain embodiments, the systems, apparatuses, and/or interfaces may be used to predict to a certain probability, what a particular user choice may be based on how fast and/or straight the user moves towards a particular selectable object. In some cases, such as movement of the thumb, where the movement comprises rotating about a thumb joint, the motion may be arcuate, and moving in a non-arcuate manner may be seen as more intentional, thus providing a higher probability. Other things that may affect the confidence of making a selection (or the probability), include proximity (closer to one object than another), slowing down as approaching a particular object (changes in direction, distance, duration, speed, velocity, acceleration, etc.) such as decelerating when moving towards a particular letter on a keyboard, then moving away at an increased acceleration (after choosing a letter on a keyboard and moving to the next). The systems, apparatuses and/or interfaces may improve real-time confidence determinates by using artificial intelligence (AI) routines based on confidence data including historical, environmental, or contextual data stored in libraries and/or databases and may be coupled with the the above movement properties to enhance predictive confidence.

### Self-Centering User Interface (SCUI)

In certain embodiments, the systems, apparatuses, and/or interfaces of this disclosure and the methods implementing them relate to novel self-centering interface (SCUI) for controlling objects (software, hardware, attributes, waveforms or any other selectable, scrollable, activatable, scrollable or otherwise controllable thing) such as controlling drones through head motions using head motion sensors. For example, picture a compass rose with a hole in its middle and divided into 4 quarters: NE, NW, SW and SE. As the user moves leftward in the SW quadrant, the systems, apparatuses, and/or interfaces may cause the drone to move to the left and a distance of the movement to the left controls the speed of the drone's movement to the left. Thus, the further the user moves to the left within the SW quadrant the faster the drone moves to the left. Similarly, as the user moves rightward in the SE quadrant, the systems, apparatuses, and/or interfaces may cause the drone to move to the right and a distance of the movement to the right controls the speed of the drone's movement to the right. Thus, the further the user moves to the right within the SE quadrant the faster the drone moves to the right. In this way, the user may use a pair of glasses (such as AR/VR/MR glasses, etc.) and see the drone, and move the drone while using a semi-transparent UI design, when using an intentional speed of head movement, i.e., deliberate head movement. So, by moving quickly, the UI may not cause the drone to move as the systems, apparatuses, and/or interfaces may determine that such movement does not represent a deliberate movement sufficient for drone control. Thus, if the movement is determined by the systems, apparatuses, and/or interfaces to be a deliberate movement, then the UI may cause the drone to undergo are corresponding movement. By moving in a specific deliberate manner, a menu may be activated, the view centered along the focus or gaze direction (self-centering) and the menu objects or elements arranged in a spaced apart configuration (e.g., concentrically) about a center of the user head or eye position, i.e., arranged about the gaze point. In this donut compass rose example, when the gaze is in the center, or donut hole area, the systems, apparatuses, and/or interfaces cause the drone to transition into a stationary state, which may be a hover state or a state of constant motion based on the last set of head/eye movements. The systems, apparatuses, and/or interfaces may discriminate between a hover state and a constant motion state base on the duration of the gaze (duration of a timed hold), on where in the center area the gaze is fixed. Moving left and right (x-axis) moves the drone left and right. Moving up and down (y axis) move the drone up and down. Moving in a combination of x and y movement, moves the drone similarly. Additionally, other movement within different quadrants such as the movement within NW or NE quadrants may control rotation of the drone on its axis, left or right, respectively, or may control pitch, yaw, roll, or other motions.

In other embodiments, the systems, apparatuses, and/or interfaces of this disclosure and the methods implementing them relate to novel user interfaces comprising three different control object formats: screen locked, world locked absolute, and world lock relative. Screen locked means that an object, a plurality of objects, an attribute, and/or a plurality of attributes remain in the user field of view at all times regardless of where in the “world” the user view is. World locked absolute means that an object, a plurality of objects, an attribute, and/or a plurality of attributes may become associated with or transitioned to a specific world view object or a specific world view location remain fixed to that object or location and do not move. Therefore, if the user movement moves that view so that the object or location moves outside of the current view, then the control objects and/or attributes associated with the object or location will be no longer visible. World locked relative means that an object, a plurality of objects, an attribute, and/or a plurality of attributes may be associated with or transitioned to the world view, but the object, the objects, the attribute, and/or the attributes may follow the user gaze, but lag behind so that they may not be accessible until the movement stops or stops for a specific period of time. For drone controls, certain drone controls may be screen located, while other drone controls may be world locked absolute, while other may be world locked relative. For example, a target and/or target attributes may be world locked absolute, a drone position controls for moving the drone along a path to the target may be world locked relative, and camera controls or weapon controls may be screen locked. Of course, the user may change the objects and attributes that are screen locked, world locked absolute, or world locked relative.

Putting these concepts together, sensing a deliberate movement causes the systems, apparatuses, and/or interfaces to activate the UI or to begin user interaction with the UI and causes an image of the drone to appear in the world view. The UI comprises the three locked formats. Then, sensing movement to the left within the SW quadrant, the systems, apparatuses, and/or interfaces causes the drone to move left, where the speed of drone movement to the left is controlled by the distance the sensed movement of the user to the left within the SW quadrant. As the drone moves, the screen locked object, objects, attribute, and/or attributes move with the users; the world locked absolute object, objects, attribute, and/or attributes remain fixed to an object in the world or a location in the world; and the world locked relative object, objects, attribute, and/or attributes track the movement of the drone. The tracking may be appear as it the object, objects, attribute, and/or attributes are screen locked—they move in direct correlation to the drone, or they are move at a slower rate or they move so that only after user movement stop that they move back into the user view. Optionally, the world locked relative object, objects, attribute, and/or attributes may move in front of the drone so that the has a preview of the drones course and may adjust it accordingly. When the user head or eye movement stops at a gaze point (user gaze at a fixed location in the world view), then the drone movement will either stop or the drone continues to move in accord with the movement at the time the user movement stops, where a type of gaze—duration, gaze center, etc., determines whether the gaze cause the drone to hover in place or continue to move in accord with the last movement properties. In certain embodiment, once a fixed gaze is detected, then the world locked relative object, objects, attribute, and/or attributes, which have been following the user movement, catches up to the gaze point, and become centered about the gaze point. Because the UI is controlling the drone, the drone now centers itself in alignment with the UI, which is centered around the gaze point. In one embodiments, the UI lags slightly behind the gaze point, and the drone lagging slightly behind the UI.

This same UI may also be used to control z-axis motions by either using 3D sensor data (from head motion sensor or other motion sensors), or by using a unique 2D construct that provides 3D controls. An example of this is the same compass rose (or circular/radial UI menu/controller) with a donut hole, but now adding a designated z-axis area as described herein. In one embodiment, the UI is in the shape of a funnel as set forth herein, providing a slim, pure z-axis control wedge zone centered within the z-control wedge. Moving towards or away from the center of this z-zone moves the drone along the z-axis. The UI is divided into two parts, with a dead zone. The center area provides 3D x/y/z axis controls, while the outer part of the funnel is 2D and provides only x/y control (as described above). In the 3D area, if the user moves out of the Z-zone, but remains in the inner section, then the motion represents a combination of x, y and z. If the user moves into the outer zone, only x/y controls are provided.

### Systems, Methods and Interfaces Including at Least Two User Feedback Devices

More particularly, embodiments of this disclosure relate to systems, apparatuses, and/or interfaces and methods for implementing them on or in a computer, where the systems, apparatuses, and/or interfaces and methods of interacting with 3D or n-dimensional (nD) environments using at least two user interface devices, where the systems, apparatuses, and/or interfaces include at least one motion sensor, at least one processing unit, and at least two user feedback unit for controlling, interacting, and manipulating motion in 2D, 3D, and/or nD environments.

### Automotive Display System

In certain embodiments, the systems, apparatuses, and/or interfaces may be configured to display traffic information, traffic signs, and traffic notices projected onto the windshield. Billboards and regulatory signs and other traffic related notices are common when driving a vehicle on roads, highways, freeways and tollways throughout the world. The systems, apparatuses, and/or interfaces may be configured to display on the windshield (e.g., HUDs) or on the interior surface of visor of a helmet representing a new method for providing information to drivers or occupants. One specific example is where a driver is traveling along a highway approaching a location that is designated as an information or regulatory sign area or sensors on the vehicle “sees” an information or regulatory sign, a virtual representation of the sign may be displayed in a center of the windshield, appearing smaller and with a perspective of appearing far away. As the driver continues moving toward the sign, this virtual sign grows larger and moves across the windshield just as if it was a real sign and the driver was passing it by. Being a virtual sign, the image and information may be “frozen” or recalled at any time, replayed, or may be magnified or scrolled through using motions as has been described herein. In addition, the systems, apparatuses, and/or interfaces may use voice commands or a combination of motion and voice commands to recalled at any time, replayed, or may be magnified or scrolled through viewed signs. Being able to interact with motion on a steering wheel (touchpad, optical sensor, etc.), with eye tracking, HUD, or any other ways may provide the driver the ability to review missed information. It may also provide the ability to have changes updated according to the vehicle or occupants (speed of vehicle, notifications from family members, etc.) in real time or according to scheduled times. The systems, apparatuses, and/or interfaces may also be linked to a phone or other system, and this information may be displayed as one of these virtual signs as well, whether connected to a location or not. With regard to speed, the systems, apparatuses, and/or interfaces may also display vehicle speed above or below certain differences from regulations, providing flashing or other animated graphics, or even multiple layers at once to show differences over time of messages.

Analytics Using the Same Motions that Control Things

In certain embodiments, the systems, apparatuses, and/or interfaces may use historical data to predict user intent and cause actions (such as selections) to happen faster without have to move to an object. Thus, by analyzing past user behavior and movement characteristics, the systems, apparatuses, and/or interfaces may be able to more quickly, which object aligned with a particular movement is more likely the target. The same vectors that change with speed and direction (and these changes provide controls) also tell us many things about the user. For instance, scrolling back and forth (say x-axis movement) between two out of five items, then moving towards a particular object (say y axis movement), selects and activates that object. But knowing the other objects lets the systems, apparatuses, and/or interfaces classify alternate choices, that may be ranked based on historical data. The use of analytics may find particular application in advertising or training methods using the motion based systems, apparatuses, and/or interfaces of this disclosure.

In other embodiments, systems, apparatuses, and/or interfaces may use these predictive methodologies that cause objects to move towards the user or a selection object to predict zones for foveated rendering. In VR or other mixed reality environments, graphics rendering is extremely time consuming. To compensate for this, graphics rendering at the highest resolution is generally restricted to an area or areas associated with a center of vision. By restricting the high resolution rendering to these areas provides the user with a good experience. Thus, the high resolution graphics rendering doesn;t need to be performed on zones, areas, or volumes not being looked at. In this way, prediction of where the user will be looking may assist in foveated rendering, so that part of the display may be rendering the predicted zones, so the user sees no apparent delay in rendering.

In other embodiments, the systems, apparatuses, and/or interfaces of this disclosure and the methods implementing them, where the systems, apparatuses, and/or interfaces include at least one eye and/or head tracking sensor, at least one processing unit, and at least one user feedback unit. The systems, apparatuses, and/or interfaces permit two different pinning modes. The first pinning mode is that the tracking sensor includes information about objects displayed in a tracking based manner viewable at a left and right edge of the viewing plane. These object may be selected by moving the head and/or eyes toward the tracking pinned objects causing them to appear in the center of the field so that they can be controlled by further head and/or eye movement. As the user views a real world object in a real world environment, an object in a AR environment or an object in a VR environment, the user may transition the selection format from a tracking pinned format to a world pinned format. In the tracking pinned format, the selection and control function for the object under the control of the systems, apparatuses, and/or interfaces remain with the tracking sensor and may be accessed at any time, but once the user sees an object pauses at the object or moves in a predetermined manner toward that object, the systems, apparatuses, and/or interfaces pins the object control functions to the object. The pinning may be permanent or relative. Permanent pinning ties the control functions to the object so that you may return to the object to be able to control its attributes. Relative pinning means that the object control function travel with the world view either directly or with a lag as it follows the eye and/or head movement.

The inventor has found that movement based systems, apparatuses, and/or interfaces and methods implement them, where the systems, apparatuses, and/or interfaces include at least one sensor, at least one processing unit, at least one user cognizable feedback unit, and one real and one real or virtual object or a plurality of real and/or virtual objects controllable by the at least one processing unit, where the at least one sensor senses blob data associated with touch and/or movement on or within an active zone of the at least one sensor and generates an output and/or a plurality of outputs representing the blob data, and where the at least one processing unit converts that blob data outputs into a function or plurality of functions for controlling the real and/or virtual object and/or objects.

### Triggers

In certain embodiments, the systems, apparatuses, and/or interfaces of this disclosure and methods implementing them use a marker or an image/character recognition feature to trigger a menu or metadata that may then be used with menuing systems of this disclosure or any other menuing system. These markers or features are similar to a 2D or 3D barcode, emoticons, or any object or feature that may be recognized as a trigger. The trigger may be used to unlock certain locked menus or lists for special access. The triggers may also be used for tailoring triggers to cause the systems, apparatuses, and/or interfaces to invoke specific and pre-defined menus, objects, programs, devices, or other specific or pre-defined items under the control of the systems, apparatuses, and/or interfaces.

Systems, Apparatuses, and/or Interfaces and Methods Using Blob Data

In certain embodiments, the systems, apparatuses, and/or interfaces of this disclosure and methods implementing them include using blob data as a source of movement data for analyzing, determining, and predicting movement and movement properties, where movement is understood to mean sensing movement meeting a threshold measure of motion by a motion sensor, a plurality of motion sensors or an array of motion sensor for use in motion based object control, manipulation, activation and/or adjustment. Blob data comprises raw motion sensor data representing sensor elements that have been activated by presence and/or movement within an active area, volume or zone of the proximity and/or motion sensor(s). In the case of a touch screen including a large plurality of touch elements, touching the screen produces raw output data corresponding to all touch elements activated by the area of contact with the screen and comprise the blob data for touch screen or other pressure sensors or field density sensor or sensor including activatable pixels or any other sensor that include elements that are activated when a threshold value associated with the element is exceeded (pressure, intensity, color, field strength, weight, etc.). The term activate as it relates to touch elements means that touch elements within the contact area produce touch element outputs above a threshold level set either by the manufacturer or set by the user. For other types of sensors, movement within an active sensing zone of the sensors (e.g., areas for 2D devices, volumes for 3D devices) will activate an area and/or a volume within the zone. These areas and volumes represent the “blob” data for each type of device and comprises elements having a value exceeding some threshold value for activating the elements. For image based sensors, the activate elements will generally comprise pixels having a threshold value of pixel values. For capacitive sensors or inductive sensors or electromagnetic field (EMF) sensors, the blob data will relate to areas or volumes corresponding to sensor elements that meet a threshold output for the sensors.

The blob data (activate element area or volume) will change with changes in contact, pressure, and/or movement of any kind. The blob data represents an additional type of data to control, manipulate, analyze, determine, and predict movement and movement properties. The blob data may be used to identify a particular finger, to differentiate between different fingers, to determine finger orientations, to determine differences in pressure distributions, to determine tilt orientations, and/or to determine any other type of change in the blob data.

In the biokinetic applications, the blob data with or without the addition of filtered data (center of contact, center of pressure, or other types of centroid data) may be used to create a proportionate and/or unique user identifier. Not only may blob and centroid data be biometric identifiers, but the relationship between the two is a more unique biometric, or electro-biometric identifier. The systems, apparatuses, and/or interfaces of this disclosure may also include sensing, determining, and analyzing the blob data and determining and analyzing filtered data or centroid data for use in analyzing, determining, and predicting movement and movement properties for use in motion based object control, manipulation, activation and/or adjustment of this disclosure. For example, a user places a thumb on a phone touch screen. In doing so, the blob data may be used to identify which thumb is being used or to confirm that the thumb belongs to a particular user. If the touch screen also may include temperature sensors, then the blob data may not only be used to differentiate and identify particular thumbs (or fingers, irises, retinas, palms, etc.) alone or in conjunction with other movement data based on a shape of the blob data or output signal and a direction to which the blob data or blob data and centroid data may be pointing or oriented. This technique may be used to directly turn a knob using a pivoting movement versus using movement of a centroid, where the thumb is represented as a point and movement of the centroid from one point to another is used to determine direction. Using blob data allows the user to select zones, control attributes, and/or select, scroll, activate, and/or any combination of these, the systems and methods of this disclosure simply by pivoting the thumb. Then moving the thumb in a direction may be used to activate different commands, where the blob data movements may be used to accentuate, to confirm, to enhance, and/or to leverage centroid data. For examples, pivoting the thumb while in contact with the touch screen results in blob data that may be used to determine finger orientation and/or tilt, allowing the user to select between groups or fields of objects (for example), or through pages of data or objects. Once the user scrolls and selects a particular group or field, further movement results in a different set of set of controls, instructions, commands, attributes, etc. The systems and methods may use the blob data to “see” or anticipate movement attributes (direction, pressure distribution, temperature distribution, speed (linear and angular), velocity (linear and angular), acceleration (linear and angular), etc. The systems and methods may use the blob data, the centroid data or a combination of the two types of data to analyze, determine and/or predict or anticipate user movement. The transition from blob data to centroid data may also be used to see or anticipate user intent. For example, as a user twists or pivots the thumb, then begins to move towards an object, zone or location, the thumb may begin to roll in a lifting motion, rolling up towards the tip of the thumb, providing less of a pattern and more of a typical centroid touch pattern on the screen. This transition may also provide user intent through not only movement in an x/y plane, but also providing shape distinctions that may be used for commands and other functions. The rocking of the thumb or finger (rocking from a flat orientation to a tip orientation) may also provide z-axis attributes or functions. This may also be combined with movement while rocking. In 3D environments, the blob and/or centroid data (along with other movement attributes such as direction, pressure distribution, temperatures distribution, etc.) maybe used, but instead of blob data, pixilation in 3D in any environment, or volumetric differences (sensed in any way) along axes (plural) may be used in the same way as blob and/or centroid data to analyze, determine, anticipate, and/or predict user intent. These aspects may also be seen or used as a “field” of influence determinative. In these embodiments, temperature may be used for a number of different purposes. First, the temperature data may be used to ensure that the motion sensor is detecting a living person. Second, the temperature data may be used as data to insure that the user sensed within the active zones of the sensor or sensors is indeed the user that has access to the systems and methods on the particular device. Of course, temperature data is not the only data that the sensors may determine. The sensors may also capture other user specific data.

In certain embodiments, the systems and methods of this disclosure include controlling a hologram remotely or by interacting with it. Pivoting the hand in parallel with a field may provide one control, while changing an angle of the hand may be perceived as a “blob” data change, a transition to centroid data, or a combination thereof. This transition may also be represented on a display as going from a blob to a point, and the transition may be shown as a line or vector with or without gradient attributes. Putting these into the hologram example, changing from blob data to centroid data, and seeing a vector and a gradient of change of volume or area along the vector may be used to change the display in the hologram of a shoe (for example) so the shoe may change size and direction according to the movement of the user. This methodology may be performed in any conceivable predetermined or dynamically controllable way, where attributes may be any single or combination of intent, attribute, selection, object, command or design. These movements and/or movement attributes may be simultaneously or sequentially used in any environment, and in whole or part, and include gradients of attributes based on changes of perceived mass, pressures, temperature, volume, area, and/or influence. These changes may be sensed and defined by any sensor or software reproduction ability (software may be used to replicate movement or the effects of movement). This also allows for a 2D sensor to provide 3D controls. All this may also be used to determine unique BioKinetic identifiers as well and in combination with these attributes.

In certain embodiments, the systems and methods of this disclosure include using blob data to orient a menu appropriately, where the blob data comprises raw sensor output data based on a number of sensing elements being activated above the threshold activation. For example, in the case of a touch screen, when a user touches the screen with a finger tip or other part of a finger, the sensor generates a blob of data comprising all sensing elements activated (based on some threshold activation value). The data is generally used to determine a centroid of the contact and that value is then used in further processing. However, the blob data may be used not only to differentiate different users, but may also be used to predict or anticipate user movement and ascertain movement and changes in movement. By knowing which thumb or finger is located at what area of the screen, the displayed menu upon a touch or entry into a sensor area may be positioned to provide a best heuristics or positioning based on the touch area and or user movement. For instance, touching the right thumb on a right side of a phone screen in a lower quadrant may signal the systems or methods to display a menu along a radius just above the thumb, while an angle of the thumb when touching a middle of the screen may result in displaying a radial menu just below the thumb if the thumb was pointing upwards towards an opposite corner, or above the thumb if the thumb was pointing towards a bottom left corner.

In certain embodiments, the systems and methods of this disclosure include one menu appearing when touching an upper part of the screen and a different menu appearing when touching a different part of the screen such as a lower part of the screen. If the finger is flat and not angled when touching the screen, different menus may be activated. So the position of the finger, finger angle, finger direction, finger pressures distribution, and/or combinations thereof may result in different menu sets, object sets, attribute sets, command sets, etc., and/or mixtures of combinations thereof for further processing based on movement data. Of course, all of these concepts may be equally applied to 2D, 3D, 4D, or other multi-dimensional environments both real, augments and/or virtual.

### Systems and Methods Using Bread Crumb Procedures

In certain embodiments, the systems and methods of this disclosure include using “bread crumbs” or “habits” to determine direction of movement in an active zone or field of a sensor, of a plurality of sensors, and/or of a sensor array. When a user moves towards a desired location on a screen of a phone, especially across the screen to make a touch event, the sensor(s) will begin to “see” data associated with the user's movement, but not necessarily in a continuous manner. Instead, the sensor(s) will see a series of points, with increasing frequency, intensity, and/or coverage area, and will begin to be sensed as the user movement comes closer to “contact” with a desired screen location. This data may be used to determine speed and direction, which in turn may be used to predict or anticipate user intent, which objects or attributes are active for choosing attributes rather than objects first is another application that you have filed. This provides a verification aspect so the objects and/or attributes may be selected before a physical confirmation occurs (a touch event), or to cause objects and/or attributes to begin to respond (with color changes, sounds, tactile feedback, shape, animations, etc.) before a confirmatory touch or action occurs. In this way, movement and then a touch may represent a unique signature or identifier as well. It should be recognized that the bread crumbs or habits may be positive attributes and/or reactions or negative attributes and/or reactions.

In certain embodiments, the systems, apparatuses, interfaces, and/or methods of this disclosure include a user performing a movement or gesture then verbally identifying or confirming what attribute, command, or function to associate with the movement or gesture. This may be simultaneously or sequentially performed. Again, in the context of this disclosure, simultaneous means events that occur concurrently or event that occur in rapid succession within in a “short” time frame (e.g., a short time frame is between about 1 ps and about 1 s), while sequentially means that the actions occur sequentially over a “long” time frame (e.g., a long time frame is between about 1 s and about 10 s). For example, a user moving in an upward direction, while saying “volume up” results in controlling and increasing a volume of a sound. A user may instead say “base” or “base up”, and a base intensity increases instead of the volume.

In certain embodiments, the above describe aspect maybe used as a security identifier, where a movement and a voice command may be used to unlock a locked menu, object, and/or attribute or act as a unique identifier for activating a menu, object, and/or attribute. By moving with a right finger or thumb from left to right, and saying “open”, a locked phone may be unlocked, or any other command or function may occur. Both aspects may provide for biometric identification as well. Another example is facial recognition plus a specific gesture or dynamic motion event. These changes may be sequential changes collected over a long time frame and/or simultaneous changes collected over a short time frame allowing further refinement of user identification, verification and/or authentication. This may also include multiple touches or sensed points, multiple words or commands, or any combination of these. Instead of words, sounds, notes, or any audible or other kind of wave form may be used. Touching a zone or location on a screen, while saying a desired attribute, command, or any other desired choice is another way this may be used. Another benefit of this is the ability to quickly associate commands or attributes (scrolls, selections, actuations, or attributes), training a system or interface in an easy way. In this way, controls can easily be customized to the user preferences.

Another example of this methodology is to use an area of a touch on the screen. By touching the upper right quadrant of the screen (or moving in that direction) and saying “travel”, the system may be trained or programmed so that this touch may display a travel menu of objects or other attributes. By touching or moving in (or towards) the bottom right quadrant and saying “food”, a menu of restaurants may be displayed. From that point on, touching or moving towards the associated location or area may provide a different menu, selection or attribute than moving towards or touching a different area. In another example, saying “lights” may invoke a display of controllable lights on a mobile device or in a virtual or augmented environment. By aligning a finger or gaze with the “lights” object, the user may say “hallway” and the hallway light would move under the user's finger or gaze, just as if it had been selected by moving towards it (as described in other applications). A color wheel may display and the user move into the color wheel to select a color, or the user may say “warm” and a sliding scale of yellow-based colors would move or appear under the user's finger, which the user could then move to select the desired hue. By having a motion-based architecture already established, any motion may be replaced by a voice command, and any voice command may be replaced by a motion, or a combination of the two. As the User moves towards the bedroom light icon and says “warm”, the sliding scale would show under the user's finger (or gaze) and immediate attribute control would be possible. This is also true in 3D environments such as an augmented or virtual reality environment, where gestures or movement may be associated with controls, selections, menu items or attributes by performing the desired gesture or motion and saying (simultaneously or sequentially) what the associated attribute and/or selection is. This may be performed in virtual space or on real displays, so that areas or volumes or locations in 2D and 3D space may operate in the same way.

In certain embodiments, the, apparatuses, interfaces, and/or methods of this disclosure include locating an object at a point where it may have been before, or a 3D camera in a structure so it is the optimal distance from walls or other objects in a space. One way of doing this is to take a phone (or any device with sensors) and touch a wall or come close enough to be considered a threshold event (for example) with the phone and a trigger of some kind (touching a control object on the phone or saying “start” or other kind of triggering command, and begin to walk towards a perceived location in the middle of a room. The phone displays a visual “chord” or vector from where the wall was touched to your location. This may be done by using the compass, magnetometer, gyroscope, accelerometer, or any other sensor of the phone and the steps as measure by other sensors of the phone (such as changes in the accelerometer data of the phone). Repeating this with each wall, or at least one or two points, and as the user moves, the intersection of these vectors can be determined and seen on a screen. By running spatial algorithms, the central part of the room can be determined. This can then be repeated later using different wall points to locate the center at a later point. By also using the distance from each wall or using corners or a wall at a specific height, accuracy is greatly enhanced. This ability to “drag” a set of vectors makes it easy for a user to move and locate the point they wish to recreate or find by using a display, processor and sensor combination. A central point or center of area can be determined as well as a previous point. In this way, a camera may be set at the same point over time to get sequential pictures from the same location.

The zoom level may also be set by a hold or other event, such as a touch, a “bounce” or “jerk” movement or gesture (of any kind), or verbal command, or any combination of these in motion based processing systems and methods described herein.

Zoom levels may be set by common parameters that are sensed, i.e., a distance from the face (most people will have a preferred distance to read, and this may be preset, or set at some point), and then holding the device at that point (within a range) triggers the capability.

Certain real content (real-world objects or images seen through a camera or sensed by other sensors in real time, sounds heard in real time by a microphone or other sensor), imaged content (web pages, images, videos, any other content shown on a device, or any kind of content not being seen as real content), virtual content (animated or extra image content that is associated with imaged or real content—i.e., when looking at a picture of a shirt either through the camera of a device, or while looking at an image of a shirt from a web site may trigger an animated 3D person wearing the shirt and walking on a sidewalk to provide further content to a user), or any data (commonly called metadata) associated with any content—any of these, or combination of these, may trigger a set point or to cause the systems to activate with a certain preset zoom and/or pan level.***

### Multi-User Combinational Controls

Embodiments of this disclosure also relate to systems and methods that include motion based sensor subsystems that support a plurality of users interacting with the sensor subsystem so that the systems are methods change the attributes of the displayed object(s), attribute(s), and/or environment(s) by combining the user interactions resulting in a combinationally changed object(s), attribute(s), and/or environment(s). For example, if the display is a hologram or picture, the sensor subsystems will sense movement by each user as each user interacts with a motion based processing subsystem of this disclosure. The systems and methods of this disclosure then combines the user interactions to change the picture or hologram to reflect a combination of the individual system interactions. For example, if the multiple users are interacting with a hologram and each select a color for the hologram, then the color actually displayed will constitute a color that is an addition of the colors selected by the users. If one user selected blue and another selects red, then the resulting color will be purple. The actual color may also be based on a “strength” of the selection or a “manner” of selection or a “timing of the selection. Thus, if the blue user is first to select, then the resulting color may be a bluer purple, while if the red user is first to select, then the resulting color may be a redder purple. If the blue user, make a more the blue selection immediately, while the red user took longer to select, then the resulting color may be a bluer purple. In virtual or augmented reality environments, interactions by multiple users within the environments may result in objects, features and/or attributes of the environments changing in a combinational manner based on a synthesis of the individual user interactions. For example, if the environment represents a game played by multiple users, then the systems and methods of this disclosure would change the objects, features, and/or attributes of the gaming environment based on a synthesis of the user interactions. Such combinational interactions may be used to alter the gaming environment as the game is being played in a manner wholly unexpected by the users. The same type of synthetic changes may be used in other type of systems including image processing, website design, data processing, financial processing, tread analyses, etc., where the system integrates all user interactions to display a combinational analysis of the processing results. In other embodiments, the systems and methods will capture sensor data relating to the size, proportions, other physical attributes of the users, objects, entities, etc. that are moving within the active zone or zones of the sensor or sensors or sensor array or sensor arrays.

Eye, Facial, and/or Body Expression/Language Used in Motion Based Processing

Embodiments of this disclosure also relate to systems and methods that include capturing eye, facial, and/or body language/expression and using the information in aspects of motion based processing herein. As previously states, eye, facial and body (in whole or in part) movement is used either for direct control of the functioning of the interfaces of this disclosure or a confirmatory movement for function selection and activation. However, this data does not capture the full range of data that may be used in motion based processing. There are a number of physiological changes that occur when people interact with people or things. Iris dilation and constriction, eyes fix, flutter or move, eye lids blink, facial expressions change, facial flushing, sweating, temperature changes, moisture content of tissue, body parts move or pose, for scent sensors odor, changes in odor, changes in breathing and gas output, chemical and neurological changes occur, etc. All of these changes evidence likes, dislikes, fascination, excitement, pleasure, anger, rage, and/or any other human emotion. These attributes of body part changes due to interactions with information content may be used to assist in the motion based function selection and processing and in improving prediction of motion based function selection and processing and in tailoring the motion based interfaces for the particular user based on these changes in body part movements and poses. For example, as an interface of this disclosure is activated and a scrolling function is invoked causing a list or menu to scroll across the display or other human cognizable output device, a change in iris dilation or constriction may be used to cluster desired content from less desired content or for activation of the object that corresponds to the highest amount of dilation or constriction. These same changes may be used to confirm a preliminary selection or to reject a preliminary selection. As the user interacts with the system over time, the system learns from these changes and structures the objects or content to conform with these changes. These changes may also be used in the construction of unique identifiers for new programs accessed by the user and color coding system or acoustic system may be used allowing “highlight” (color, sound, shape, pulsating, etc.) one or more objects to attract the attention of the user. The particular highlighting may be determined from general preference—how people in general respond to different stimuli or may be particularized based on the systems or methods learning what a particular highlighting a particular user responds best to. Of course, negative responses may be used to de-emphasize objects by invoking negative highlighting—highlighting that the user would not be attracted to. As this information is kinetic, the information may be combined with the biometric and other movement properties in the creation of unique identifiers. Thus, the systems of this disclosure may improve identifier uniqueness not only by capturing data associated with the manner of interaction with the interface, but also by using physiological responses and changes in physiological responses of a body and/or body part (e.g., physiological responses and changes in response of eyes, ears, face, mouth, lips, finger, hands, arms, shoulders, head, iris, sweat, or any other detectable change in physiological responses of bodies or body parts) to further enhance user identification. Thus, the systems of this disclosure may simply observe the user until the systems have accumulated sufficient user specific biometric, kinetic, and/or biokinetic data to construct unique identifiers so that when user activates a new application that requires a user name and password, the systems generate unique user names and passwords that are established without the user having to remember anything. The systems would simply observe the user and then all applications user names and passwords established using the systems of this disclosure would be automatically established when a particular application is activated.

### Ereaders

In certain embodiments, where the systems and methods of this disclosure are adapted to work with e-readers, the systems and methods would be able to follow the eye movement of the user and when the user came to the end of a page eye movement away from the page would cause the systems and methods to advance the page one page forward. The systems and methods could also be customized to each user so that when the user eye gets to the bottom of the page, the top part of the page would be begin to fade into the next page with final part of page fading to the new page as the user eye tracks up. In other embodiments, the systems and methods may learn the readers reading speed so that page changing or page fading may be timed to the users reading speed.

### Encryption Systems and Methods

Embodiments of this disclosure also relate to methods for encrypting data between users. The methods involve establishing a biokinetic identifier for each user using motion and biometric sensors to construct a unique biokinetic identifier for the sender and receiver. The identifiers are then embedded in files to be sent during encryption and act as the keys for locking an opening the file after transmission and receipt. Thus, the sender is able to open the file for any purpose and the receiver is able to open the file for any purpose.

While the biokinetic identifiers may be preconstructed by the users using the interfaces and systems of this disclosure, the identifiers may be made even more unique by constructing the biokinetic signature at the time of encryption. Thus, the systems capture sufficient biometric and kinetic data from the sender and receiver to construct on the fly unique identifiers. The receiver biokinetic identifier, whether premade or on the fly, is transmitted to the sender system. The sender system then uses the sender identifier, whether premade or on the fly, and the receiver identifier, whether premade or on the fly, as the lock and key for encrypting the file. The file can then be sent from the sender system to the receiver system.

### Security Systems and Methods

Embodiments of this disclosure also relate to computer security systems utilizing the unique biokinetic identifiers. Once the computer security system software of this disclosure is installed on a computer, the system utilizes the motion and biometric sensors to construct a security identifier to reduce or prevent security breaches into the computer. When the user opens the computer, the system using the security identifier to unlock the computer before it can be used.

For computer networks including a plurality of computers, the computer security systems are installed on all of the computers. Once installed, the systems are used to construct a plurality of authorized security identifiers. These authorized security identifiers, which are each biokinetic identifiers unique for each authorized personnel, are then uploaded to each computer in the computer network. The set of authorized personnel may be updated or modified by a subset of the authorized personnel that have the authority to add, delete, update or modify user security levels, where the security levels provide the systems with information on the scope of activities each authorized person can undertake in changing or modifying elements of the computer systems from added new computers, to deleting old computers, to updating user information on each computer, to locking computer systems when motion sensor or biometric sensors fail or the software becomes corrupted. Once the computer security systems have been installed across the network to all connected and authorized computers and the authorized security identifiers have been uploaded to all the connected and authorized computers, each time a user activates the computer assigned to the user, the systems captures biometric and motion data via the biometric and motion sensors, which of course may be the same or different, until a unique biokinetic identifier is capable of being constructed. Once constructed, the identifier is uploaded to an identifier database and the computer is locked by the identifier so that each time the user comes to the assigned computer, the systems will capture biometric and motion data sufficient to determine that the user is then one assigned to this computer. Of course, each computer may be assessable by one or more users, provided that the identifier of each user is resident on the user computers. Please note that each identifier of this disclosure is designed to have a security quotient of greater than about 80%, greater than about 85%, greater than about 90, greater than about 95%, or greater than about 99%.

Deliberate Movement Differentiated from Spontaneous or Non-Deliberate Movement

In certain embodiments, the systems, apparatuses, and/or interfaces of this disclosure and the methods implementing them include sensing deliberate or intentional, generally predefined, movements, outputting the sensed movement as an output, and converting the output into a command and control function including, without limitation, a select function, an activate function, a scroll function, an attribute control function, and/or combination thereof. The deliberate or intentional movements may be associated with eye tracking or head tracking motion sensors or with any other motion sensor or deliberate or intentional movements associated with a specific body part or member under the control of an entity. The deliberate or intentional movements may be to move an eye or the eyes across a displayed selectable object, then to change a speed a predetermined amount so a desire function is invoked. For example, for the systems, apparatuses, and/or interfaces including a display and an eye-tracking sensor, when the user looks across a particular object or a set of objects or stares at a particular object or set of objects, then a particular function may be invoked such as a select function, a select and activate function or a select, activate and adjust attribute value function, but if the user looks across a face of the object at a preset speed, then a particular function may be invokes such as a select and activate function. It should be recognized that in the case of eye movement, the deliberate or intentional movements including its movement properties must be discernibly distinct from normal eye movement. In certain embodiments, the systems, apparatuses, and/or interfaces sense motion from one or more motion sensors and monitor the movement until the movement meets one or more criterion sufficient to distinguish the movement from normal eye movement—threshold criteria are satisfied. For example, the deliberate or intentional movement may be a slow but continuous movement, a pause at a corner and a look quickly towards another corner (diagonally), or some other change of rate of speed or acceleration that is distinguishable from normal eye movement.

Another example of deliberate or intentional movements may involve differentiating normal viewing behavior from viewing behavior that is deliberate. Users typically do not look directly at a middle of a displayed object, but rather look at the whole object or just below a center, i.e., the users focus is not on the center of the object. Thus, a deliberate movement may be just to stare at a center of an object or to stare at some other location in an object; provided, however, that the movement is sufficient for the systems, apparatuses, and/or interfaces to distinguish the movement from normal eye movement. A person may look at an object, and when it is determined by a sensor that an object is generally being looked at, a center or centroid of the object may be displayed differently (or just be active without appearing differently), such as a square or circle showing the centroid area so that the systems, apparatuses, and/or interfaces may use the motion sensor output associated with looking into the area or volume or moving through this area or volume and converting the output into a command and control function. Of course, the triggering area or volume may not be the center, but may be another location within the object. Therefore, looking at or towards an object may cause the systems, apparatuses, and/or interfaces to pre-select the object, but only when the user moves the gaze into the active area/volume (generally predefined) does the systems, apparatuses, and/or interfaces invoke a particular command and control function. Alternatively, the deliberate movements may involve moving across a predefined area, where speed of the motion does not matter, only that a traversal to a certain threshold is reached. Additionally, other movement properties (e.g., speed, velocity, and/or acceleration or changes of these) may be used as part of the predefined movement to invoke a particular function or functions. This same technique may be applied to users that have certain type of maladies that prevent them from smooth movement, the systems, apparatuses, and/or interfaces may be tailored to determine difference(s) between normal user movement and deliberate user movement even though the difference(s) may be subtle.

Constructs with Continuous Properties

In certain embodiments, the systems, apparatuses, and/or interfaces of this disclosure and the methods implementing them may utilize constructs having continuous properties (e.g., continuous values—analog—instead of discrete values—digital). In such environments (all objects are waveforms that are capable of interacting), the movement may navigate through the continuous properties with a change in movement or a deliberate movement may result in the selection of a particular value of a continuous property or a set of continuous properties. Thus, waveform and waveform interactions may be manipulated, adjusted, altered, etc. and viewed. Additionally, given interaction patterns may cause the systems, apparatuses, and/or interfaces to invoke a particular function or set of functions. Attribute may be a subset or other attribute of an object, but may also be associated with a change in a waveform, that is different from scrolling, in that scrolling must have integer values (or stops along a path). It like a guitar, where scrolling would be moving through frets, but sliding the string sideways (bending) the string produces frequency changes with no preset integer values, where systems, apparatuses, and/or interfaces may use both outputs to invoke a different function or set of functions, which may be predefined or determined from context on the fly.

### Real-Time Prediction of User Intent

People move typically in a straighter line, and faster when they know what they want or are choosing something. In certain embodiments, the systems, apparatuses, and/or interfaces may be used to predict to a certain probability, what a particular user choice may be based on how fast and/or straight the user moves towards a particular selectable object. In some cases, such as movement of the thumb, where the movement comprises rotating about a thumb joint, the motion may be arcuate, and moving in a non-arcuate manner may be seen as more intentional, thus providing a higher probability. Other things that may affect the confidence of making a selection (or the probability), include proximity (closer to one object than another), slowing down as approaching a particular object (changes in direction, distance, duration, speed, velocity, acceleration, etc.) such as decelerating when moving towards a particular letter on a keyboard, then moving away at an increased acceleration (after choosing a letter on a keyboard and moving to the next). The systems, apparatuses and/or interfaces may improve real-time confidence determinates by using artificial intelligence (AI) routines based on confidence data including historical, environmental, or contextual data stored in libraries and/or databases and may be coupled with the the above movement properties to enhance predictive confidence.

### Self-Centering User Interface (SCUI)

In certain embodiments, the systems, apparatuses, and/or interfaces of this disclosure and the methods implementing them relate to novel self-centering interface (SCUI) for controlling objects (software, hardware, attributes, waveforms or any other selectable, scrollable, activatable, scrollable or otherwise controllable thing) such as controlling drones through head motions using head motion sensors. For example, picture a compass rose with a hole in its middle and divided into 4 quarters: NE, NW, SW and SE. As the user moves leftward in the SW quadrant, the systems, apparatuses, and/or interfaces may cause the drone to move to the left and a distance of the movement to the left controls the speed of the drone's movement to the left. Thus, the further the user moves to the left within the SW quadrant the faster the drone moves to the left. Similarly, as the user moves rightward in the SE quadrant, the systems, apparatuses, and/or interfaces may cause the drone to move to the right and a distance of the movement to the right controls the speed of the drone's movement to the right. Thus, the further the user moves to the right within the SE quadrant the faster the drone moves to the right. In this way, the user may use a pair of glasses (such as AR/VR/MR glasses, etc.) and see the drone, and move the drone while using a semi-transparent UI design, when using an intentional speed of head movement, i.e., deliberate head movement. So, by moving quickly, the UI may not cause the drone to move as the systems, apparatuses, and/or interfaces may determine that such movement does not represent a deliberate movement sufficient for drone control. Thus, if the movement is determined by the systems, apparatuses, and/or interfaces to be a deliberate movement, then the UI may cause the drone to undergo are corresponding movement. By moving in a specific deliberate manner, a menu may be activated, the view centered along the focus or gaze direction (self-centering) and the menu objects or elements arranged in a spaced apart configuration (e.g., concentrically) about a center of the user head or eye position, i.e., arranged about the gaze point. In this donut compass rose example, when the gaze is in the center, or donut hole area, the systems, apparatuses, and/or interfaces cause the drone to transition into a stationary state, which may be a hover state or a state of constant motion based on the last set of head/eye movements. The systems, apparatuses, and/or interfaces may discriminate between a hover state and a constant motion state base on the duration of the gaze (duration of a timed hold), on where in the center area the gaze is fixed. Moving left and right (x-axis) moves the drone left and right. Moving up and down (y axis) move the drone up and down. Moving in a combination of x and y movement, moves the drone similarly. Additionally, other movement within different quadrants such as the movement within NW or NE quadrants may control rotation of the drone on its axis, left or right, respectively, or may control pitch, yaw, roll, or other motions.

In other embodiments, the systems, apparatuses, and/or interfaces of this disclosure and the methods implementing them relate to novel user interfaces comprising three different control object formats: screen locked, world locked absolute, and world lock relative. Screen locked means that an object, a plurality of objects, an attribute, and/or a plurality of attributes remain in the user field of view at all times regardless of where in the “world” the user view is. World locked absolute means that an object, a plurality of objects, an attribute, and/or a plurality of attributes may become associated with or transitioned to a specific world view object or a specific world view location remain fixed to that object or location and do not move. Therefore, if the user movement moves that view so that the object or location moves outside of the current view, then the control objects and/or attributes associated with the object or location will be no longer visible. World locked relative means that an object, a plurality of objects, an attribute, and/or a plurality of attributes may be associated with or transitioned to the world view, but the object, the objects, the attribute, and/or the attributes may follow the user gaze, but lag behind so that they may not be accessible until the movement stops or stops for a specific period of time. For drone controls, certain drone controls may be screen located, while other drone controls may be world locked absolute, while other may be world locked relative. For example, a target and/or target attributes may be world locked absolute, a drone position controls for moving the drone along a path to the target may be world locked relative, and camera controls or weapon controls may be screen locked. Of course, the user may change the objects and attributes that are screen locked, world locked absolute, or world locked relative.

Putting these concepts together, sensing a deliberate movement causes the systems, apparatuses, and/or interfaces to activate the UI or to begin user interaction with the UI and causes an image of the drone to appear in the world view. The UI comprises the three locked formats. Then, sensing movement to the left within the SW quadrant, the systems, apparatuses, and/or interfaces causes the drone to move left, where the speed of drone movement to the left is controlled by the distance the sensed movement of the user to the left within the SW quadrant. As the drone moves, the screen locked object, objects, attribute, and/or attributes move with the users; the world locked absolute object, objects, attribute, and/or attributes remain fixed to an object in the world or a location in the world; and the world locked relative object, objects, attribute, and/or attributes track the movement of the drone. The tracking may be appear as it the object, objects, attribute, and/or attributes are screen locked—they move in direct correlation to the drone, or they are move at a slower rate or they move so that only after user movement stop that they move back into the user view. Optionally, the world locked relative object, objects, attribute, and/or attributes may move in front of the drone so that the has a preview of the drones course and may adjust it accordingly. When the user head or eye movement stops at a gaze point (user gaze at a fixed location in the world view), then the drone movement will either stop or the drone continues to move in accord with the movement at the time the user movement stops, where a type of gaze—duration, gaze center, etc., determines whether the gaze cause the drone to hover in place or continue to move in accord with the last movement properties. In certain embodiment, once a fixed gaze is detected, then the world locked relative object, objects, attribute, and/or attributes, which have been following the user movement, catches up to the gaze point, and become centered about the gaze point. Because the UI is controlling the drone, the drone now centers itself in alignment with the UI, which is centered around the gaze point. In one embodiments, the UI lags slightly behind the gaze point, and the drone lagging slightly behind the UI.

This same UI may also be used to control z-axis motions by either using 3D sensor data (from head motion sensor or other motion sensors), or by using a unique 2D construct that provides 3D controls. An example of this is the same compass rose (or circular/radial UI menu/controller) with a donut hole, but now adding a designated z-axis area as described herein. In one embodiment, the UI is in the shape of a funnel as set forth herein, providing a slim, pure z-axis control wedge zone centered within the z-control wedge. Moving towards or away from the center of this z-zone moves the drone along the z-axis. The UI is divided into two parts, with a dead zone. The center area provides 3D x/y/z axis controls, while the outer part of the funnel is 2D and provides only x/y control (as described above). In the 3D area, if the user moves out of the Z-zone, but remains in the inner section, then the motion represents a combination of x, y and z. If the user moves into the outer zone, only x/y controls are provided.

### Automotive Display System

In certain embodiments, the systems, apparatuses, and/or interfaces may be configured to display traffic information, traffic signs, and traffic notices projected onto the windshield. Billboards and regulatory signs and other traffic related notices are common when driving a vehicle on roads, highways, freeways and tollways throughout the world. The systems, apparatuses, and/or interfaces may be configured to display on the windshield (e.g., HUDs) or on the interior surface of visor of a helmet representing a new method for providing information to drivers or occupants. One specific example is where a driver is traveling along a highway approaching a location that is designated as an information or regulatory sign area or sensors on the vehicle “sees” an information or regulatory sign, a virtual representation of the sign may be displayed in a center of the windshield, appearing smaller and with a perspective of appearing far away. As the driver continues moving toward the sign, this virtual sign grows larger and moves across the windshield just as if it was a real sign and the driver was passing it by. Being a virtual sign, the image and information may be “frozen” or recalled at any time, replayed, or may be magnified or scrolled through using motions as has been described herein. In addition, the systems, apparatuses, and/or interfaces may use voice commands or a combination of motion and voice commands to recalled at any time, replayed, or may be magnified or scrolled through viewed signs. Being able to interact with motion on a steering wheel (touchpad, optical sensor, etc.), with eye tracking, HUD, or any other ways may provide the driver the ability to review missed information. It may also provide the ability to have changes updated according to the vehicle or occupants (speed of vehicle, notifications from family members, etc.) in real time or according to scheduled times. The systems, apparatuses, and/or interfaces may also be linked to a phone or other system, and this information may be displayed as one of these virtual signs as well, whether connected to a location or not. With regard to speed, the systems, apparatuses, and/or interfaces may also display vehicle speed above or below certain differences from regulations, providing flashing or other animated graphics, or even multiple layers at once to show differences over time of messages.

Analytics Using the Same Motions that Control Things

In certain embodiments, the systems, apparatuses, and/or interfaces may use historical data to predict user intent and cause actions (such as selections) to happen faster without have to move to an object. Thus, by analyzing past user behavior and movement characteristics, the systems, apparatuses, and/or interfaces may be able to more quickly, which object aligned with a particular movement is more likely the target. The same vectors that change with speed and direction (and these changes provide controls) also tell us many things about the user. For instance, scrolling back and forth (say x-axis movement) between two out of five items, then moving towards a particular object (say y axis movement), selects and activates that object. But knowing the other objects lets the systems, apparatuses, and/or interfaces classify alternate choices, that may be ranked based on historical data. The use of analytics may find particular application in advertising or training methods using the motion based systems, apparatuses, and/or interfaces of this disclosure.

In other embodiments, systems, apparatuses, and/or interfaces may use these predictive methodologies that cause objects to move towards the user or a selection object to predict zones for foveated rendering. In VR or other mixed reality environments, graphics rendering is extremely time consuming. To compensate for this, graphics rendering at the highest resolution is generally restricted to an area or areas associated with a center of vision. By restricting the high resolution rendering to these areas provides the user with a good experience. Thus, the high resolution graphics rendering doesn;t need to be performed on zones, areas, or volumes not being looked at. In this way, prediction of where the user will be looking may assist in foveated rendering, so that part of the display may be rendering the predicted zones, so the user sees no apparent delay in rendering.

In other embodiments, the systems, apparatuses, and/or interfaces of this disclosure and the methods implementing them, where the systems, apparatuses, and/or interfaces include at least one eye and/or head tracking sensor, at least one processing unit, and at least one user feedback unit. The systems, apparatuses, and/or interfaces permit two different pinning modes. The first pinning mode is that the tracking sensor includes information about objects displayed in a tracking based manner viewable at a left and right edge of the viewing plane. These object may be selected by moving the head and/or eyes toward the tracking pinned objects causing them to appear in the center of the field so that they can be controlled by further head and/or eye movement. As the user views a real world object in a real world environment, an object in a AR environment or an object in a VR environment, the user may transition the selection format from a tracking pinned format to a world pinned format. In the tracking pinned format, the selection and control function for the object under the control of the systems, apparatuses, and/or interfaces remain with the tracking sensor and may be accessed at any time, but once the user sees an object pauses at the object or moves in a predetermined manner toward that object, the systems, apparatuses, and/or interfaces pins the object control functions to the object. The pinning may be permanent or relative. Permanent pinning ties the control functions to the object so that you may return to the object to be able to control its attributes. Relative pinning means that the object control function travel with the world view either directly or with a lag as it follows the eye and/or head movement.

The inventor has found that movement based systems, apparatuses, and/or interfaces and methods implement them, where the systems, apparatuses, and/or interfaces include at least one sensor, at least one processing unit, at least one user cognizable feedback unit, and one real and one real or virtual object or a plurality of real and/or virtual objects controllable by the at least one processing unit, where the at least one sensor senses blob data associated with touch and/or movement on or within an active zone of the at least one sensor and generates an output and/or a plurality of outputs representing the blob data, and where the at least one processing unit converts that blob data outputs into a function or plurality of functions for controlling the real and/or virtual object and/or objects.

### Triggers

In certain embodiments, the systems, apparatuses, and/or interfaces of this disclosure and methods implementing them use a marker or an image/character recognition feature to trigger a menu or metadata that may then be used with menuing systems of this disclosure or any other menuing system. These markers or features are similar to a 2D or 3D barcode, emoticons, or any object or feature that may be recognized as a trigger. The trigger may be used to unlock certain locked menus or lists for special access. The triggers may also be used for tailoring triggers to cause the systems, apparatuses, and/or interfaces to invoke specific and pre-defined menus, objects, programs, devices, or other specific or pre-defined items under the control of the systems, apparatuses, and/or interfaces.

The inventors have found that motion-based eye and/or head tracking apparatuses, interfaces, systems, and methods for implementing them may be constructed, where the interface is associated with a mobile device, a lap top computer, or a stationary computer or desk top computer having at least one display device and at least one processing unit and include at least one eye tracking glasses, head tracking device, or other eye tracking or head tracking device (collectively eye tracking sensor), which may be a sensor associated with the mobile device, the lap top computer, or the stationary computer or desk top computer or may be a separate device in communication with the mobile device, the lap top computer, or the stationary computer or desk top computer.

In certain embodiments the interface operates as follows. The at least one eye tracking sensor senses eye motion or movement as the eye, eyes, or head traverse a plurality of selectable icons or objects displayed on the at least one display device. The at least one processing unit may be configured to receive an output signal(s) from the at least one eye tracking senor as the eye, eyes, and/or head traverse the icons or objects. The at least one processing unit may also be configured to (1) immediately activate a particular icon or object, when the eye movement moves in, on, or at the particular icon or object; or (2) activate a particular icon or object, when the eye movement moves in, on or at the particular icon or object and stops for a microhold in, on, or at the particular icon or object. The at least one processing unit may also be configured to display a list of attribute icons or object, if the particular object or icon has associated attributes. The at least one processing unit may also be configured to receive output signal(s) from the at least one eye tracking sensor relating to further eye movement towards a particular attribute icon and to activate the attribute icon. The particular attribute icon may be (1) an adjustable attribute so that further eye movement in one direction will increase the value of the attribute, while eye movement the opposite direction will decrease the value of the attribute, (2) the particular attribute icon may be associated with a sublist, where further eye movement towards as item in the sublist will activate the item, or (3) the particular attribute icon may be associated with values set for in a matrix format, where further eye movement in, on, or at a matric location will set the attribute value. In certain, embodiments, the at least one processing unit may also highlight a particular icon or object, when the eye movement moves in, on, or at the particular icon or object, where the highlighting may be enlargement or any other highlighting effect the will discriminate the particular icon or object from the other icons or displays. Additionally, the enlargement may cover non-selected icon or objects that are deactivated by the eye movement in, on, or at the particular icon or object.

In other embodiments the interface operates as follows. The at least one eye tracking sensor senses eye motion or movement as the eye, eyes, or head traverse a plurality of selectable icons or objects displayed on the at least one display device. The at least one processing unit may be configured to receive an output signal(s) from the at least one eye tracking senor as the eye, eyes, and/or head traverse the icons or objects. The at least one processing unit may also be configured to highlight a particular icon or object, when the eye movement moves in, on, or at the particular icon or object. The at least one processing unit may also be configured to (1) receive further eye movement in, on, or at a portion of the highlighted icon or object to confirm the selection of the particular icon or object; and (2) activate the particular icon or object after eye movement confirmation. Alternately, the at least one processing unit may also be configured to (1) receive further eye movement in, on, or at a area or portion of the highlighted icon or object to confirm selection; and (2) to immediately activate the particular icon or object. In another alternative, the at least one processing unit may also be configured to (1) receive further eye movement in, on, or at a portion of the highlighted icon or object and stop for a microhold to confirm selection; and (2) activate the particular icon or object after the microhold confirmation. The at least one processing unit is also configured to display a list of attribute icons or object, if the particular object or icon has associated attributes. The at least one processing unit is also configured to receive output signal(s) from the at least one eye tracking sensor relating to further eye movement towards a particular attribute icon and to activate the attribute icon and a microhold in, on, or at the particular attribute icon. The particular attribute icon may be (1) an adjustable attribute so that further eye movement in one direction will increase the value of the attribute, while eye movement the opposite direction will decrease the value of the attribute, (2) the particular attribute icon may be associated with a sublist, where further eye movement towards as item in the sublist will activate the item, or (3) the particular attribute icon may be associated with values set for in a matrix format, where further eye movement in, on, or at a matric location will set the attribute value. In certain, embodiments, the at least one processing unit may also highlight a particular icon or object, when the eye movement moves in, on, or at the particular icon or object, where the highlighting may be enlargement or any other highlighting effect the will discriminate the particular icon or object from the other icons or displays. Additionally, the enlargement may cover non-selected icon or objects that are deactivated by the eye movement in, on, or at the particular icon or object.

In other embodiments the interface operates as follows. The at least one eye tracking sensor senses eye motion or movement as the eye, eyes, or head traverse a plurality of selectable icons or objects displayed on the at least one display device. The at least one processing unit may be configured to (1) receive an output signal(s) from the at least one eye tracking senor as the eye, eyes, and/or head traverse the icons or objects; (2) highlight a particular icon or object, when the eye movement moves in, on, or at the particular icon or object; (3) display a confirmation icon within the highlighted icon or object, (4) receive a microhold on the confirmation icon; and (5) activate the highlighted icon. The at least one processing unit is also configured to display a list of attribute icons or object, if the particular object or icon has associated attributes. The at least one processing unit is also configured to receive output signal(s) from the at least one eye tracking sensor relating to further eye movement towards a particular attribute icon and to activate the attribute icon and a microhold in, on, or at the particular attribute icon. The particular attribute icon may be (1) an adjustable attribute so that further eye movement in one direction will increase the value of the attribute, while eye movement the opposite direction will decrease the value of the attribute, (2) the particular attribute icon may be associated with a sublist, where further eye movement towards as item in the sublist will activate the item, or (3) the particular attribute icon may be associated with values set for in a matrix format, where further eye movement in, on, or at a matric location will set the attribute value. In certain, embodiments, the at least one processing unit may also highlight a particular icon or object, when the eye movement moves in, on, or at the particular icon or object, where the highlighting may be enlargement or any other highlighting effect the will discriminate the particular icon or object from the other icons or displays. Additionally, the enlargement may cover non-selected icon or objects that are deactivated by the eye movement in, on, or at the particular icon or object.

In other embodiments, the processing unit maybe configured to highlight each icon or object as the eye movement passes onto, at, into an icon or object and activate the icon only if the eye movement includes a change in direction within the icon or object screen area, otherwise the icon or object is restored to its normal configuration.

It should be recognized that eye movement that continues beyond the highlight icon will result in the processing unit removing the highlighting and await further eye movement. It should also be recognized that the processing unit may be configured to only populate the display after a threshold movement event occurs or after a correct login event occurs, which may be a biokinetic identifier.

Another aspect of the interfaces of this disclosure is that the faster the selection object moves toward the pre-selected selectable object or the group of pre-selected selectable objects, the faster the pre-selected selectable object or the group of preselected selectable objects move toward the selection objector the faster the objects may move in a different direction, such as away or at angles to the user's motion.

Another aspect of the interfaces of this disclosure is that as the pre-selected selectable object or the group of pre-selected selectable objects move toward the selection object, the pre-selected selectable object or the group of pre-selected selectable objects or zone or active areas may also increase in size, change color, become highlighted, have other effects change, or mixtures or combinations thereof.

Another aspect of the interfaces of this disclosure is that each object that has at least one adjustable attribute may include an adjustable active area associated with each adjustable attribute associated with the objects that become displayed as the selectable object is augmented by the motion. Moreover, as the selectable object becomes more certain of selection, the adjustable active areas may increase in size as the selection object moves toward the selectable object or “gravity” pulls the selectable object toward the selection object. The active area permits selection to be made prior to any actual contact with the object, and allows selection to be made merely by moving in the direction of the desired object. The active area may be thought of as a halo effect surrounding the object activated by motion toward the object.

Another aspect of the interfaces of this disclosure is that as motion continues, the motion will start to discriminate between members of a group of pre-selected objects until the motion results in the selection of a single displayed (discernible) object or a group of displayed (discernible) objects. As the motion continues, the display will begin to discriminate between objects that are aligned with the motion and objects that are not, emphasizing the selectable objects aligned with the motion (i.e., objects in the direction of motion) and de-emphasizing the non-selectable objects not aligned with the motion (i.e., objects away from the direction of motion), where the emphasis may be any change in object(s) properties, changes in object(s) positions, or a combination thereof and the de-emphasis may be any change in the object(s) properties, changes in object(s) positions, or combination thereof.

Another aspect of the interfaces of this disclosure is the display, movement, and positioning of sublist members or attributes associated with object(s) may be simultaneous and synchronous or asynchronous with the movement and display of the selectable object(s) or display object(s) being influenced by the motion of the selection object(s). Once the selection object and a selectable display object touch or the selection object and a selectable display object active area touch or the selection object and a selectable display object is predicted with a threshold degree of certainty, a triggering threshold event (this may be the distance of proximity or probability without ever touching), the selectable object(s) is selected and non-selected display object are removed from the display or fade away or become less prominent or change in such a way that they are recognizable as the non-selected object(s) and the selected object is centered within the display or at a predetermined position, is adjusted to a desired amount if an adjustable attribute, or is executed if the selected object(s) is an attribute or selection command, or any combination of these. If the object is an executable object such as taking a photo, launching an application, changing a display orientation, scale or aspect, adjusting the volume, turning on a device, etc., then the execution is simultaneous or acts in a predetermined way with selection. If the object has a submenu, sublist or list of attributes associated with the selected object, then the submenu members, sublist members or attributes may become displayed on the screen is a spaced apart or differentiated format either after selection or during the selection process, with their distribution becoming more defined as the selection becomes more and more certain. The same procedure used to select the selected object is then used to select a member of the submenu, sublist or attribute list. This same effect may occur with a combination of executable, submenu, sublist, and listing attributes. Thus, the interfaces have a gravity or attractive or distortion or highlighting, or combination of these like action(s) on displayed selectable objects. As the selection object moves, it attracts an object or objects in alignment with the direction of the selection object's motion pulling those objects toward it, and may simultaneously repel other objects not aligned with the selection object's motion, causing them to move away or be identified as non-selected objects. The area, zone or volume of the objects may be simultaneously affected so as to magnify, reduce, or have other effect on the displayed or active area(s) associated with the object(s). As motion continues or a velocity or acceleration of the motion increase, the pull increases on the object(s) most aligned with the direction of motion, further accelerating the object toward the selection object until they touch, merge, or cause a triggering selection event, or a combination thereof. If two objects are along the same line or zone, and the closer of the two is attracted or selected as motion occurs toward the user, and motion continues in line, the first object may be treated like a non-wanted object and the second desired object is selected. If motion is stopped, stopped with a predetermined hold or dwell, or slowed to a predetermined threshold amount at the first object, it is considered selected. If motion continues at the first object, it is considered not selected. The touch, merge or triggering event causes the processing unit to select and activate the object, active an object sublist or menu, or active an attribute for control, or a combination thereof.

A combination or compound action of these events may occur as well, such as the eye gaze or eye motion acting as a selection object, and a secondary object of the pointing of a finger or touch on a surface acting as another, so the combination provides an enhanced or different effect than either one of the objects acting alone. One example in particular is where eye motion is used in a VR/AR environment to highlight or cause an effect on a zone of objects, such as expanding an area most associated with the direction or movement of the eye(s) and having objects least probable to diminish or move away from the zone being looked at or towards, or displaying a system of objects or menus associated with the objects (attributes), and a finger direction of motion, or a selection object, or an area or volume representing a selectable zone, further defines or selects the selectable objects, attributes or zones. Another example would be to touch a watch or wearable device to begin a selection or scrolling process, while tilting the watch further affects the selection, scrolling or attribute process, dynamically affecting the zones and/or objects as described above. Another example would be to move in one direction to adjust the brightness or volume of a wearable or mobile device with motion of a finger, on or a surface of the device, and having the display expand the audio zone signifying volume change, then synchronously or asynchronously changing the zonal size of the song choice by moving the device in a different direction or axis, or even in the same direction, but being able to differentiate the motion from the motion of the finger(s), and causing a different scroll, attribute or selection, or combination of these, to occur more easily based on the relevant zonal size of motion with what is most relevant to the first motion. In this example, using a hand or finger motion above the watch may change the volume, and rolling the wrist might advance or rewind the song based on direction of roll, while moving the wrist up or down may play or stop. While beginning to move in the second direction, the probability of changing the song increases as more motion is applied, and the attribute of adjusting volume diminishes until it is non-selectable while changing the song.

### Methods

Embodiments of this disclosure provide methods for implementing the selection protocol using the user interfaces of this disclosure. The methods include selecting and activating selectable objects, selecting and activating members of a selectable list of virtual and/or real objects, selecting and activating selectable attributes associated with the objects, selecting and activating and adjusting selectable attributes, zones, areas, or combinations thereof, where the interfaces include at least one display or other user feedback unit, at least one motion sensor (or data received therefrom), and at least one processing unit in communication with the user feedback units and the motion sensors or motion sensor data. The interfaces also may include power supplies, battery backups, and communications software and hardware for remote control and/or remote monitoring. The methods include sensing motion or movement sensed by the motion sensor(s), generating an output signal and sending the output signal to the processing unit. The methods also include converting the output signal into a command output via the processing unit. The command output may be a start command, which activates the feedback unit or activates the feedback unit and generates at least one selection or cursor object or activates the feedback unit and generates at least one selectable object or activates the feedback unit and generates at least one selection or cursor object and at least one selectable object. The selection object may be discernible or not (displayed or not). The motion may be generated by an animal or body part or parts, a human or body part or parts, a machine, or a real world object under control of an animal, a human, or a robot or robotic system, especially when the motion being sensed is within a 3D active sensing volume or zone. Once activated, the methods monitor sensed motion or movement within the active zone(s) of the motion sensor(s), which is used to move the selection object on or within the user feedback unit in accord with the motion properties (direction, velocity, acceleration, and changes of one or more of these properties) toward a selectable object or a group of selectable objects or a pre-selected object or a group of pre-selected objects, zones or areas. At the same time, the methods either move the non-selected objects away from the selection object(s), cause the non-selected object to fade, disappear or other change other properties of the non-selected objects, or combinations thereof. The pre-selected object or the group of pre selected objects are the selectable object(s) that are most closely aligned with the direction of motion of the selection object.

Another aspect of the methods of this disclosure is that movement towards an executable area, such as a close/expand/maximize/minimize function area(s) or object(s) of a software window in an upper right corner may cause an executable function(s) to occur, such as causing the object(s) to expand or move apart so as to provide more space between them and to make it easier to select each individual object or a group of objects.

Another aspect of the methods of this disclosure include interfaces is that object selection or menu selection may be grouped together such that as movement is made towards a group of objects, the group of objects simultaneous rearrange themselves so as to make individual object selection or menu selection easier, including moving arcuately or to corners of a designated area so as to make discrimination of the desired selection easier.

Another aspect of the interface is that proximity to the selection object may cause the selectable objects, zones or areas most aligned with the properties of the sensed motion to expand, separate, or otherwise move in such a way so as to make object discrimination easier, which in turn may cause associated subobjects or submenus to be able to be selected by moving the subobjects or submenus towards the selection object. Additionally, they could be selected or activated by moving into an active area designated by distance, area or volume from or around such objects, thereby selecting the object functions, menus or subobjects or submenus. The movement or attribute change of the subobjects or submenus may occur synchronously or asynchronously with the movement of the primary object(s).

Another aspect of the interfaces is that the faster the selection object moves toward the pre selected object or the group of preselected objects, the faster the pre-selected object or the group of preselected objects move toward the selection object(s), and/or the faster the unselected objects may move away from the selection object(s). Of course, any differentiation of direction may be used, where the unselected objects move towards the user and the preselected objects move away.

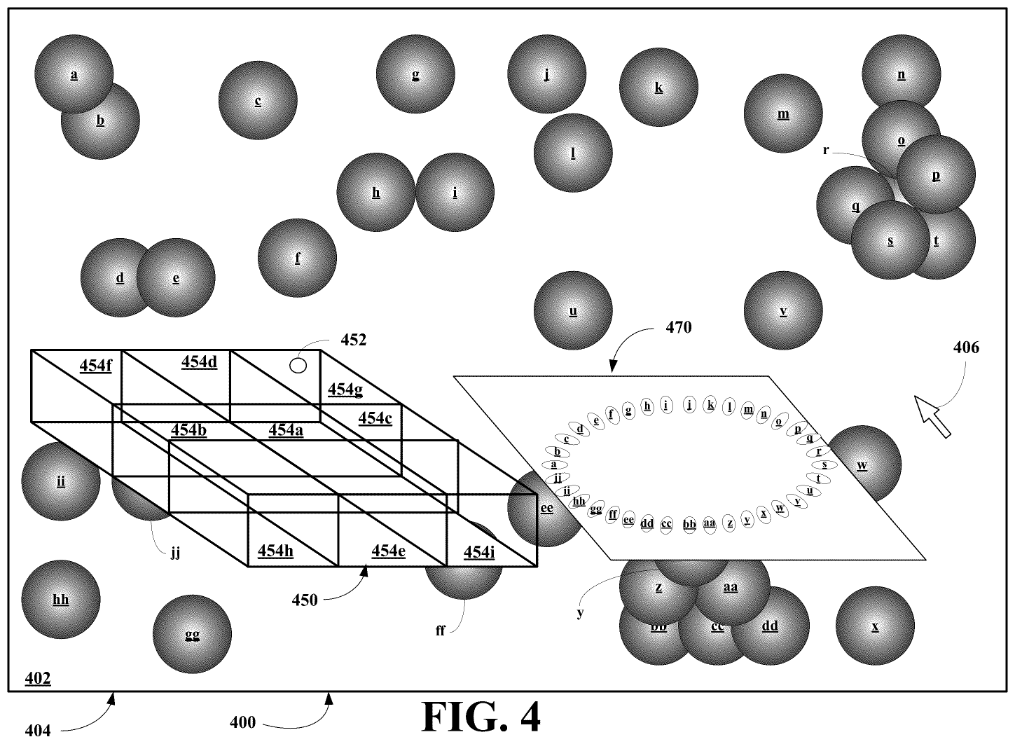

Another aspect of the interfaces is that as the pre-selected (meaning the objects that are most closely aligned with the properties of the motion) object or the group of pre-selected objects move toward the selection object, the pre-selected object or the group of pre-selected objects may either increase in size, change color, become highlighted, change some other effect, change some characteristic or attribute, or a combination thereof. These same, similar or opposite changes may occur to the unselected objects or unselected group of objects. Another aspect is that, based upon a user's previous choices, habits, motions or predicted motions, the attributes of the objects may be changed such that they move faster, increase in size or zone, or change in such a way that the object with the highest percentage of user intent is the easiest and most likely to be selected as shown in FIGS. 4A-D and described in the associated text below.

Another aspect of the interfaces is that as motion continues, the motion will start to discriminate between members of the group of pre-selected object until the motion results in the selection of a single selectable or displayed object or a single group of selectable objects, or zone or group of zones, or any combination(s) of these. Once the selection object and a selectable object active area touch or the selection object and a selectable display object is predicted with a threshold degree of certainty, a triggering threshold event (this maybe the distance of proximity or probability without ever touching), the selectable object is selected and non-selected object are removed from the display or fade away or become less prominent or change in such a way that they are recognizable as non-selected object(s). Once selected, the selected object may become centered within the display or at a predetermined position within the display. If the selected object has a single adjustable attribute, then motion may adjust the attribute a desired or pre-defined amount. If the selected object is executable, then the selected object is invoked. If the selected object is an attribute or selection command, then the attribute may be adjusted by additional motion or the selection may invoke a command function. Of course, the systems may do all or any combination of these processes. If the object is an executable object such as taking a photo, turning on a device, etc., then the execution is simultaneous or acts in a predetermined way with the selection. If the object is a submenu, sublist or list of attributes associated with the selected object, then the submenu members, sublist members or attributes are displayed on the screen in a spaced apart format or appear as the selection becomes more certain and then persist once selection is certain or confirmed, and may be displayed at one or more levels, and any or all synchronously, asynchronously or simultaneously. The same procedure used to select the selected object is then used to select a member of the submenu, a member of the sublist or a particular attribute. Thus, the interfaces have a gravity like action on displayed selectable objects that move them toward the selection objection as certainty increases. As the selection object moves, it attracts an object or objects in alignment or relation with the properties of the sensed motions (direction, speed, acceleration, or changes in any of these primary properties) of the selection object pulling the object(s) meeting this criterion toward the selection object. Simultaneously, synchronously or asynchronously, submenus or subobjects may become visible if they were not so to begin with and may also move or change in relation to the movement or changes of the selected objects. Simultaneously, synchronously, or asynchronously, the non-selected objects may move or change away from the selection object(s). As motion continues, the pull increases on the object most aligned with the properties (e.g., direction) of motion or movement, further moving or accelerating the object toward the selection object until they touch, merge, or reach a triggering event—close enough to touch an active area or to predicted the selection to a threshold certainty. The touch, merge, or triggering event causes the processing unit to select and activate the object. The object(s) may also be defined as an area in between objects, giving a gate-like effect to provide selection of sub-menu or sub-objects that are aligned with the motion of the selection object and are located between, behind, or at the same angle but a different distance than this gate. Furthermore, a back object or area may be incorporated to undo or reverse effects or changes or motions that have occurred to objects, whether selectable or not.

Embodiments of this disclosure provide Embodiments of this disclosure relate to systems and methods implements on a processing unit or distributed network of processing units, where the systems include at least one processing unit, at least one motion sensor, at least one user interface, and dynamic environment software and methods include software steps to implement the software systems on the processing units, where the dynamic environment software produces dynamic environments for object and attribute display, manipulation, and/or interaction.

More particularly, this disclosure relate to systems and methods implements on a processing unit or distributed network of processing units, where the systems include at least one processing unit, at least one motion sensor or at least one sensor output, at least one user interface, and dynamic environment software and methods include software steps to implement the software systems on the processing units, where the dynamic environment software produces dynamic environments for object and attribute display, manipulation, and/or interaction, where the dynamic environment software produces dynamic environments for object and attribute display, manipulation, and/or interaction, where the dynamic environments are produced by the dynamic environment software and include a plurality of objects and associated attributes so that the objects and/or attributes are highlighted and/or differentiated one from the other, where the highlighting may evidence priority, directionality, content, type, activation procedures, activation parameters, control features, or other properties that are associated with the objects and/or attributes and motion sensed by the motion sensors in electronic communication with the processing units permit manipulation and/or interaction with the elements of the dynamic environments either causing the environment to change in response to the sensed motion or causing object and/or attribution selection and/or activation.

### Control Constructs Viewable Through Eye Tracking Glasses

Embodiments of this disclosure broadly relate to methods including displaying, via a processing unit, a virtual reality (VR), augmented reality (AR), or a mixed reality (MR) environment including a plurality of objects, a plurality of scenes, and/or a plurality of attributes associated with the environment and/or objects or scenes on a display device in communication with processing unit. The methods also include viewing, via the processing unit, the environment through eye tracking glasses in communication with the processing unit and superimposing, in or on the environment via the processing unit, an interactive control construct including a plurality active control areas. The methods also include displaying, via the processing unit, a selection object for visualizing eye movement from the glasses in the environment or in or on the control construct, sensing eye movement via the glasses and moving the selection object correspondingly, and if the movement is on or in a particular active control area of the construct, then converting the movement into a construct function associated with the particular active control area of the construct or if the movement is on or in the environment, then converting the movement into a selection and/or activation function of a particular object or a selection, activation, and/or attribute function of the environment.

In certain embodiments, the methods further include repeating the sensing and if steps, until an exit or stop command is selected. In other embodiments, the methods also include prior to the environment displaying step, sensing a first eye movement, wherein the first movement includes at least one property exceeding a threshold value. In other embodiments, the control areas comprise a fast forward movement area, a no movement area, a backward movement area, a pan left area, a pan right area, and a no pan area, wherein each area has a corresponding movement function or a corresponding panning function associated therewith. In other embodiments, the control areas comprise a plurality of bands, each of the bands having a plurality of regions. In other embodiments, the bands comprise a fast forward band, a slow forward band, a stop or no motion band, a fast backward band, and a slow forward band, wherein each band has a corresponding movement function associated therewith, and the regions comprise a pan left region, a pan right region and a no pan region interposed therebetween, wherein each band has a corresponding panning function associated therewith. In certain embodiments, the methods further include sensing eye movement via the glasses and moving the selection object correspondingly, if the movement is on or in a particular band and a particular region of the particular band, then converting the movement into the corresponding movement function and panning function and moving through the environment accordingly or if the movement is on or in the environment, then converting the movement into a selection and/or activation function of a particular object or a selection, activation, and/or attribute function of the environment. In certain embodiments, the methods further include prior to the if steps, confirming the selection of the particular area of the construct, or confirming the selection of the object or attribute in the environment.

Embodiments of this disclosure broadly relate to apparatuses including a display device, an input device, eye tracking glasses, and a processor in communication with the display device, the glasses and the input device. The processor is configured to (a) display a virtual reality (VR), augmented reality (AR), or a mixed reality (MR) environment including a plurality of objects, a plurality of scenes, and/or a plurality of attributes associated with the environment, objects and/or scenes on the display device, (b) initiate the glasses to view the environment, (c) superimpose, in or on the environment, an interactive control construct including a plurality active control areas viewable through the glasses, (c) display a selection object for visualizing eye movement from the glasses in or on the environment or in or on the control construct, (d) sense eye movement via the glasses and moving the selection object correspondingly, and (e) if the movement is on or in a particular active control area of the construct, then converting the movement into a function associated with the particular active control area of the construct; or if the movement is on or in the environment, then converting the movement into a selection and/or activation function of a particular object or a selection, activation, and/or attribute adjustment function of a particular attribute of the particular object or of the environment.

In certain embodiments, the process is further configured to prior to the environment display, sense a first movement from the glasses or from the input device, wherein the first movement includes at least one movement property exceeding a threshold value. In other embodiments, the device comprises a mobile device including the display device, the input device, and the processing unit. In other embodiments, the device comprises a mobile device including the display device, the input device, and the processing unit. In other embodiments, the display device comprises a touchscreen and the input device is a motion sensor. In other embodiments, the mobile device comprises a cell phone, a wearable device, a tablet computer, or a laptop computer.

### Eye Tracking Methods and Apparatuses for Controlling Icons

Embodiments of this disclosure broadly relate to methods including displaying, via a processing unit, a plurality of icon on a display device in communication with the processing unit. The methods also include sensing, via the processing unit, eye movement via eye tracking glasses in communication with the processing unit, where the movement is discernibly towards a particular icon and expanding, via the processing unit, the particular icon. The methods also include activating, via the processing unit, the particular icon once the movement enters the particular icon and displaying, via the processing unit, one or a plurality of attribute icons associated with the particular icon. The methods also include sensing, via the processing unit, further eye movement via the glasses discernibly towards a particular attribute icon, selecting and activating the particular attribute icon and if the particular attribute icon is adjustable, sensing further eye movement via the glasses to adjust the attribute value.

In certain embodiments, the methods further include repeating the steps. In other embodiments, the methods further include prior to the displaying icon step, sensing a first eye movement, wherein the first movement includes at least one property exceeding a threshold value. In other embodiments, the expanding step further includes displaying a confirmation icon within the expanded particular icon and the activating step comprises sensing eye movement via the glasses towards the confirmation icon and activating the particular icon when the movement stop for a microhold over the confirmation icon. In other embodiments, the activating step further includes a microhold over the particular icon. In other embodiments, the selecting and activating the particular attribute icon step further includes a microhold over the particular attribute icon. In other embodiments, the selecting and activating the particular attribute icon step further includes expanding the particular attribute icon and displaying a confirmation icon within an expanded particular icon and the activating step comprises sensing eye movement via the glasses towards the confirmation icon, selecting and activating the particular attribute icon, and if the particular attribute icon is adjustable, sensing further eye movement via the glasses to adjust the attribute value.

Embodiments of this disclosure broadly relate to apparatuses including a display device, an input device, eye tracking glasses, and a processor, in communication with the display device, the glasses and the input device. The processor is configured to (a) display a plurality of icon on a display device in communication with the processing unit, (b) sense eye movement via eye tracking glasses, where the movement is discernibly towards a particular icon, (c) expand the particular icon, (d) activate the particular icon once the movement enters the particular icon, (e) display one or a plurality of attribute icons associated with the particular icon, (f) sense further eye movement via the glasses discernibly towards a particular attribute icon, (g) select and activate the particular attribute icon, (h) if the particular attribute icon is adjustable, sense further eye movement via the glasses to adjust the attribute value.

In certain embodiments, the processor is further configured to repeat the display, sense, expand, activate, display, select and activate and attribute adjust. In other embodiments, the processor is further configured to prior to the display icons, sense a first eye movement, wherein the first movement includes at least one property exceeding a threshold value. In other embodiments, the expand further includes display of a confirmation icon within the expanded particular icon and the activate comprises sense eye movement via the glasses towards the confirmation icon and activate the particular icon when the movement stop for a microhold over the confirmation icon. In other embodiments, the activate further includes a microhold over the particular icon. In other embodiments, the select and activate the particular attribute icon step further includes a microhold over the particular attribute icon. In other embodiments, In other embodiments, the select and activate the particular attribute icon step further includes expand the particular attribute icon and display a confirmation icon within an expanded particular icon, and the activate comprises sense eye movement via the glasses towards the confirmation icon, select and activate the particular attribute icon, and if the particular attribute icon is adjustable, sense further eye movement via the glasses to adjust the attribute value.

### Training Methods and Apparatuses Using Computer Generated Constructs

Embodiments of this disclosure broadly relate to methods including (a) capturing, via a processing unit, trainee images or a trainee image sequence and trainer images and/or a trainer image sequence from at least one motion sensor corresponding to a specific task; (b) constructing, via the processing unit, constructs of the trainee images or the trainee image sequence and constructs of the trainer images or the trainer image sequence on an image by image basis and on a feature by feature basis; (c) scaling, via the processing unit, the trainee and/or trainer constructs on an image by image and on a feature by feature basis so that the constructs are spatially and temporally conformed; (d) comparing, via the processing unit, the scaled constructs on an image by image basis and on a feature by feature basis; (e) determining, via the processing unit, differences between the scaled constructs on an image by image basis and on a feature by feature basis; (f) overlaying, via the processing unit, the scaled trainee construct onto the scaled trainer construct on an image by image basis; and (g) displaying, via the processing unit, the overlaid constructs on an image by image basis on a display device in communication with the processing unit.

In certain embodiments, the methods further include (h) highlighting, via the processing unit, the differences on an image by image basis and on a feature by feature basis on the display device. In other embodiments, the methods further include (i) repeating the steps (a)-(h) until a stop function is invoked to stop the training exercise or the differences satisfy at least one completion criteria. In other embodiments, the at least one completion criteria comprises conformity or substantially conformity between the trainee scaled construct and the trainer scaled construct on an image by image basis or the at least one completion criteria comprise minimizing one, some or all of differences as evidenced by changes in the differences upon repeating the exercise being less than a minimal value, where the minimal value is less than or equal to a 5%, less than or equal to a 2.5%, less than or equal to a 2%, or less than or equal to a 1%. In other embodiments, the start and stop functions may be activated by motion based processing, gesture based processing or a hard select processing.

Embodiments of this disclosure broadly relate to apparatuses including a display device, an image capture device, an input device, an interface, and a processor. The interface is configured to capture trainee images or a trainee image sequence from the image capture device and trainer images or a trainer image sequence from the image capture device and receive input from the input device to invoke a start function or a stop function. The processor is configured to construct a trainee image by image construct and a trainer image by image construct; scale the trainee image by image construct and/or trainer image by image construct so that the constructs are conformed spatially and temporally; compare the scaled constructs on an image by image basis; determine differences between the scaled constructs on an image by image basis; overlay the scaled trainee construct onto the scaled trainer construct on an image by image basis; and display the overlaid constructs on an image by image basis.

In certain embodiments, the processor is further configured to highlight the differences on an image by image basis and a feature by feature basis. In other embodiments, the processor is further configured to repeat the construct, scale, compare, determine, overlay and display events until the a stop function is invoked to stop the training exercise or the differences satisfy at least one completion criteria. In other embodiments, the at least one completion criteria comprises conformity or substantially conformity between the trainee scaled construct and the trainer scaled construct on an image by image basis or the at least one completion criteria comprise minimizing one, some or all of differences as evidenced by changes in the differences upon repeating the exercise being less than a minimal value, where the minimal value is less than or equal to a 5%, less than or equal to a 2.5%, less than or equal to a 2%, or less than or equal to a 1%. In other embodiments, the start and stop functions may be activated by motion based processing, gesture based processing or a hard select processing.

### Suitable Components for Use in the Disclosure

### Motion Sensors

Suitable motion sensors include, without limitation, optical sensors, acoustic sensors, thermal sensors, optoacoustic sensors, wave form sensors, pixel differentiators, or any other sensor or combination of sensors that are capable of sensing movement or changes in movement, or mixtures and combinations thereof. Suitable motion sensing apparatus include, without limitation, motion sensors of any form such as digital cameras, optical scanners, optical roller ball devices, touch pads, inductive pads, capacitive pads, holographic devices, laser tracking devices, thermal devices, electromagnetic field (EMF) sensors, wave form sensors, any other device capable of sensing motion, changes in EMF, changes in a wave form, or the like or arrays of such devices or mixtures or combinations thereof. The sensors may be digital, analog, or a combination of digital and analog. The motion sensors may be touch pads, touchless pads, touch sensors, touchless sensors, inductive sensors, capacitive sensors, optical sensors, acoustic sensors, thermal sensors, optoacoustic sensors, electromagnetic field (EMF) sensors, strain gauges, accelerometers, pulse or waveform sensor, any other sensor that senses movement or changes in movement, or mixtures and combinations thereof. The sensors may be digital, analog, or a combination of digital and analog or any other type. For camera systems, the systems may sense motion within a zone, area, or volume in front of the lens or a plurality of lens. Optical sensors include any sensor using electromagnetic waves to detect movement or motion within in active zone. The optical sensors may operate in any region of the electromagnetic spectrum including, without limitation, radio frequency (RF), microwave, near infrared (IR), IR, far IR, visible, ultra violet (UV), or mixtures and combinations thereof. Exemplary optical sensors include, without limitation, camera systems, the systems may sense motion within a zone, area or volume in front of the lens. Acoustic sensor may operate over the entire sonic range which includes the human audio range, animal audio ranges, other ranges capable of being sensed by devices, or mixtures and combinations thereof. EMF sensors may be used and operate in any frequency range of the electromagnetic spectrum or any waveform or field sensing device that are capable of discerning motion with a given electromagnetic field (EMF), any other field, or combination thereof. Moreover, LCD screen(s), other screens and/or displays may be incorporated to identify which devices are chosen or the temperature setting, etc. Moreover, the interface may project a virtual control surface and sense motion within the projected image and invoke actions based on the sensed motion. The motion sensor associated with the interfaces of this disclosure may also be acoustic motion sensor using any acceptable region of the sound spectrum. A volume of a liquid or gas, where a user's body part or object under the control of a user may be immersed, may be used, where sensors associated with the liquid or gas can discern motion. Any sensor being able to discern differences in transverse, longitudinal, pulse, compression or any other waveform may be used to discern motion and any sensor measuring gravitational, magnetic, electro-magnetic, or electrical changes relating to motion or contact while moving (resistive and capacitive screens) could be used. Of course, the interfaces can include mixtures or combinations of any known or yet to be invented motion sensors. The motion sensors may be used in conjunction with displays, keyboards, touch pads, touchless pads, sensors of any type, or other devices associated with a computer, a notebook computer or a drawing tablet or any mobile or stationary device, and/or device, head worn device, or stationary device.

Suitable motion sensing apparatus include, without limitation, motion sensors of any form such as digital cameras, optical scanners, optical roller ball devices, touch pads, inductive pads, capacitive pads, holographic devices, laser tracking devices, thermal devices, EMF sensors, wave form sensors, MEMS sensors, any other device capable of sensing motion, changes in EMF, changes in wave form, or the like or arrays of such devices or mixtures or combinations thereof. Other motion sensors that sense changes in pressure, in stress and strain (strain gauges), changes in surface coverage measured by sensors that measure surface area or changes in surface are coverage, change in acceleration measured by accelerometers, or any other sensor that measures changes in force, pressure, velocity, volume, gravity, acceleration, any other force sensor or mixtures and combinations thereof.

### Controllable Objects

Suitable physical mechanical, electro-mechanical, magnetic, electro-magnetic, electrical, or electronic devices, hardware devices, appliances, biometric devices, automotive devices, VR objects, AR objects, MR objects, and/or any other real world device and/or virtual object that may be controlled by a processing unit include, without limitation, any electrical and/or hardware device or appliance or VR object that may or may not have attributes, all of which may be controlled by a switch, a joy stick, a stick controller, other similar type controller, and/or software programs or objects. Exemplary examples of such attributes include, without limitation, ON, OFF, intensity and/or amplitude, impedance, capacitance, inductance, software attributes, lists, submenus, layers, sublayers, other leveling formats associated with software programs, objects, haptics, any other controllable electrical and/or electro-mechanical function and/or attribute of the device and/or mixtures or combinations thereof. Exemplary examples of devices include, without limitation, environmental controls, building systems and controls, lighting devices such as indoor and/or outdoor lights or light fixtures, cameras, ovens (conventional, convection, microwave, and/or etc.), dishwashers, stoves, sound systems, mobile devices, display systems (TVs, VCRs, DVDs, cable boxes, satellite boxes, and/or etc.), alarm systems, control systems, air conditioning systems (air conditions and heaters), energy management systems, medical devices, vehicles, robots, robotic control systems, UAVs, equipment and machinery control systems, hot and cold water supply devices, air conditioning system, heating systems, fuel delivery systems, energy management systems, product delivery systems, ventilation systems, air handling systems, computers and computer systems, chemical plant control systems, manufacturing plant control systems, computer operating systems and other software systems, programs, routines, objects, and/or elements, remote control systems, or the like virtual and augmented reality systems, holograms, and/or mixtures or combinations thereof.

### Software Systems

Suitable software systems, software products, and/or software objects that are amenable to control by the interface of this disclosure include, without limitation, any analog or digital processing unit or units having single or a plurality of software products installed thereon and where each software product has one or more adjustable attributes associated therewith, or singular software programs or systems with one or more adjustable attributes, menus, lists, or other functions, attributes, and/or characteristics, and/or display outputs. Exemplary examples of such software products include, without limitation, operating systems, graphics systems, business software systems, word processor systems, business systems, online merchandising, online merchandising systems, purchasing and business transaction systems, databases, software programs and applications, internet browsers, accounting systems, military systems, control systems, VR, AR, MR systems or the like, or mixtures or combinations thereof. Software objects generally refer to all components within a software system or product that are controllable by at least one processing unit.

### Processing Units

Suitable processing units for use in the present disclosure include, without limitation, digital processing units (DPUs), analog processing units (APUs), Field Programmable Gate Arrays (FPGAs), any other technology that may receive motion sensor output and generate command and/or control functions for objects under the control of the processing unit, and/or mixtures and combinations thereof.

Suitable digital processing units (DPUs) include, without limitation, any digital processing unit capable of accepting input from a plurality of devices and converting at least some of the input into output designed to select and/or control attributes of one or more of the devices. Exemplary examples of such DPUs include, without limitation, microprocessor, microcontrollers, or the like manufactured by Intel, Motorola, Ericsson, HP, Samsung, Hitachi, NRC, Applied Materials, AMD, Cyrix, Sun Microsystem, Philips, National Semiconductor, Qualcomm, or any other manufacture of microprocessors or microcontrollers, and/or mixtures or combinations thereof.

Suitable analog processing units (APUs) include, without limitation, any analog processing unit capable of accepting input from a plurality of devices and converting at least some of the input into output designed to control attributes of one or more of the devices. Such analog devices are available from manufacturers such as Analog Devices Inc.

### User Feedback Units

Suitable user feedback units include, without limitation, cathode ray tubes, liquid crystal displays, light emitting diode displays, organic light emitting diode displays, plasma displays, touch screens, touch sensitive input/output devices, audio input/output devices, audio-visual input/output devices, holographic displays and environments, keyboard input devices, mouse input devices, optical input devices, and any other input and/or output device that permits a user to receive user intended inputs and generated output signals, and/or create input signals.

### Detailed Description of the Drawings of the Disclosure

Interacting with nD Environments Using Multiple User Feedback Devices

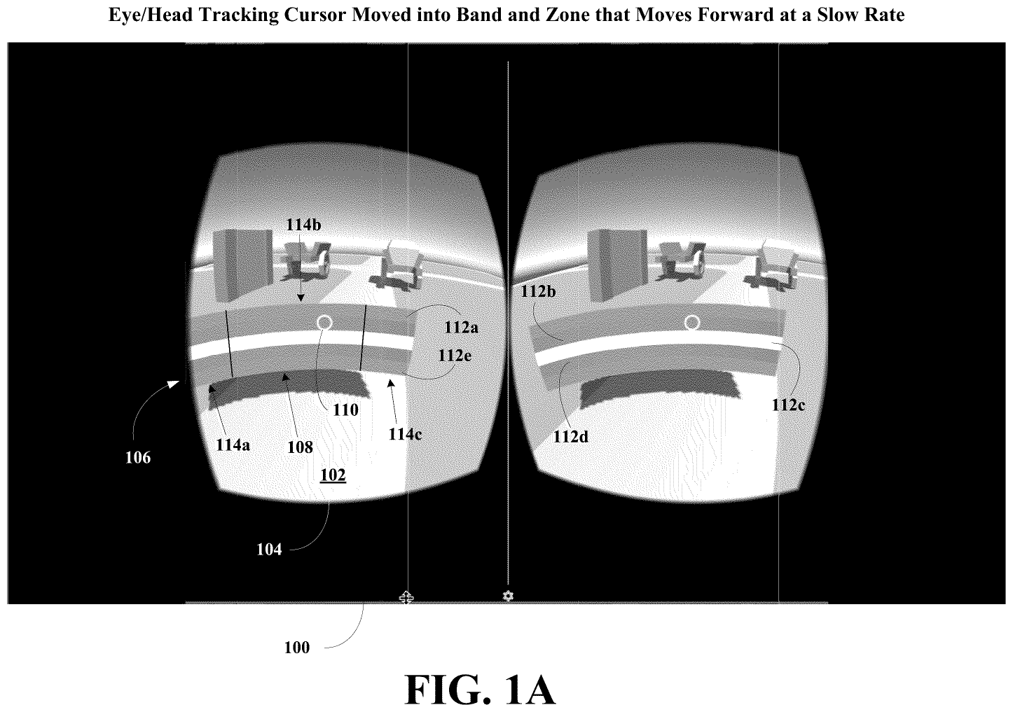

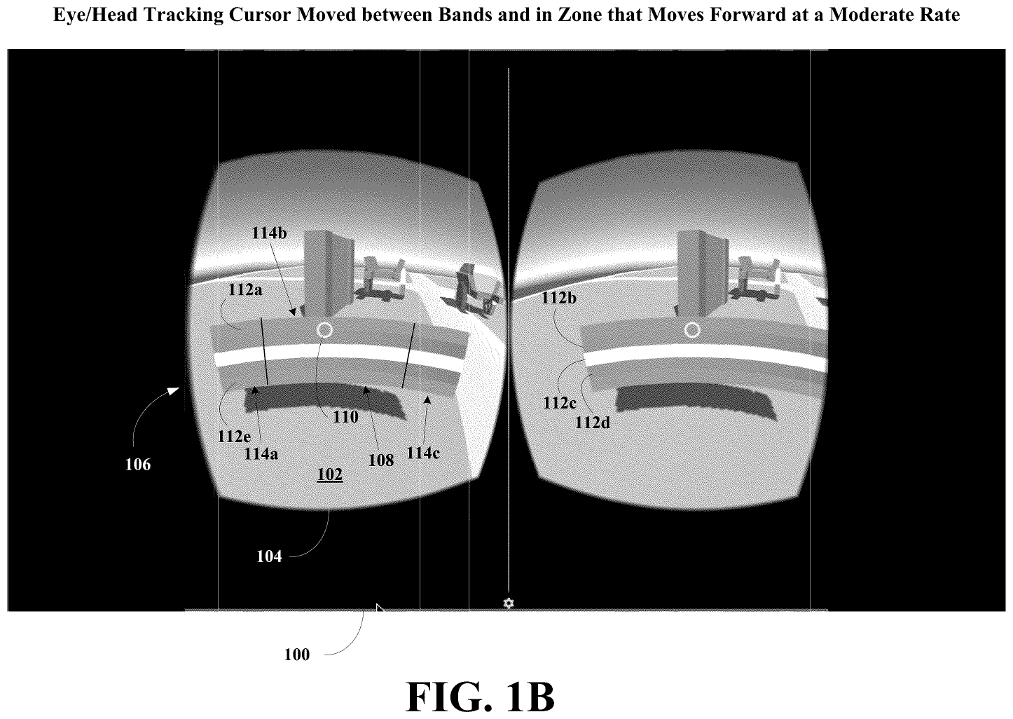

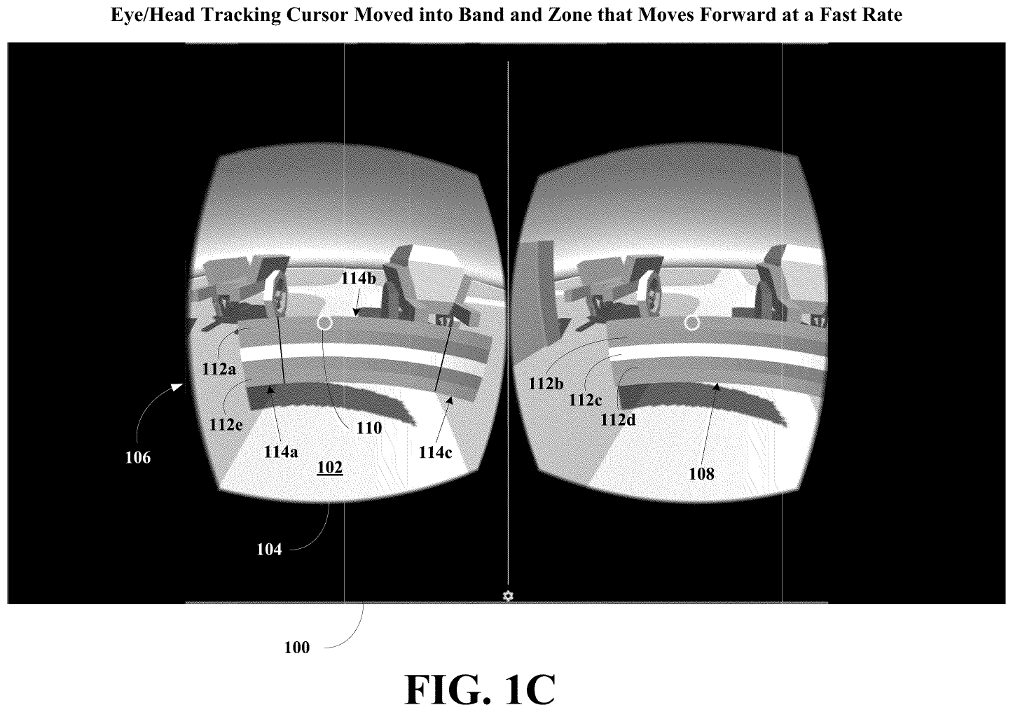

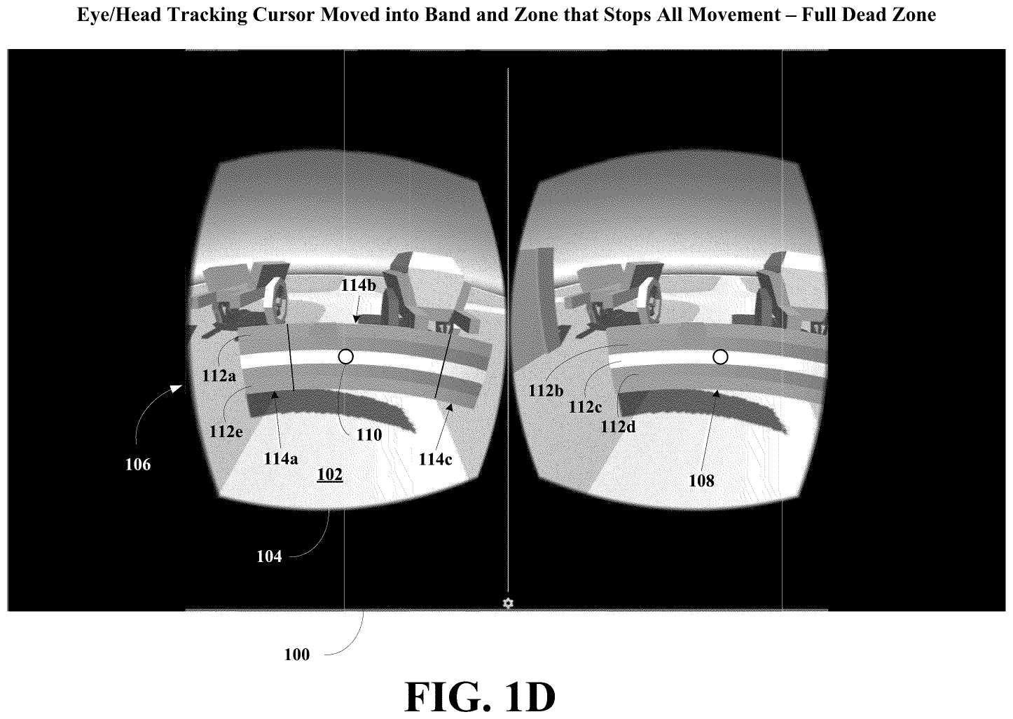

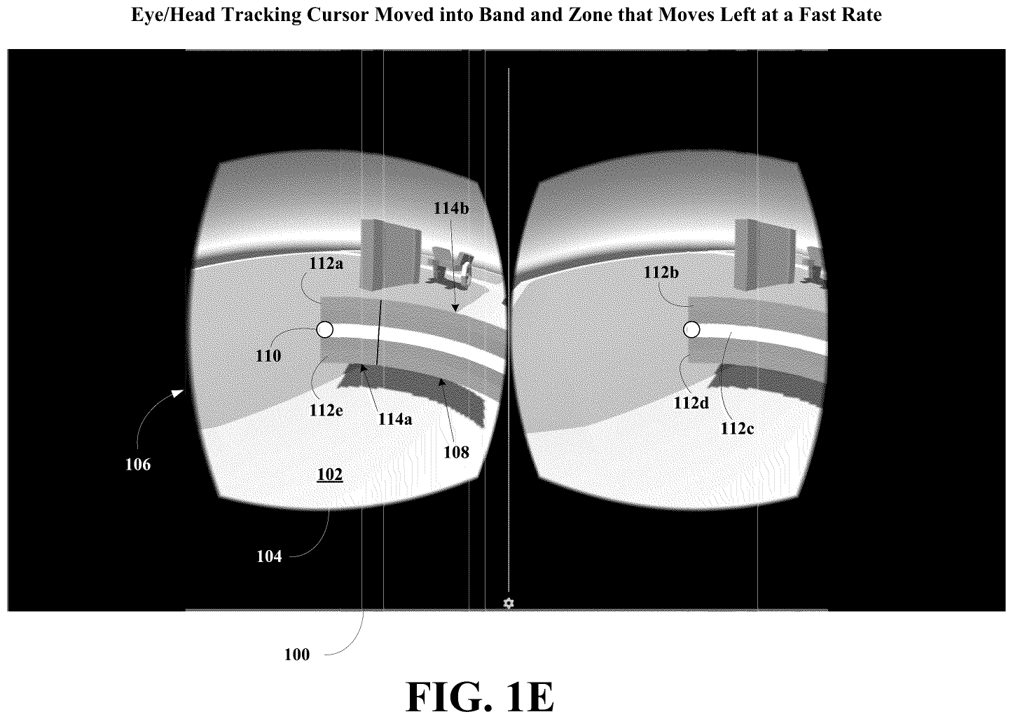

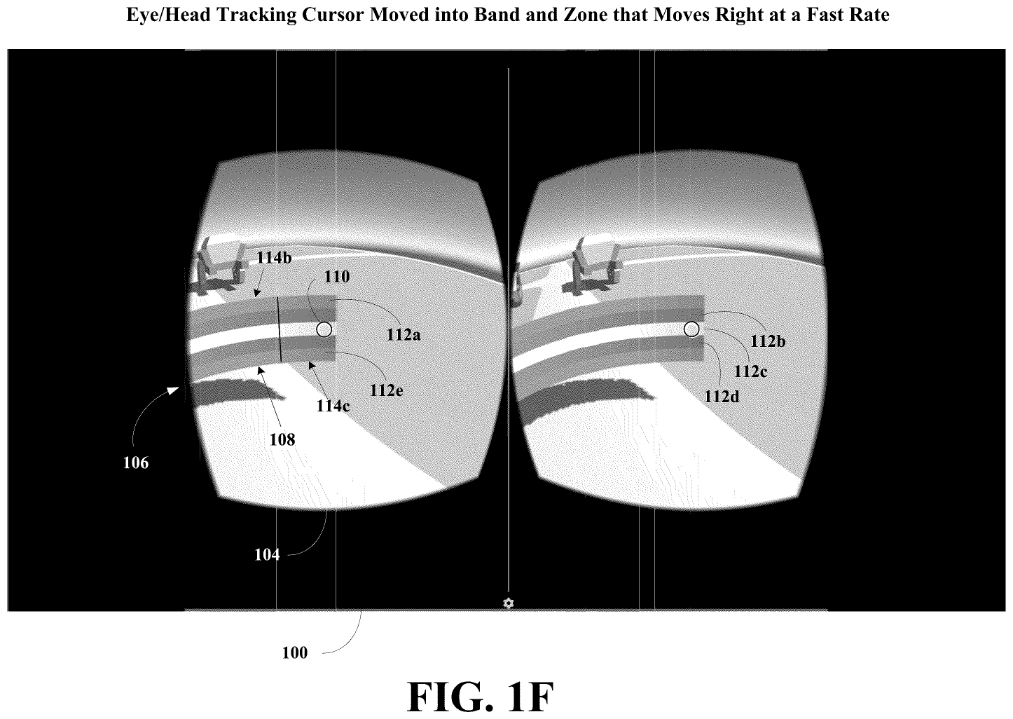

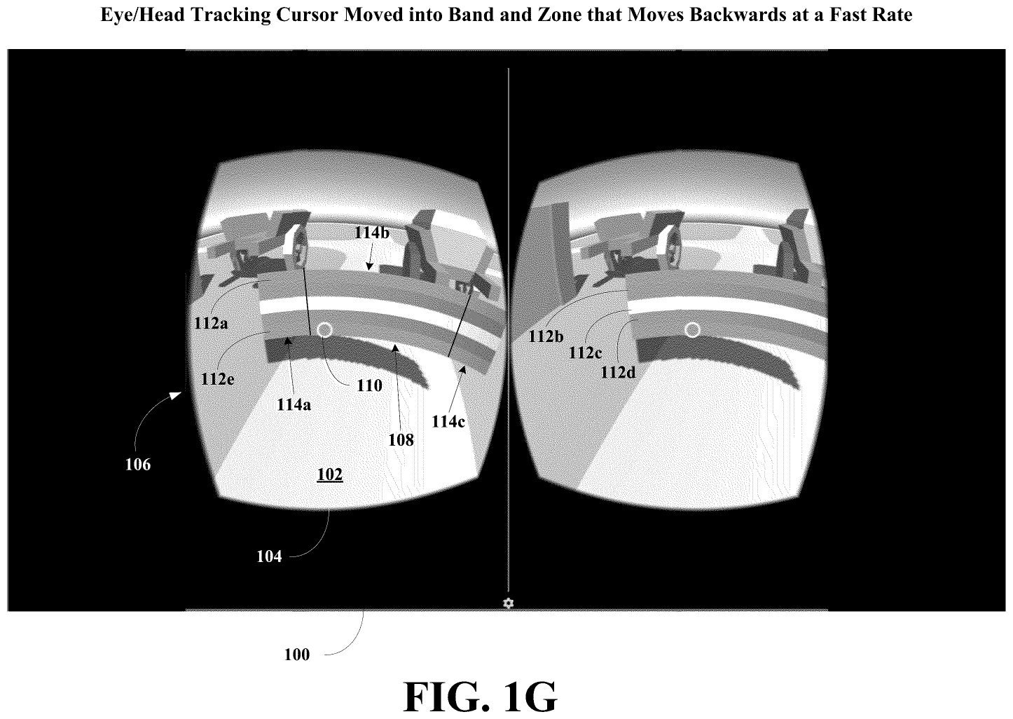

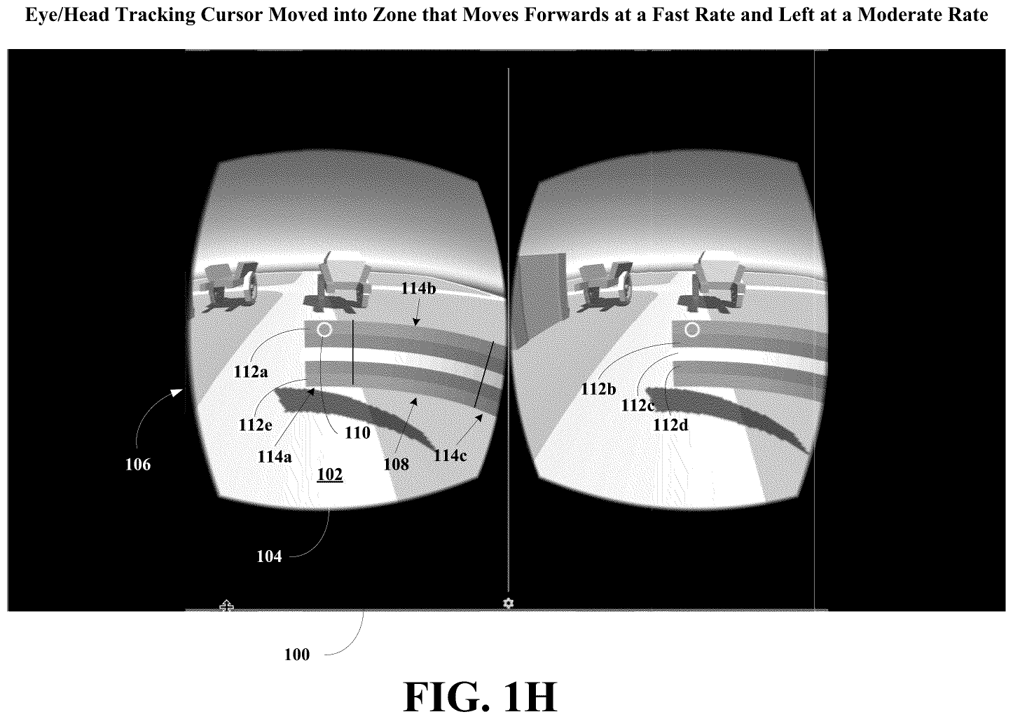

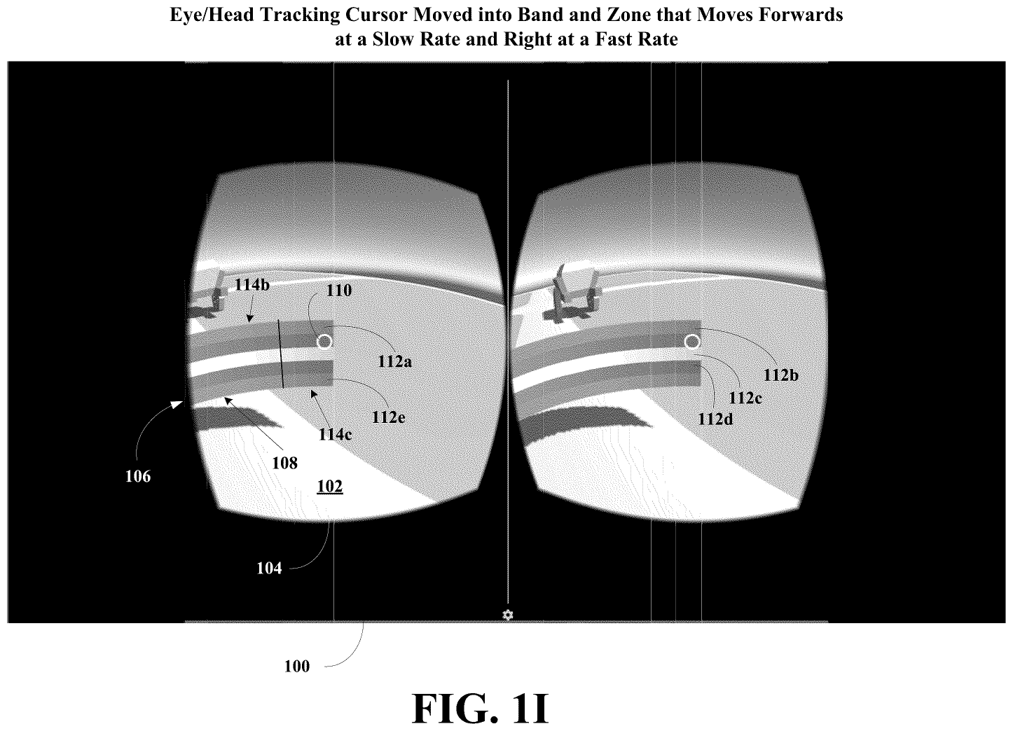

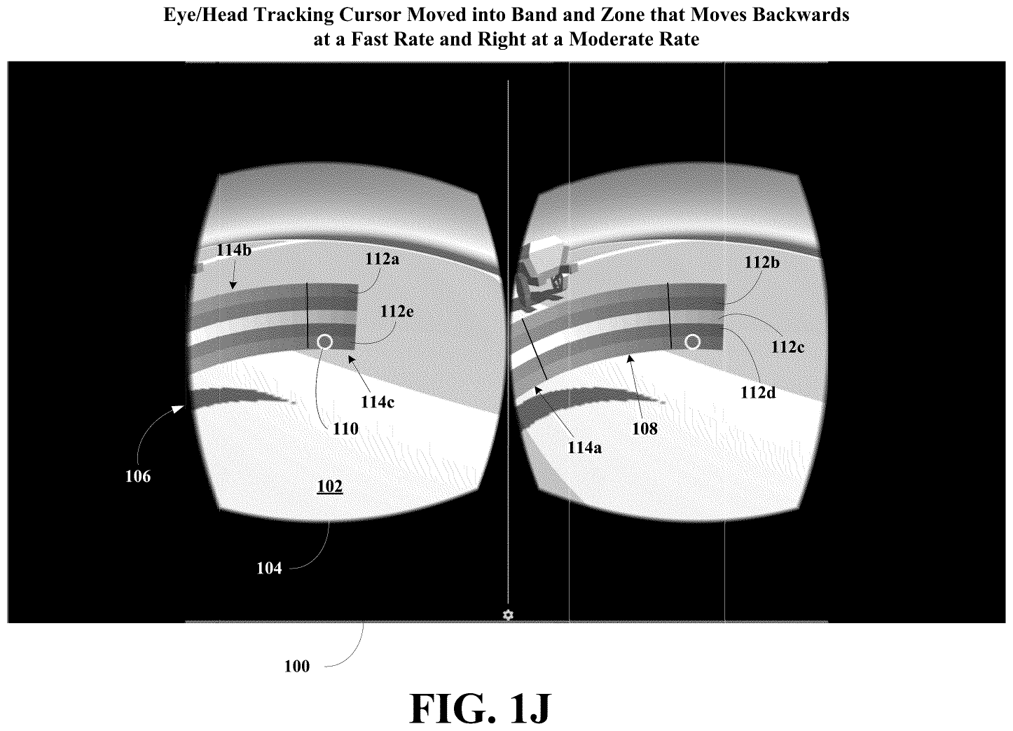

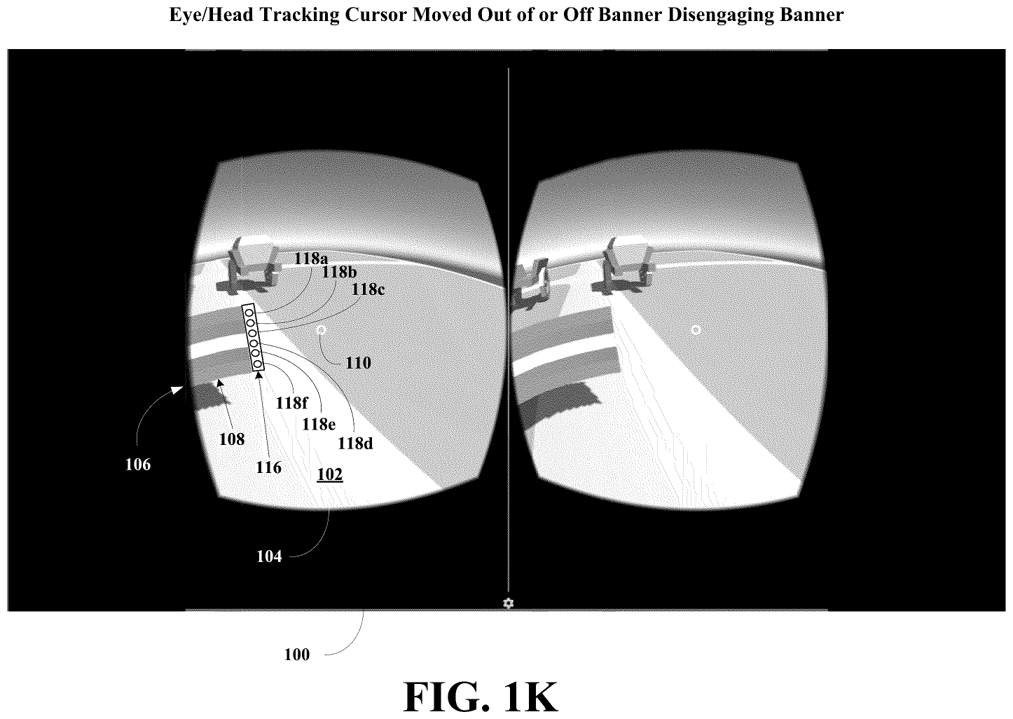

Referring now to FIGS. 1A-K, an embodiment of systems, apparatuses, and/or interfaces using two user feedback devices is shown in a sequence of screen shots involving a 3D environment displayed on a display device, the first user feedback device, and a virtual, interactive control feature viewable through eye/head-tracking glasses, the second user feedback device. The screen shots, images, or views are designated generally as 100 and are views of a 3D environment 102 displayed on a display device 104 as viewed through a pair of eye/head tracking glasses 106. The view 100 also includes a virtual interactive motion control area 108 superimposed on the view 100 and an eye/heading tracking cursor 110 also superimposed on the view 100. The area 108 include five bands 112a-e. The top and bottom bands 112a and 112e are shown in light green (color) or light gray (grayscale); the next two bands 112b and 112d are shown in darker green (color) or darker gray (grayscale); and the center band 112c is shown in white. Of course, the number of bands and regions may be more or less, but are generally independently between 1 and 7.

If the eye/head tracking cursor 110 is moved into the band 112a, the systems cause movement forward through the view 100 at a fast rate; if the eye/head tracking cursor 110 is moved into the band 112b, the systems cause movement forward through the view 100 at a slow rate; if the eye/head tracking cursor 110 is moved into the band 112c, the systems stop all movement through the view 100; if the eye/head tracking cursor 110 is moved into the band 112d, the systems cause movement backward through the view 100 at a slow rate; and if the eye/head tracking cursor 110 is moved into the band 112e, the systems cause movement backward through the view 100 at a fast rate. If the eye/head tracking cursor 110 is moved to a position where the bands 112a and 112b meet, the systems cause movement forward through the view 100 at a moderate rate; while if eye/head tracking cursor 110 is moved to a position where the bands 112d and 112e meet, the systems cause movement backward through the view 100 at a moderate rate.

The area 108 is also divided into three zones 114a-c, where the left zone 114a moves the view 100 to the left (pan left); the right zone 114c moves the view 100 to the right (pan right), and the middle zone 114b is a dead zone supporting no left to right movement (no panning). The left motion zone 114a is a relative zone so that the further to the left the eye/head tracking cursor 110 is positioned within the zone 114a, the faster the view moves left. Similarly, the right motion zone 114c is also a relative zone so that the further to the right the eye/head tracking cursor 110 is positioned within the zone 114c, the faster the view moves right.

In an alternate embodiment, the zones 114a and 114c may represent right and left rotational controls so moving the cursor 110 into the zone 114a would cause the system to rotate the view 100 about the current location counter clockwise, while moving the cursor 110 into the zone 114a would cause the system to rotate the view 100 about the current location clockwise. In other embodiments, the bands 112a-e may represent zoom in and zoom out controls instead of moving forwards or backwards within the 3D environment without changing the aspect ratio of the view.

In yet another embodiment, the area 108 may include an object area 116 including one or more control objects 118a-f as shown in FIG. 1K.

Looking at FIG. 1A, the view 100 is shown with the eye/head tracking cursor 110 located within the band 112b and the zone 114b, which causes the systems to move the view forward in the 3D environment at a slow rate as if the user were walking slowly towards the horizon. The zone 114b is a “dead” zone as it relates to right/left panning and/or right/left rotation depending on the control characteristics of the zones 114a&c. That is, moving the cursor 110 into the zone 114b in any of the bands 112a-e stops right/left panning and/or right/left rotation. Moreover, moving the cursor 110 into the area 112c and the zone 114b stops of the systems from performing any movement within the 3D environment.

Looking at FIG. 1B, the view 100 is shown with the eye/head tracking cursor 110 located within on the boundary between the bands 112a&b, which causes the systems to move the view forward in the 3D environment at a faster (moderate) rate as if the user were walking fast or jogging towards the horizon.

Looking at FIG. 1C, the view 100 is shown with the eye/head tracking cursor 110 located within the band 112a and the zone 114b, which causes the systems to move the view forward in the 3D environment at a fast rate as if the user were running towards the horizon.

Looking at FIG. 1D, the view 100 is shown with the eye/head tracking cursor 110 located on band 112a and in the zone 114c near the left edge of the area 108, which causes the systems to stop all movement—a complete dead zone.

Looking at FIG. 1E, the view 100 is shown with the eye/head tracking cursor 110 located on band 112a and in the zone 114a near the left edge of the area 108, which causes the systems to move left in the 3D environment at a fast rate—no forward or backward movement.

Looking at FIG. 1F, the view 100 is shown with the eye/head tracking cursor 110 located on band 112a and in the zone 114c near the right edge of the area 108, which causes the systems to move right in the 3D environment at a fast rate—no forward or backward movement.

Looking at FIG. 1G, the view 100 is shown with the eye/head tracking cursor 110 located within the band 112e and the zone 114b, which causes the systems to move the view backward in the 3D environment at a fast rate as if the user were running backward away from the horizon.

Looking at FIG. 1H, the view 100 is shown with the eye/head tracking cursor 110 located within the band 112a and the zone 114a, which causes the systems to move the view forward in the 3D environment at a fast rate and to the left at a moderate rate as if the user were running forward and to the left relative to the horizon—like moving north by northwest.

Looking at FIG. 1I, the view 100 is shown with the eye/head tracking cursor 110 located within the band 112b and the zone 114c, which causes the systems to move the view forward in the 3D environment at a slow rate and to the right at a fast rate as if the user were running forward and to the left relative to the horizon—like moving east by northeast.

Looking at FIG. 1J, the view 100 is shown with the eye/head tracking cursor 110 located within the band 112e and the zone 114c, which causes the systems to move the view backward in the 3D environment at a fast rate and to the left at a moderate rate as if the user were running backward and to the right relative to the horizon—like moving south by southeast.

Looking at FIG. 1K, at any time the user may disengage the area 108, where the view 100 is shown with the eye/head tracking cursor 110 located off the area 108, which causes the system to disengage the area 108. Once disengaged, the user may navigate through the 3D environment using a cursor associated with the display device or any other device for navigation and interacting with the 3D environment.

The area 108 here is shown to include the object area 116 including one or more control objects 118a-f. Thus, the object 118a may be a rotational control object, which switches the zones 114a and 114c are rotational zones, while the object 118b may be a panning object, which switches the zones 114a and 114c are panning. The object 118c may be a zoom control object, which switches the bands 112a-e to a zoom control, while the object 118d may be a forwards/backwards panning control, which switches the bands 112a-e to a panning control. The other control objects 118e-f may control different aspects of the banner 108 or may control aspects of the 3D environment itself. The area 116 may of course be associated with the banners of FIGS. 1A-J or may be a separate banner altogether.

It should also be recognized that the objects 118 within the area 116 may be selected using any of the selection methods disclosed in this disclosure. For example, by moving the cursor 110 into the area 116, the system may immediately invoke a scroll function that allows the user to scroll through the list of objects, with a change in one or more motion attributes causing the selection and activation of a particular object in the list or each object may be associated with a specific gesture or each object may be activated simply by positioning the cursor 110 on the object. Attraction and highlighting may also be used as well confirmatory movements or command—voice, wink, hand, etc.

It should also be recognized that the user may also use a display device cursor in tandem with the cursor 110 to control aspects of the 3D environment and in some embodiments, the display cursor may not only control aspects of the 3D environment, but may also interact with the banner 108. If the display cursor can also control the banner 108, then the systems may cause one cursor to be the dominate cursor, executing its movement preferentially or the systems may process both cursor movement in concert.

It should be also recognized that the banner may be screen locked (stays always with the glasses), relative world locked (moves with the change in the world view but at either a faster or slower rate or a delayed rate—catch up rate), or world locked (stays in the current zone or region of the 3D environment).

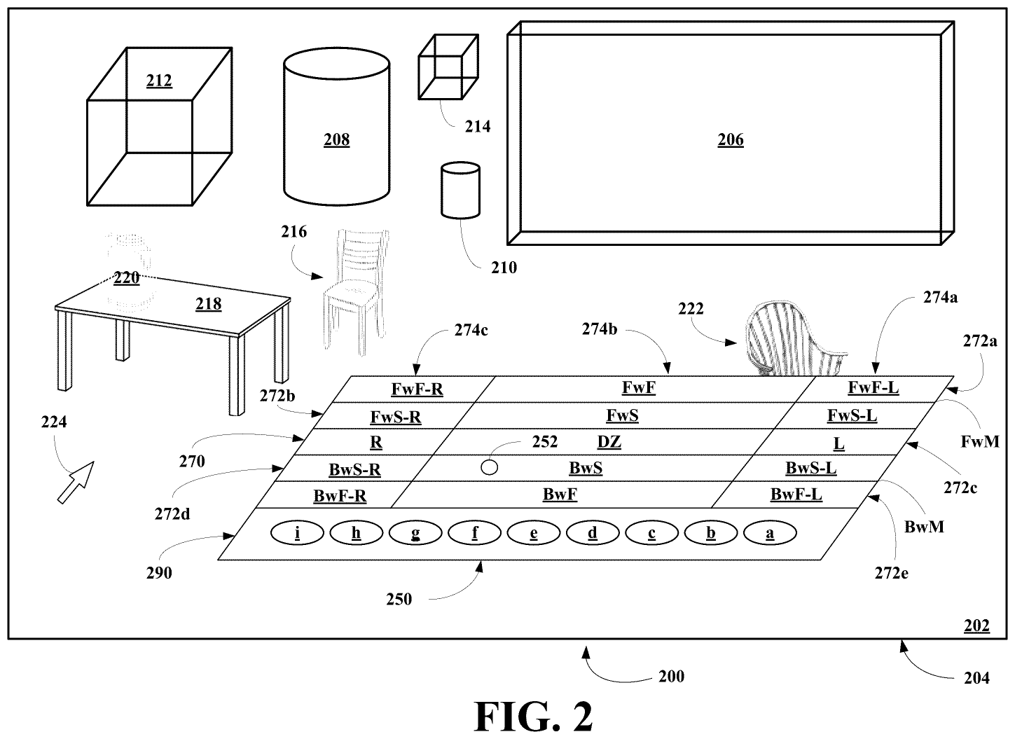

Referring now to FIG. 2, another embodiment of systems, apparatuses, and/or interfaces using two user feedback devices, generally as 200, is shown to include a 3D environment 202 displayed on a display device 204. The 3D environment 202 include a plurality of objects distributed throughout the 3D environment. Here, the objects include a wall type object 206, a large cylindrical type object 208, a small cylindrical type object 210, a large box type object 212, a small box type object 214, a table chair 216, a table 218, a tea pot 220, and a chair 222. The display device 204 also includes a display cursor 224. The entire 3D environment 202 is viewable through a pair of eye/head tracking glasses (not shown).

When viewed through the eye/head tracking glasses, a virtual interactive controller 250 appears superimposed on the environment 202 and an eye/heading tracking cursor 252 also appears superimposed on the environment 202. The controller 250 also include a motion control area 270 and a 3D environment object control area 290. The area 270 include five bands 272a-e. The bands 272a-e are divided into three zones 274a-c resulting in 15 subzones labeled from upper left to lower right with the following designations: FwF-L, FwS-L, L, BwS-L, BwF-L, FwF, FwS, DZ, BwS, BwF, FwF-R, FwS-R, L, BwS-R, and BwF-R. Fw means forward. Bw means backward. L means left and R means right.

The subzones FwF-L, FwS-L, L, BwS-L, BwF-L, FwF-R, FwS-R, L, BwS-R, and BwF-R are all relative zones. If the subzones FwF-L, FwS-L, L, BwS-L, BwF-L, FwF-R, FwS-R, L, BwS-R, and BwF-R are panning zones, then the closer the cursors 252 is to the left edge of the FwF-L, FwS-L, L, BwS-L, and BwF-L subzones or right edge of the FwF-R, FwS-R, L, BwS-R, and BwF-R subzones, the faster the systems pan left or right through the environment 202, while the closer to the zones FwF, FwS, DZ, BwS, or BwF, the slower the systems pans left or right through the environment 202. It should be recognized that positioning the cursors 224 and/or 252 within one of these subzones causes the systems to move left or right and simultaneously forward or backward at the indicated rate, a fate rate, a moderate rate, or a slow rate.

Alternatively, if the subzones are rotational subzones, then the closer to banner left edge or banner right edge, the faster the environment 202 rotates about the location of the cursors 224 and/or 252, while the closer to the FwF, FwS, DZ, BwS, and BwF subzones, the slower the rotation of the environment 202 about the location.

The FwF, FwS, DZ, BwS, or BwF subzones are not relative zones, but are zones that move forward or backward within the environment 202. The DZ subzone is a dead zone, meaning that locating the cursors 264 and/or 252 in this subzone causes the systems to stop all movement within the environment 202. Positioning the cursors 224 and/or 252 within the FwF subzone causes the systems to move the forward through the environment 202 at a fast rate, while positioning the cursors 224 and/or 252 within the BwF subzone causes the systems to move the backward through the environment 202 at a fast rate. Positioning the cursors 224 and/or 252 within the FwS subzone causes the systems to move the forward through the environment 202 at a slow rate, while positioning the cursors 224 and/or 252 within the BwS subzone causes the systems to move the backward through the environment 202 at a slow rate. Positioning the cursors 224 and/or 252 on the boundary of the FwF subzone and the FwS subzone causes the systems to move the forward through the environment 202 at a moderate rate, while positioning the cursors 224 and/or 252 on the boundary of the BwF subzone and the BwS subzone causes the systems to move the forward through the environment 202 at a moderate rate.

In other embodiments, the bands 272a-e may represent zoom in and zoom out controls instead of moving forwards or backwards within the 3D environment 202 without changing the aspect ratio of the view.

The 3D environment object control area 290 includes objects a through i, which corresponds to the objects in the 3D environment 202. Thus, the object a corresponds to the wall 206; the object b corresponds to the large cylinder 208; the object c corresponds to the small cylinder 210; the object d corresponds to the large box 212; the object e corresponds to the small box 214; the object f corresponds to the table chair 216; the object g corresponds to the table 218; the object h corresponds to the tea pot 220; and the object i corresponds to the chair 208. By moving the cursors 224 and/or 252 into the area 290, the systems may invoke a scroll function that scrolls through the object, with a subsequent movement of the cursors 224 and/or 252 selects a particular object. Once selected, the attributes associated with the corresponding 3D environment object may be selected and changed by motion as set forth herein.

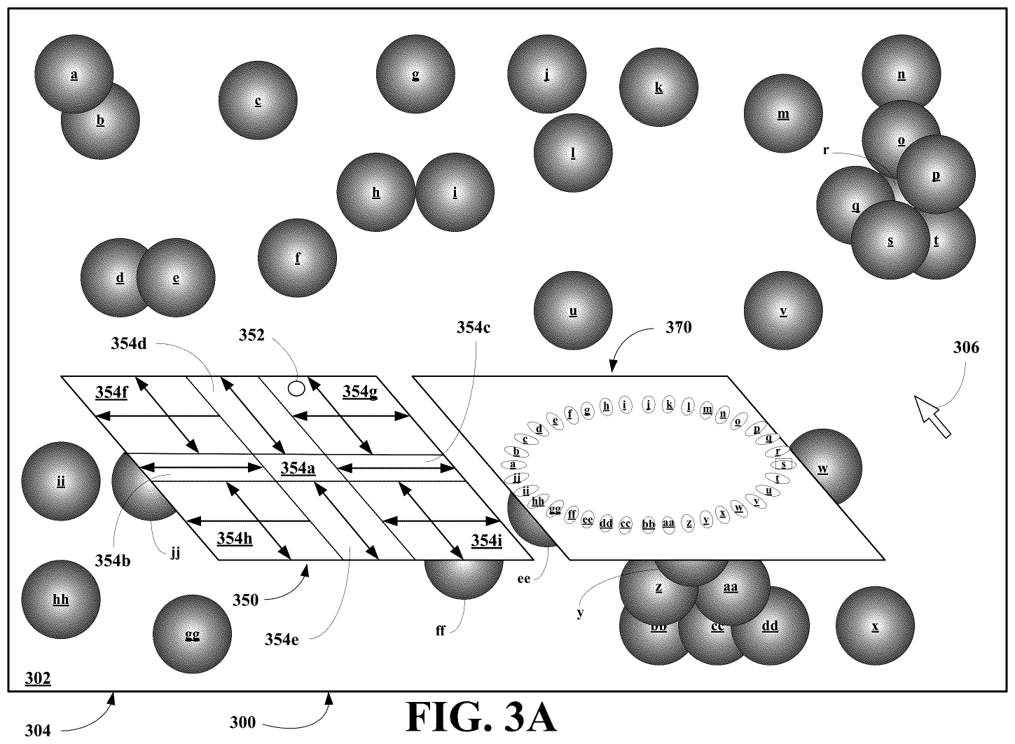

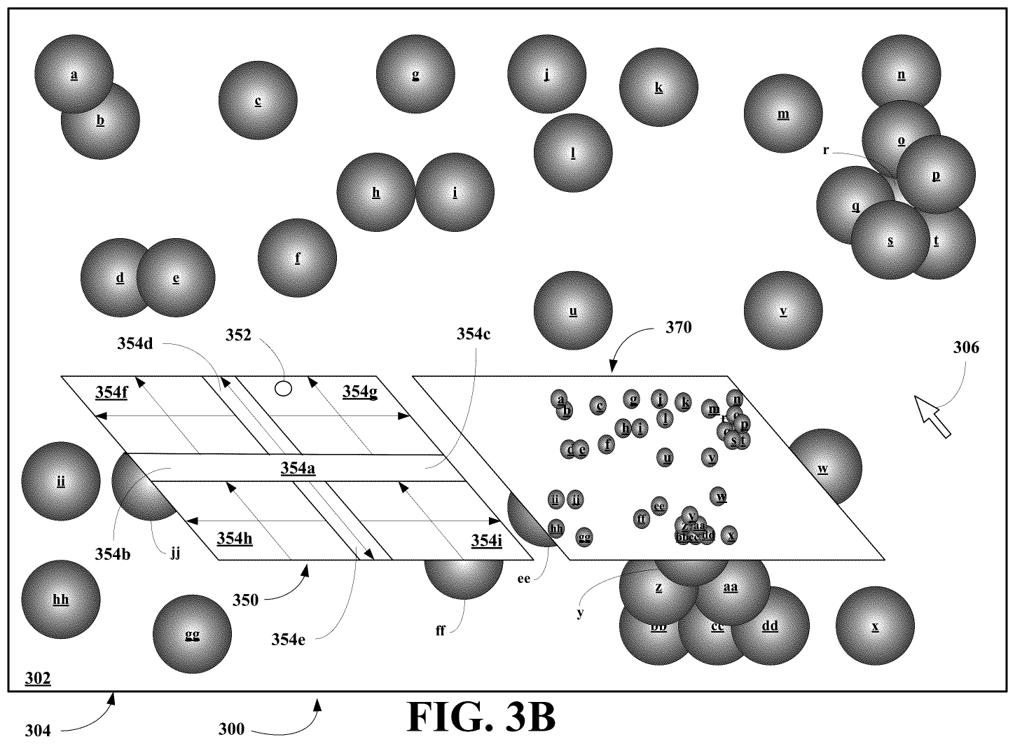

Referring now to FIGS. 3A, another embodiment of systems, apparatuses, and/or interfaces using two user feedback devices, generally 300, is shown to include a 3D environment 302 displayed on a display device 304 including a display cursor 306. The 3D environment 3202 include a plurality of objects a through jj distributed throughout the 3D environment 3202. The objects a-jj are represented here by spheres for convenience, but may actually be any type of object. The entire 3D environment 302 is viewable through a pair of eye/head tracking glasses (not shown).

When viewed through the eye/head tracking glasses, a virtual motion control area 350, a virtual object control area 370, and an eye/heading tracking cursor 352 all appear superimposed on the environment 302. The area 350 includes nine zones 354a-i, while the area 370 includes selectable objects a-jj, which correspond to the 3D environment objects a-jj.

The zone 354a is a dead zone so that when the cursor 306 and/or 352 is moved into the zone 354a, the systems cause all movement within the 3D environment 302 to stop.

The zones 354b-e are pure relative motion zones meaning that positioning the cursor 306 and/or 3252 within one of these zones causes the systems to move through the environment 302 in the indicated direction. For example, positioning the cursors 306 and/or 352 in the zone 354b causes the systems to move left at a rate determined by how close the cursors 306 and/or 352 is to the left edge of the banner 350. If the cursors 306 and/or 352 is close to the left edge, then the systems move through the environment 3202 at a fast rate; while if the cursors 306 and/or 352 is close to the dead zone 354a, then the rate is slow. Positioning the cursors 306 and/or 352 in any of the other pure relative motion zones 354c-e causes the systems to move through the environment 302 similarly.

The relative motion zones 354f-i are simultaneous or compound relative motion zones meaning that positioning the cursors 306 and/or 352 causes the systems to move through the environment 3202 in the indicated directions. For example, positioning the cursors 306 and/or 352 in the zone 354f causes the systems to move left and forward through the environment 302 at a rate determined by how close the cursors 306 and/or 352 is to the top/left corner. If the cursors 306 or 352 is close to top/left corner, then the systems move through the environment 302 to the left and forward at a fast rate; while if the cursors 306 and/or 352 is close to the dead zone 354a (bottom/right corner), then the left/forward motion rate is slow. Positioning the cursors 306 and/or 352 in any of the other compound relative motion zones 354g-i causes the systems to move through the environment 3202 similarly.

The area 370 is a selection area so that when the cursors 306 and/or 352 is positioned within the area 370. Once inside the area 370, movement toward any direction will permit the user to select from the objects. If the direction is aligned with more than one selectable object, then the systems will causes those object to be highlighted or draw to or pushed away from the cursors 306 or 352 so that further movement will result in discrimination between the possible selectable objects as set forth herein.

Referring now to FIGS. 3B, another embodiment of systems, apparatuses, and/or interfaces using two user feedback devices, generally 300, is shown to include a 3D environment 302 displayed on a display device 304 including a display cursor 306. The 3D environment 302 include a plurality of objects a through jj distributed throughout the 3D environment 302. The objects a-jj are represented here by spheres for convenience, but may actually be any type of object. The entire 3D environment 302 is viewable through a pair of eye/head tracking glasses (not shown).

When viewed through the eye/head tracking glasses, a virtual motion control area 350, a virtual object control area 370, and an eye/heading tracking cursor 352 all appear superimposed on the environment 302. The area 350 includes nine zones 354a-i, where the zones 354b-i are all 3D relative control zones meaning that positioning the cursor 306 or 352 within any of these zones causes the systems to move in two or three direction simultaneously. The area 370 includes selectable objects a-jj, which correspond to the 3D environment objects a-jj.

The zone 354a is a dead zone so that when the cursors 306 and/or 352 is moved into the zone 354a, the systems cause all movement within the 3D environment 3202 to stop.

The zones 354b-e are two directional relative motion zones meaning that positioning the cursors 306 and/or 352 within one of these zones causes the systems to move up or down and left or right or forward or backward through the environment 302. For example, positioning the cursors 306 or 3252 in the zone 354b causes the systems to move left and up or down at a rate determined by how close the cursors 306 and/or 352 is to the left edge, top edge, bottom edge, right edge of the zone 354b. If the cursors 306 and/or 352 is close to the left/top edge, then the systems move through the environment 302 at a fast rate up and to the left—move up pan left; while if the cursors 306 and/or 352 is close to the right/bottom edge or near the dead zone 354a, then the rate is up and left is slow—move up and pan left at a slow rate. Positioning the cursors 302 and/or 352 in any of the other two directional relative motion zones 354c-e causes the systems to move through the environment 302 similarly.

The zones 354f-i are three directional relative motion zones meaning that positioning the cursors 306 or 352 causes the systems to move through the environment 302 in the three directions simultaneously. For example, positioning the cursors 306 and/or 352 in the zone 354f causes the systems to move left, forward, and up or down through the environment 302 at a rate determined by how close the cursors 306 and/or 352 is to the one of the edges or corners. If the cursors 306 and/or 352 is close to top/left corner, then the systems move through the environment 302 to the left, forward, and up at a fast rate; while if the cursors 306 and/or 352 is close to the bottom/right corner (i.e., close to the dead zone 354a), then the systems move through the environment 3202 to the left, forward, and down at a slow rate. Positioning the eye/heading tracking cursors 306 or 352 in any of the other compound relative motion zones 354g-i causes the systems to move through the environment 302 similarly.

The area 370 is a selection area so that when the cursors 306 and/or 352 is positioned within the area 370, movement toward any direction will permit the user to select from the objects. If the direction is aligned with more than one selectable objects, then the systems will cause those object to be highlighted or draw to or pushed away from the cursors 306 and/or 352 so that further movement will result in discrimination between the possible selectable objects as set forth herein.

Referring now to FIG. 4, another embodiment of systems, apparatuses, and/or interfaces using two user feedback devices, generally 400, is shown to include a 3D environment 402 displayed on a display device 404 including a display cursor 406. The 3D environment 402 include a plurality of objects a through jj distributed throughout the 3D environment 402. The objects a-jj are represented here by spheres for convenience, but may actually be any type of object. The entire 3D environment 402 is viewable through a pair of eye/head tracking glasses (not shown).

When viewed through the eye/head tracking glasses, a virtual motion control area 450, a virtual object control area 470, and an eye/heading tracking cursor 452 all appear superimposed on the environment 402. The area 450 includes nine zones 454a-i, while the area 470 includes selectable objects a-jj, which correspond to the 3D environment objects a-jj and are arranged in a flat projection onto the area 470 in their projected positions.

The zone 454a is a dead zone so that when the cursors 406 and/or 452 is moved into the zone 454a, the systems cause all movement within the 3D environment 402 to stop.

The zones 454b-e are pure relative motion zones meaning that positioning the cursors 406 and/or 452 within one of these zones causes the systems to move through the environment 402 in the indicated direction. For example, positioning the cursors 406 and/or 452 in the zone 454b causes the systems to move left at a rate determined by how close the cursor 406 or 452 is to the left edge of the banner 450. If the cursors 406 and/or 452 is close to the left edge, then the systems move through the environment 402 at a fast rate; while if the cursors 406 and/or 452 is close to the dead zone 454a, then the rate is slow. Positioning the cursors 406 and/or 452 in any of the other pure relative motion zones 454c-e causes the systems to move through the environment 402 similarly.

The relative motion zones 454f-i are simultaneous or compound relative motion zones meaning that positioning the cursors 406 and/or 452 causes the systems to move through the environment 402 in the indicated directions. For example, positioning the cursors 406 and/or 452 in the zone 454f causes the systems to move left and forward through the environment 402 at a rate determined by how close the cursors 406 and/or 452 is to the top/left corner. If the cursor 406 or 452 is close to top/left corner, then the systems move through the environment 402 to the left and forward at a fast rate; while if the cursors 406 and/or 452 is close to the dead zone 454a (bottom/right corner), then the left/forward motion rate is slow. Positioning the cursors 406 and/or 452 in any of the other compound relative motion zones 454g-i causes the systems to move through the environment 402 similarly.

The area 470 is a selection area so that when the cursors 406 and/or 452 is positioned within the area 470. Once inside the area 470, movement toward any direction will permit the user to select from the objects. If the direction is aligned with more than one selectable object, then the systems will causes those object to be highlighted or draw to or pushed away from the cursors 406 and/or 452 so that further movement will result in discrimination between the possible selectable objects as set forth herein.

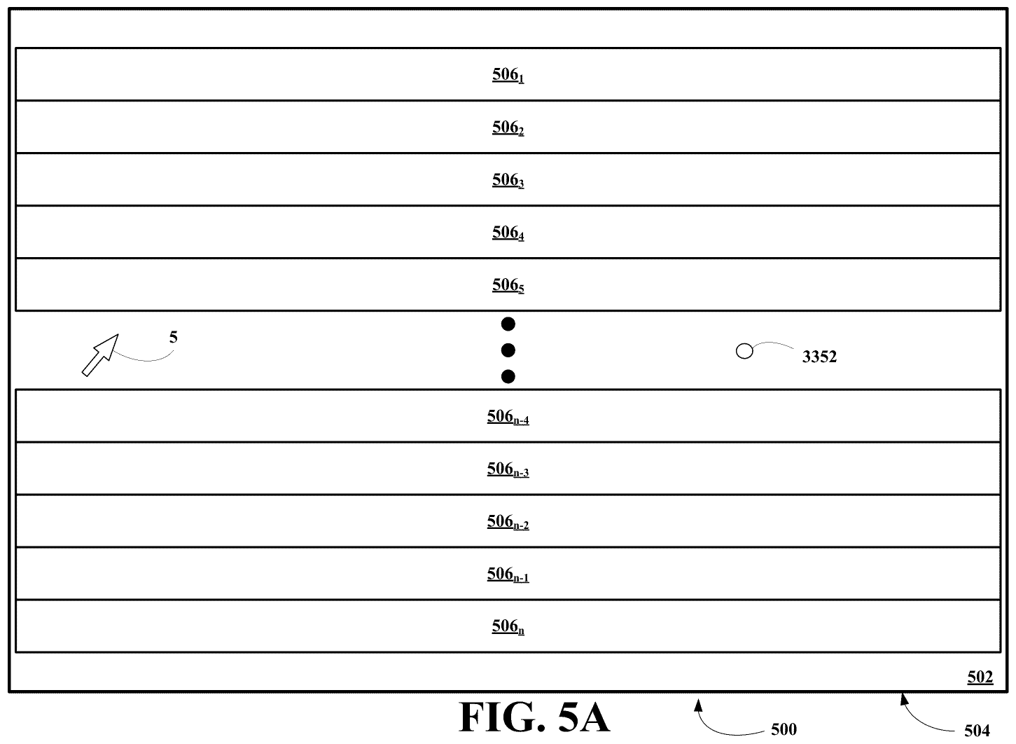

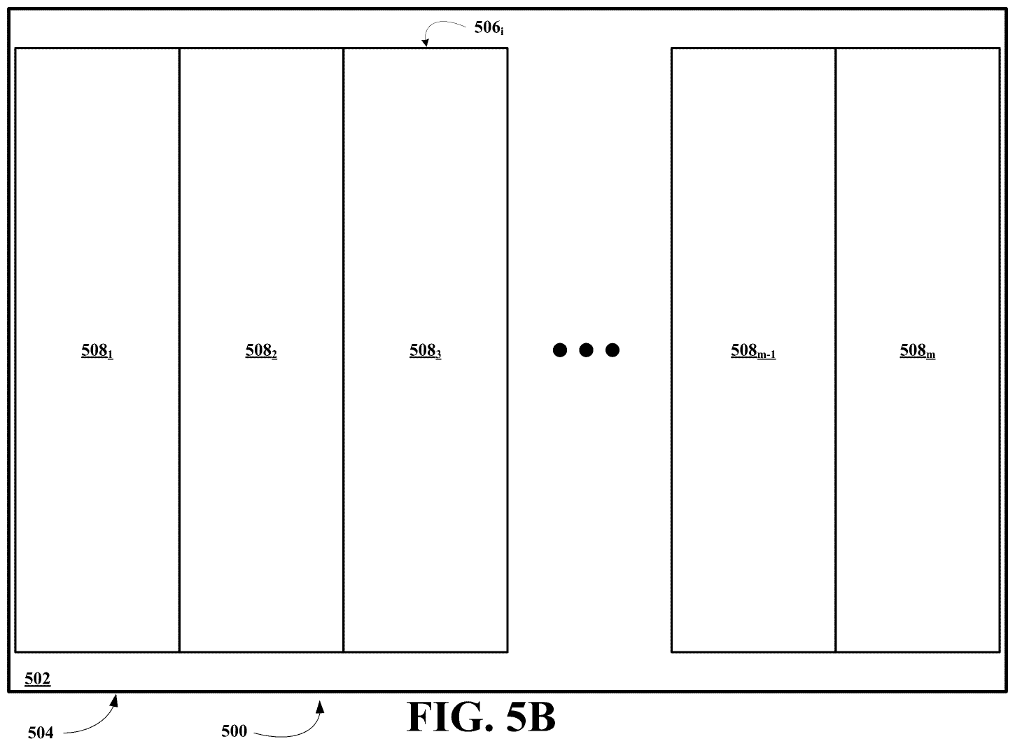

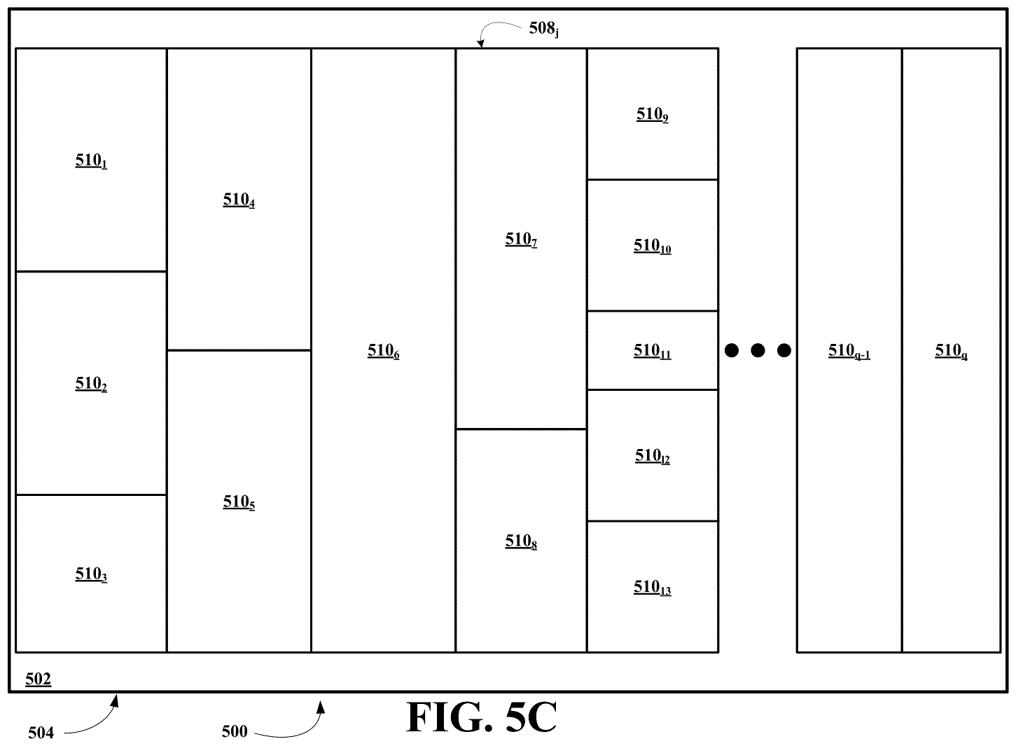

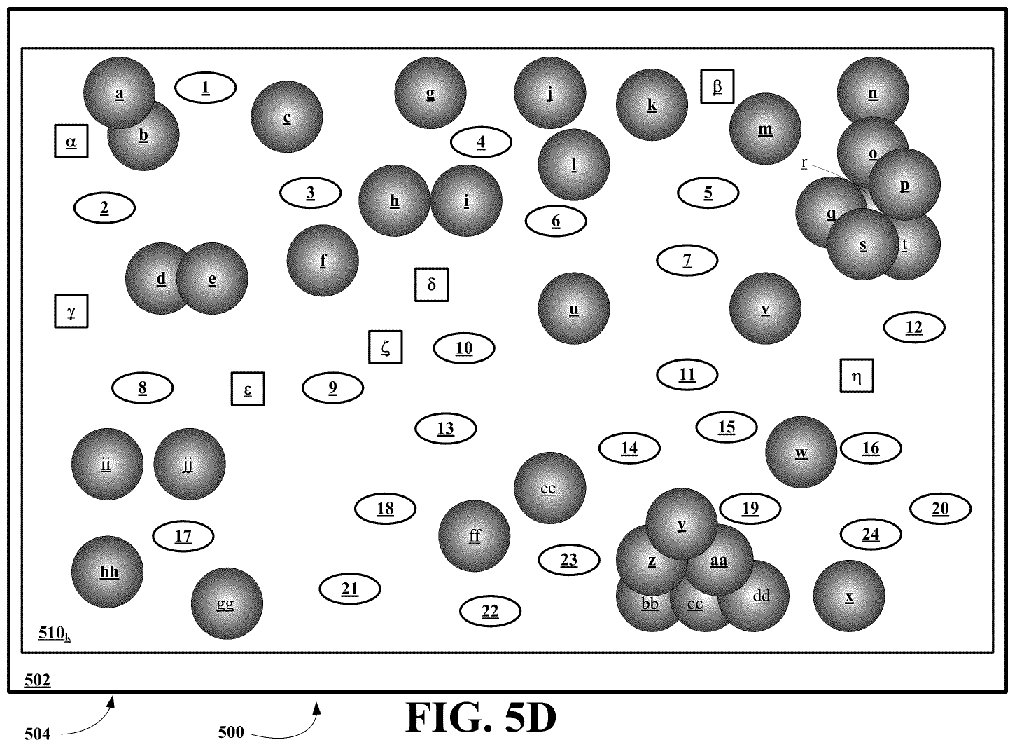

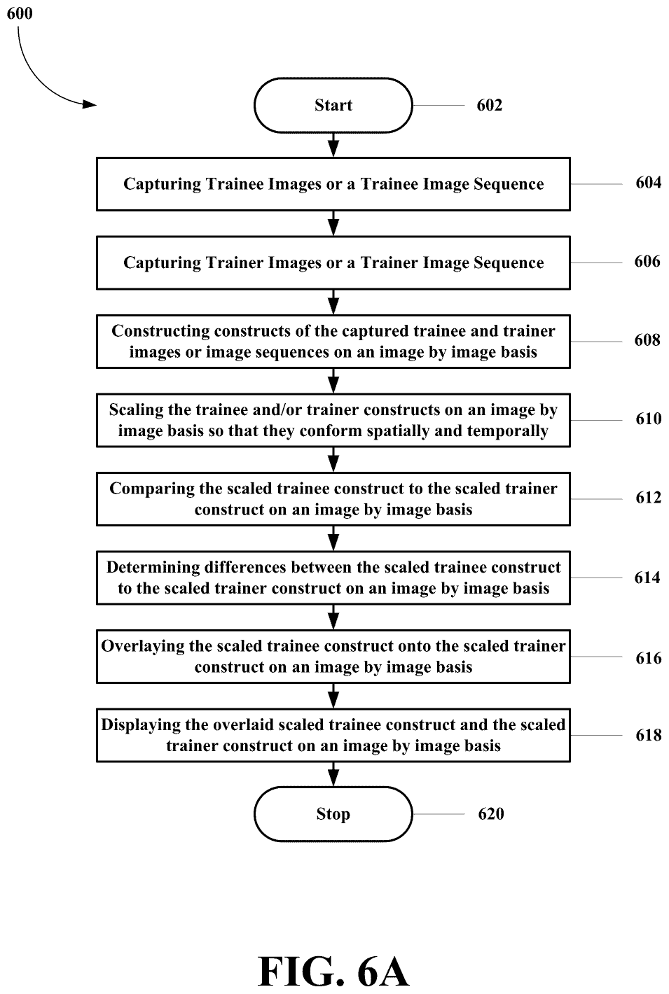

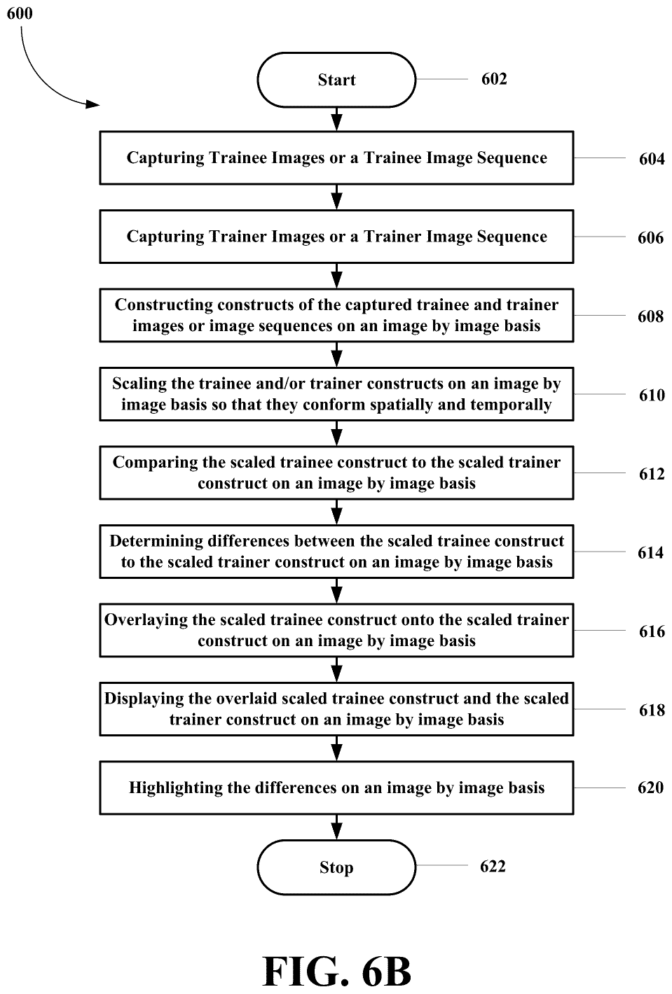

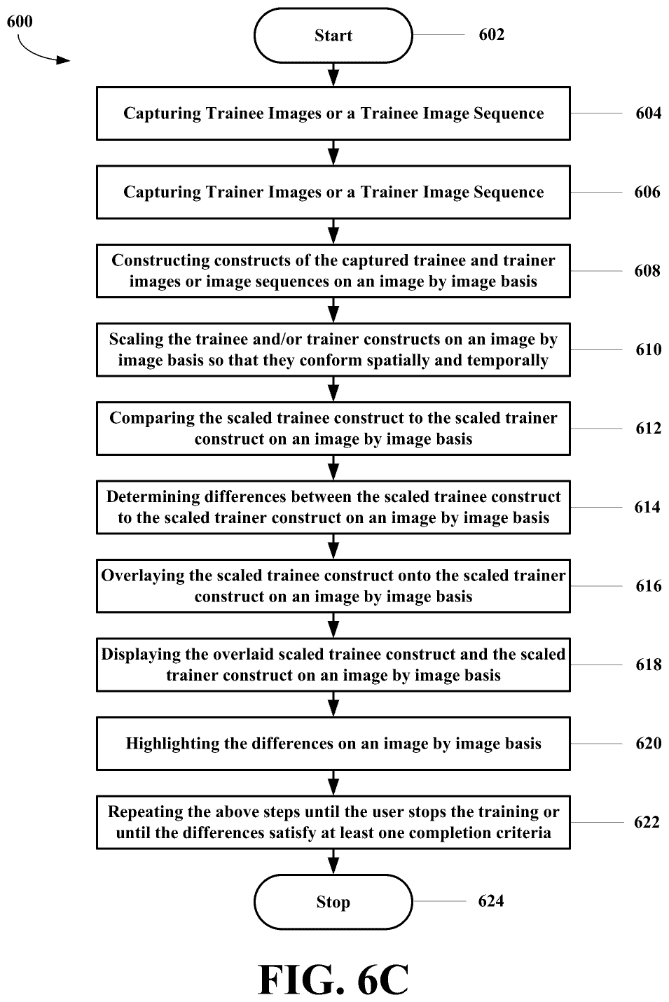

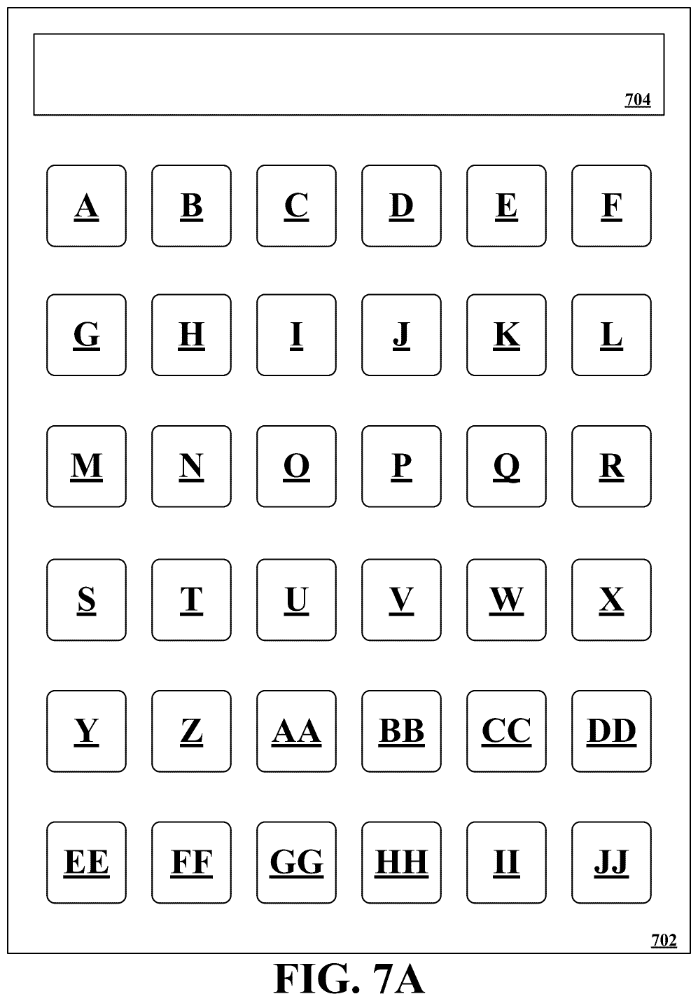

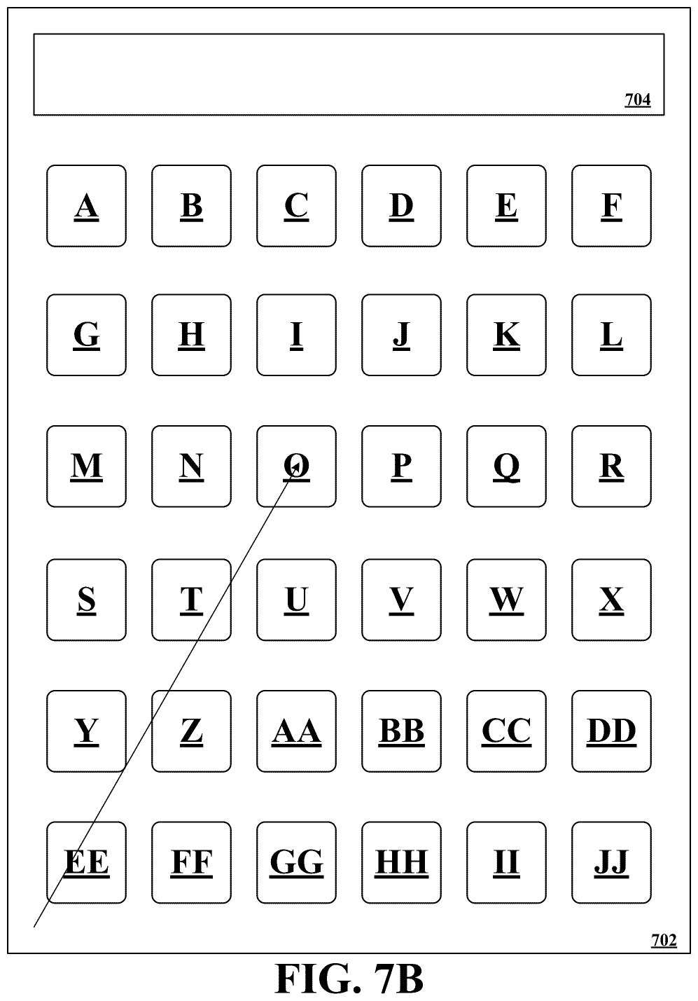

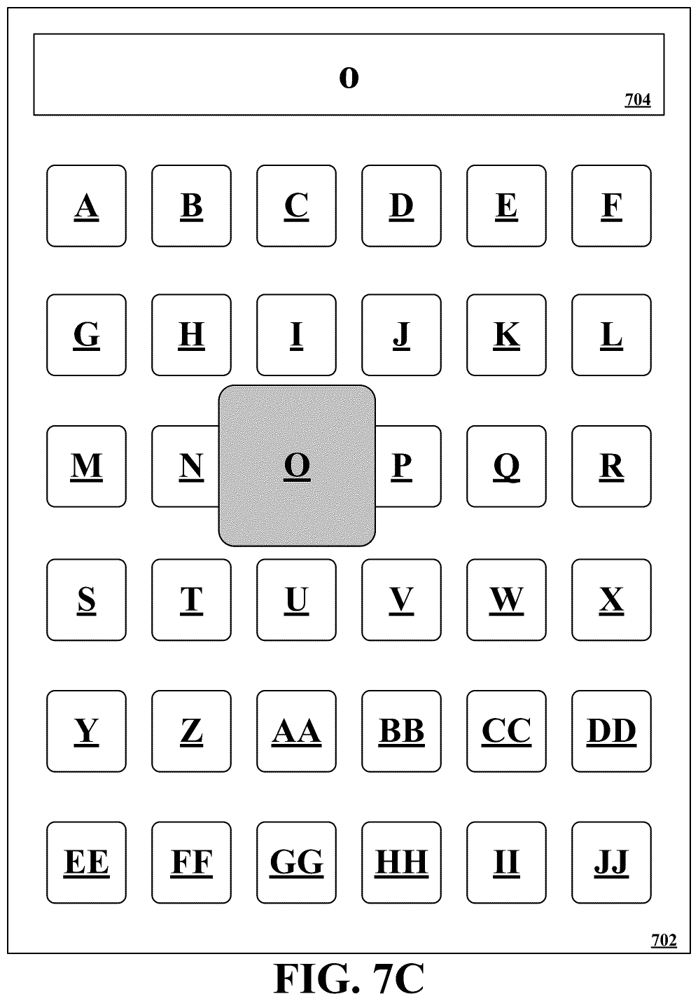

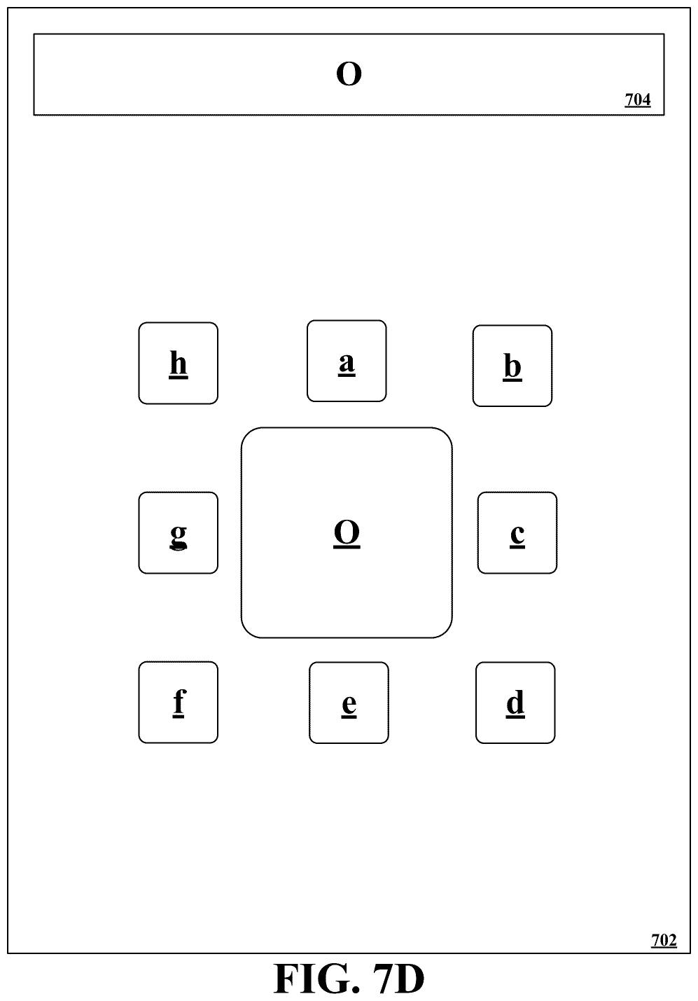

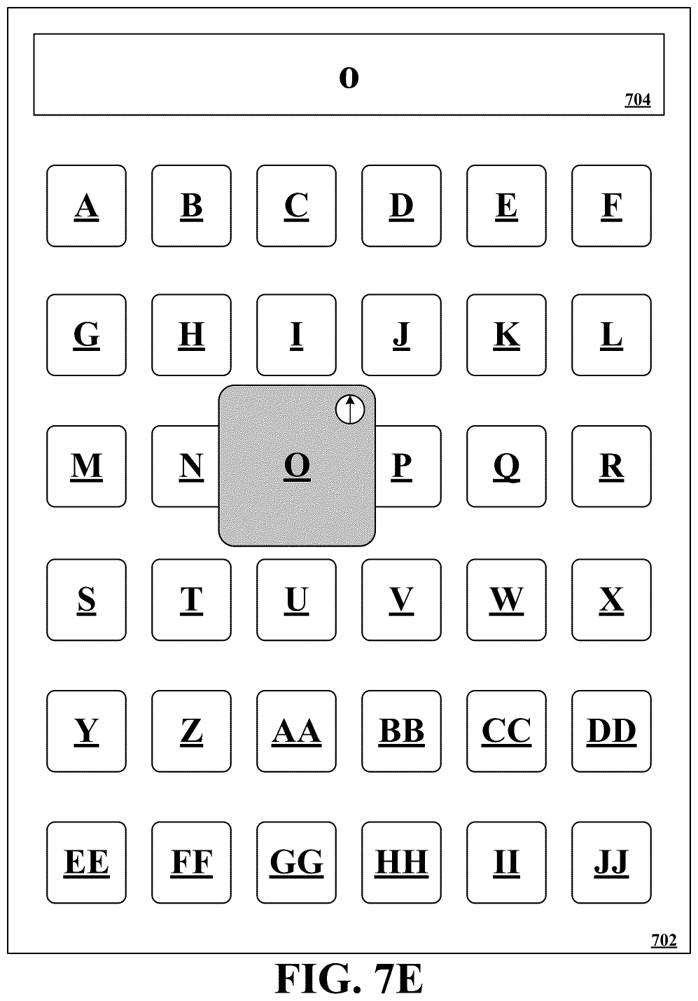

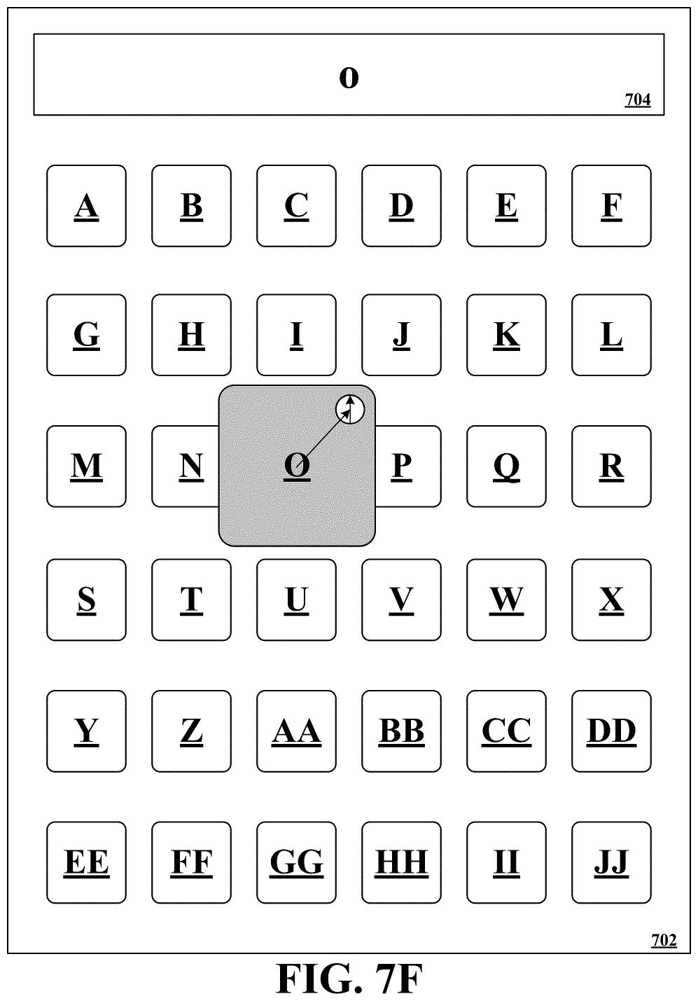

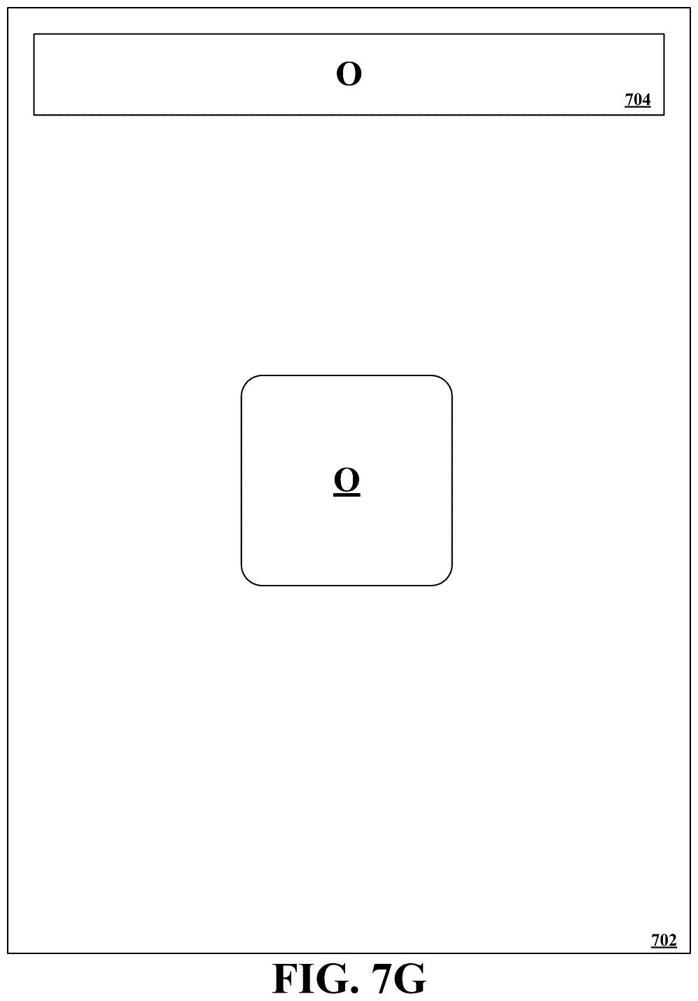

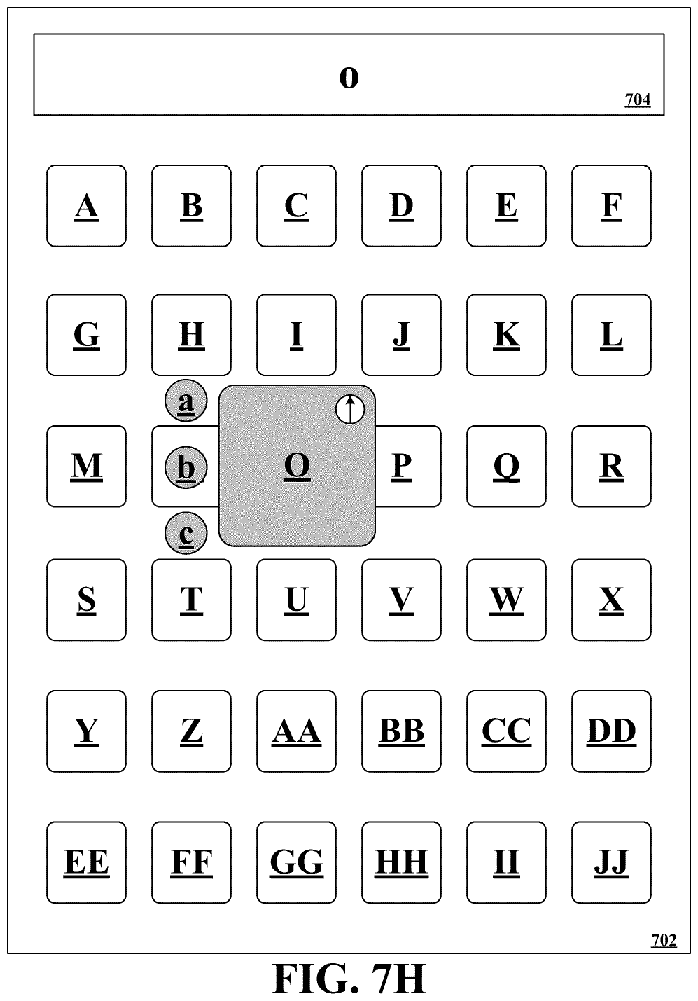

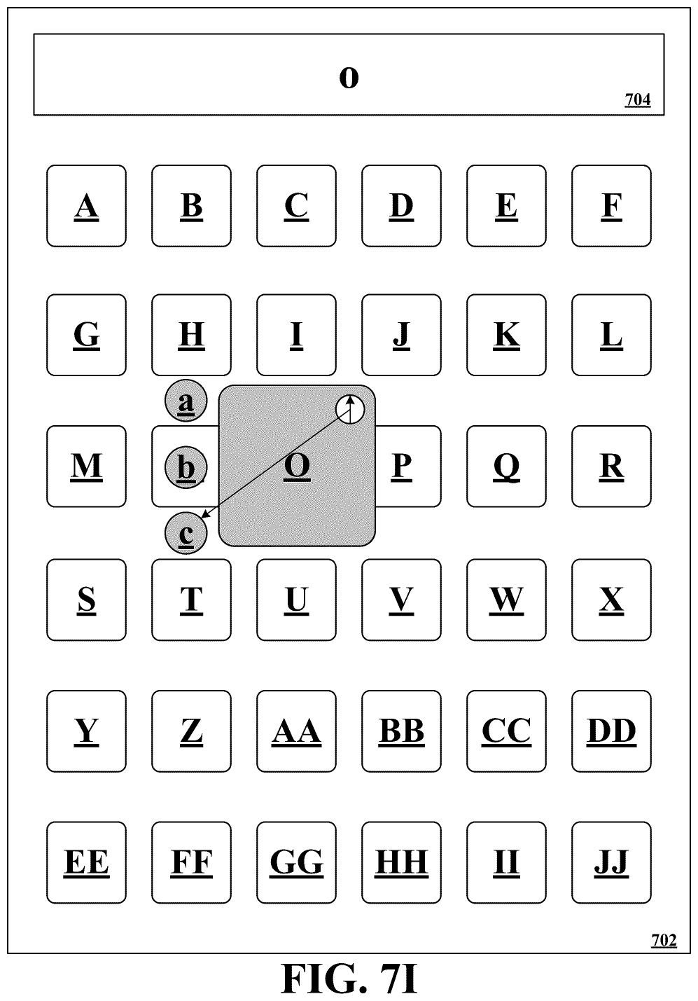

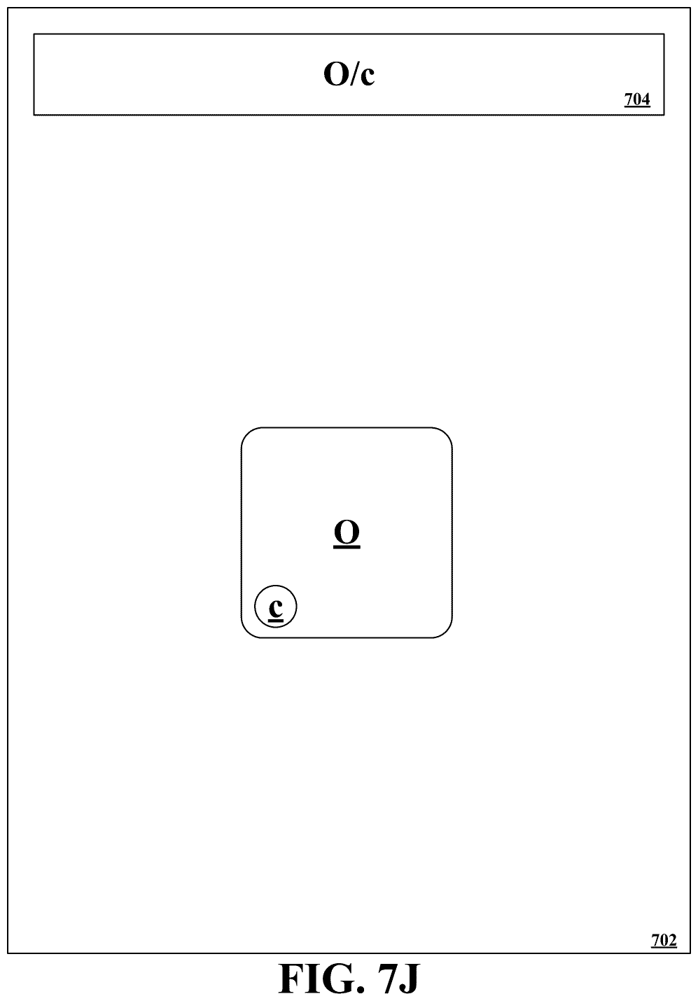

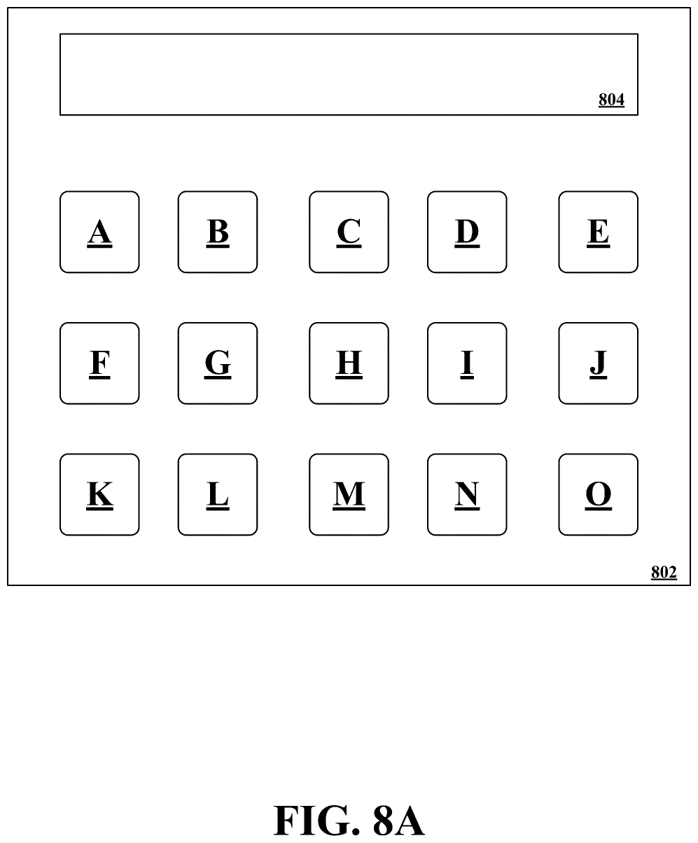

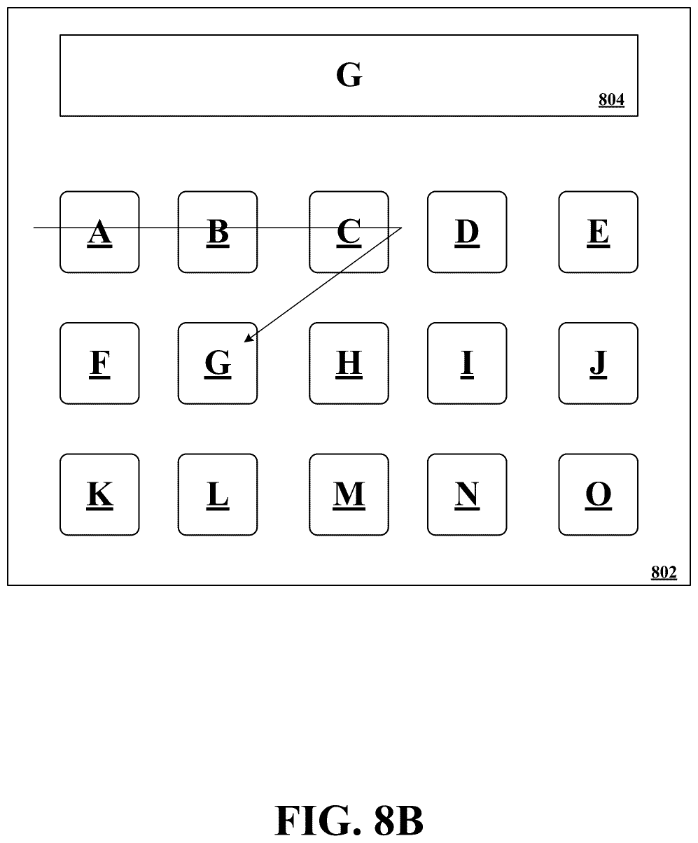

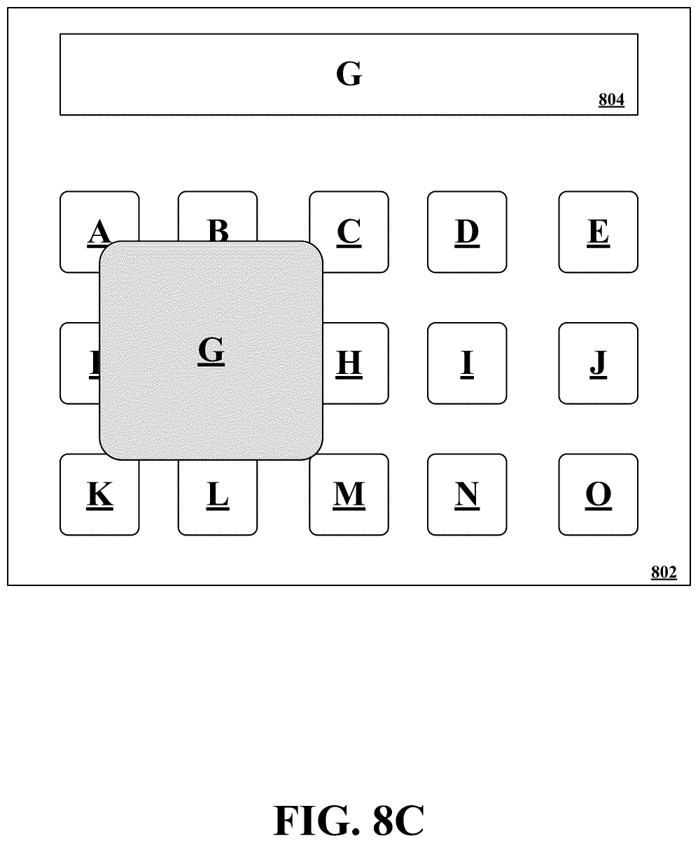

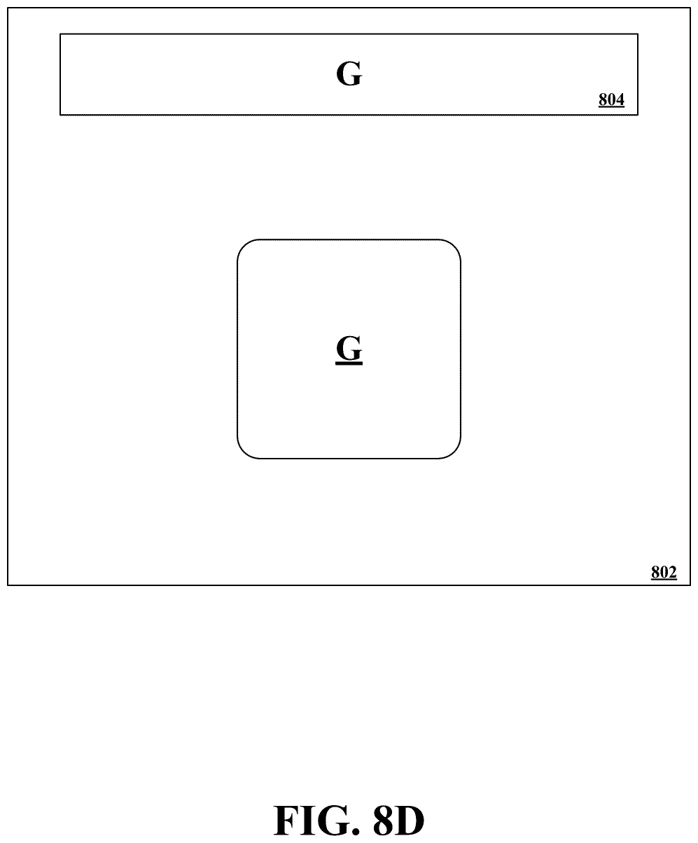

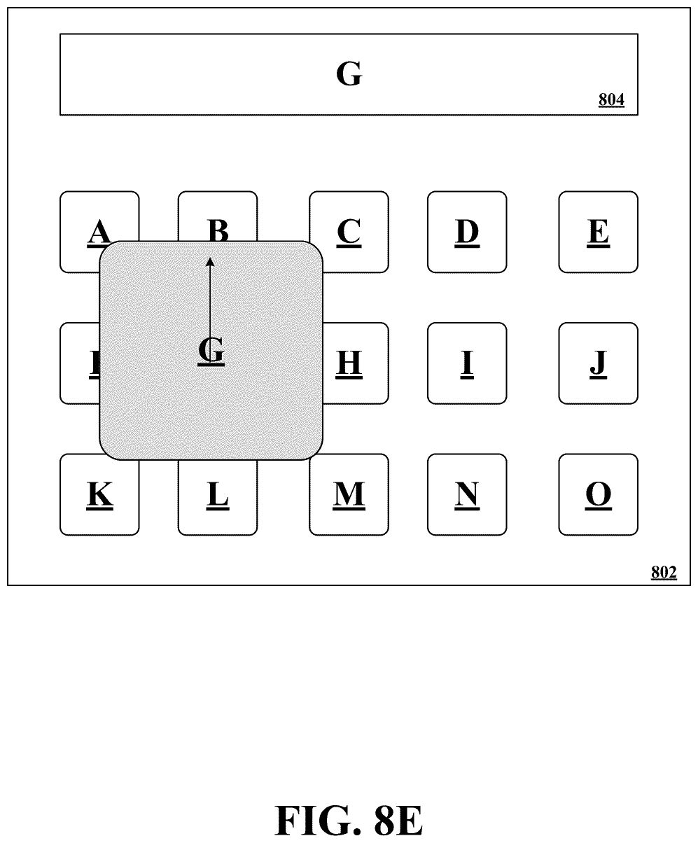

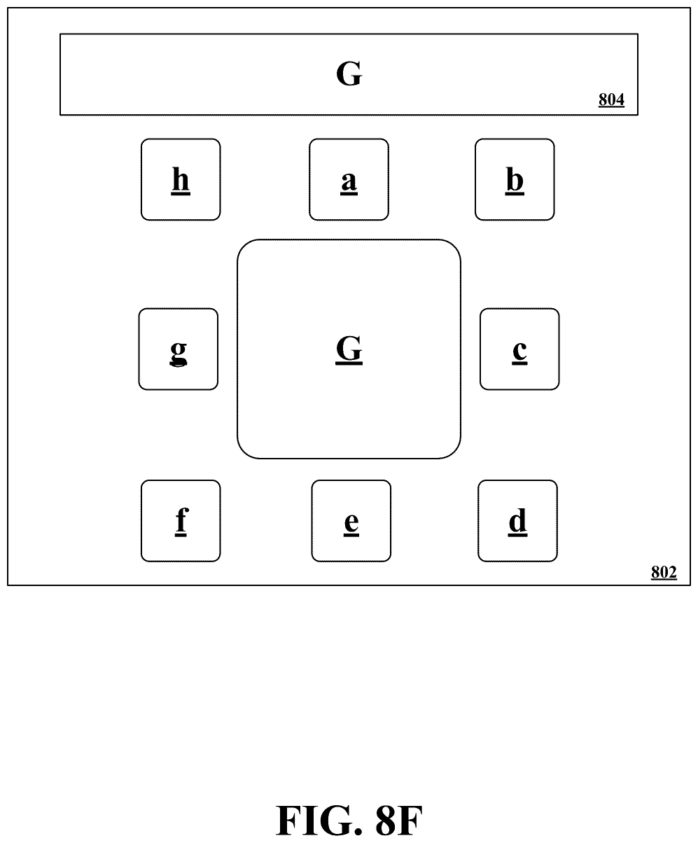

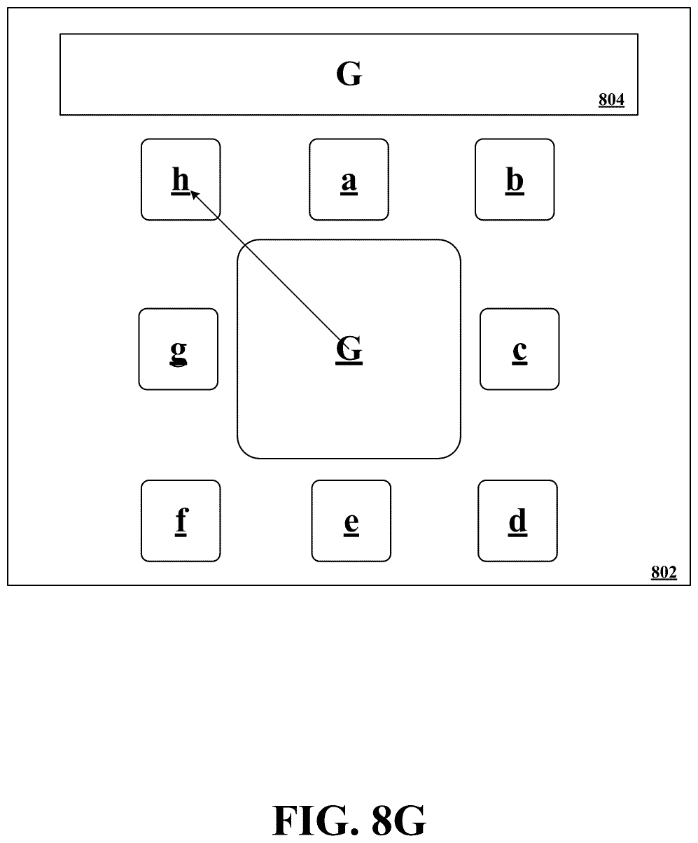

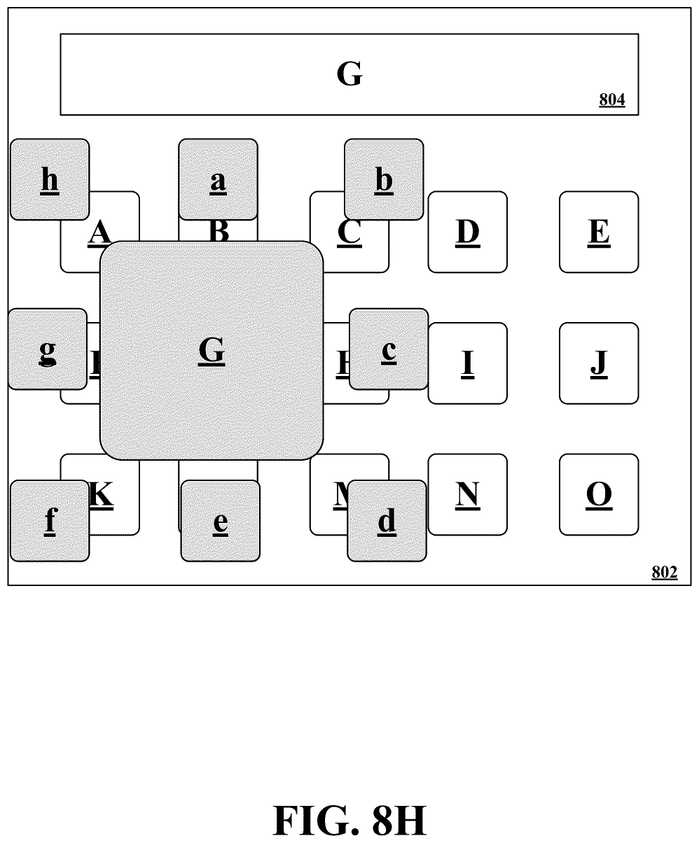

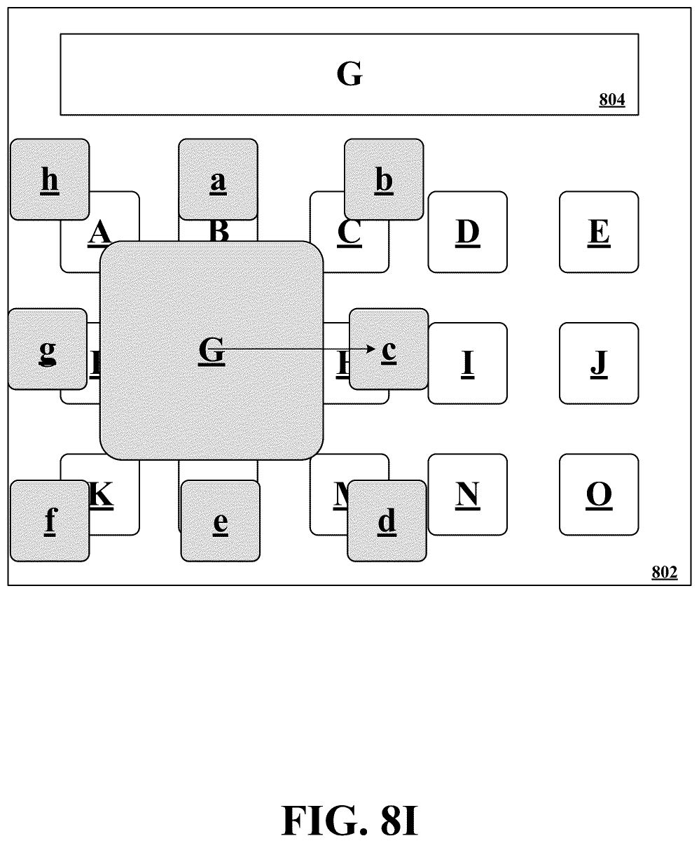

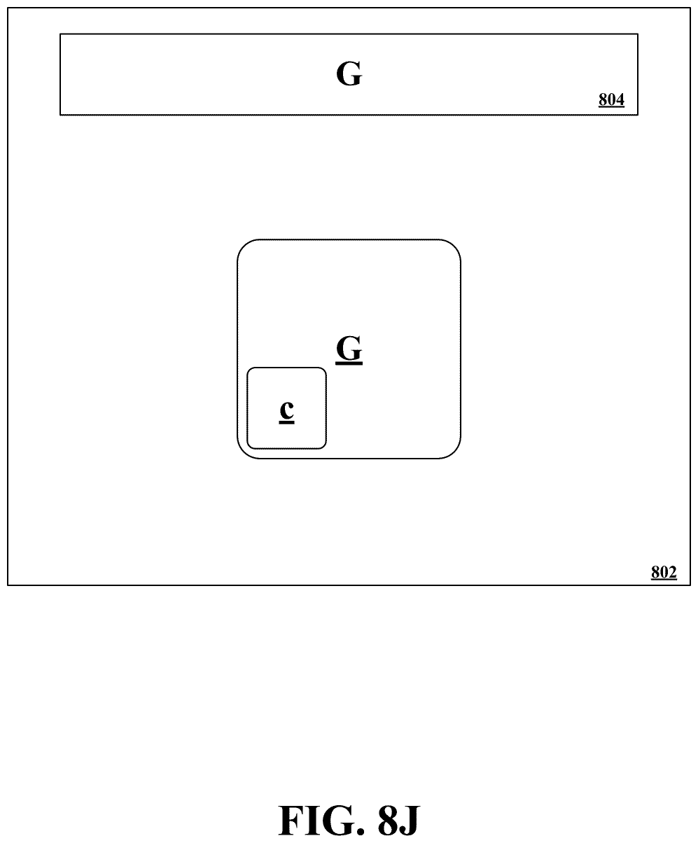

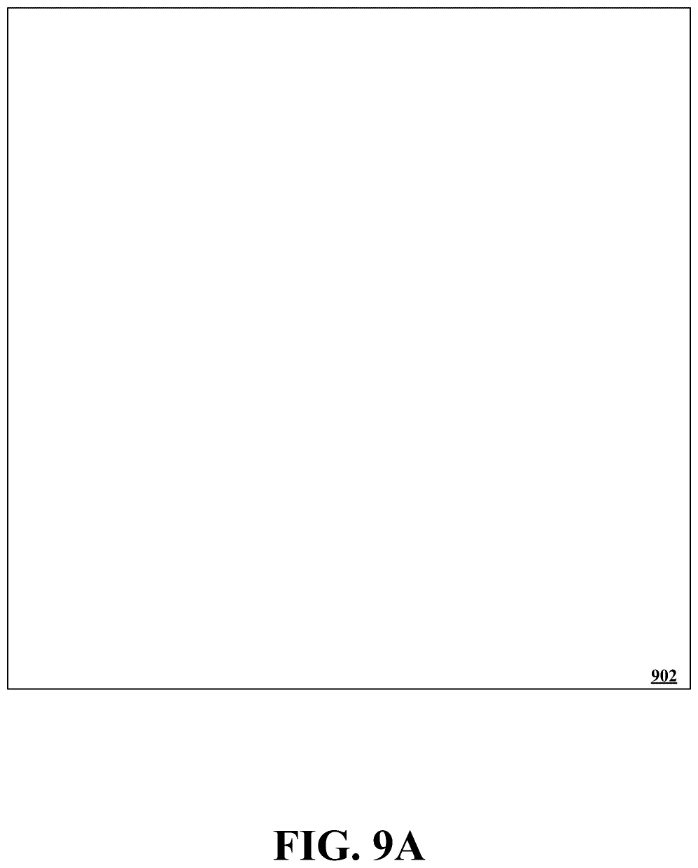

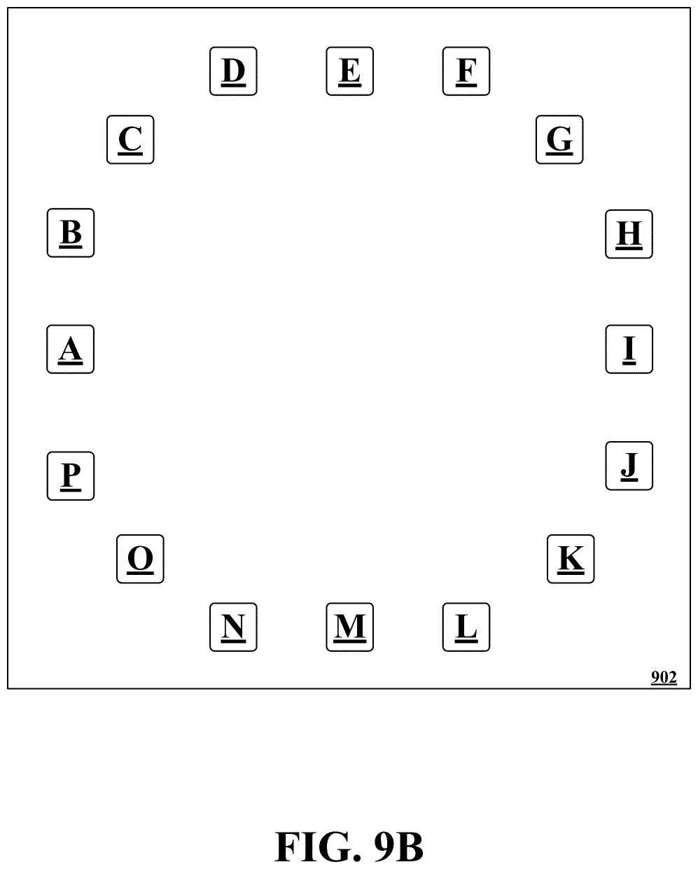

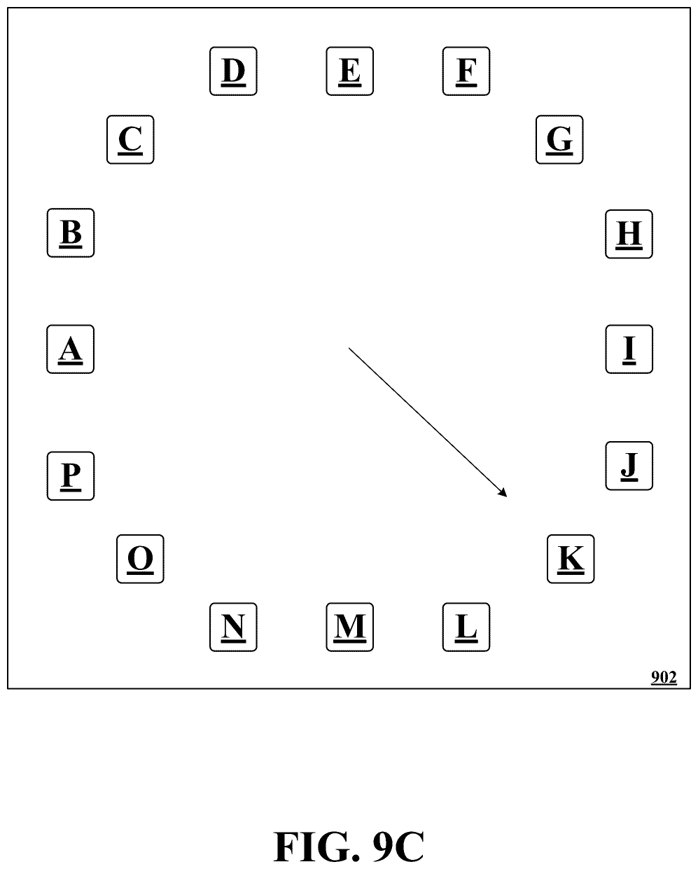

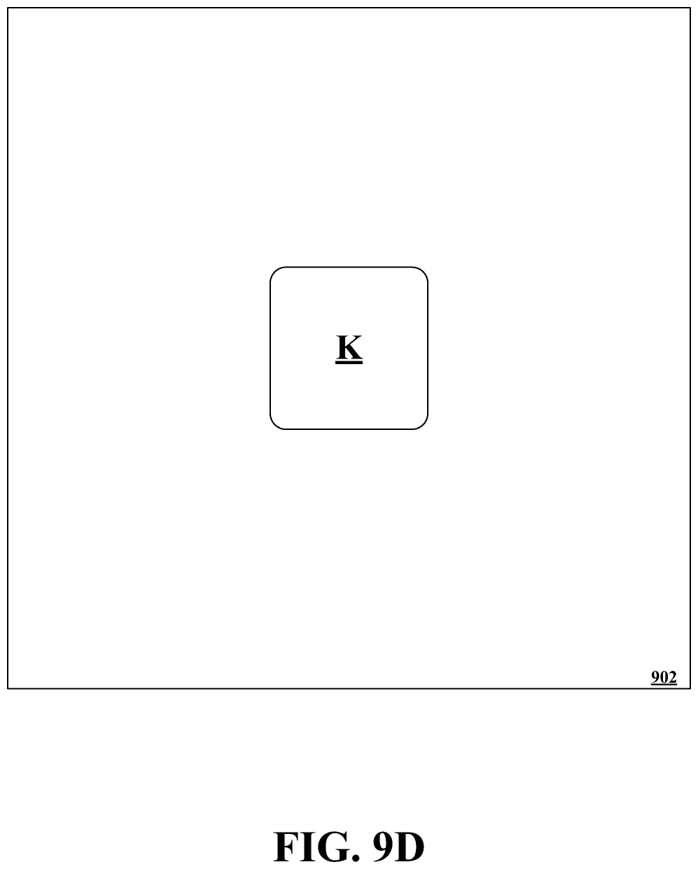

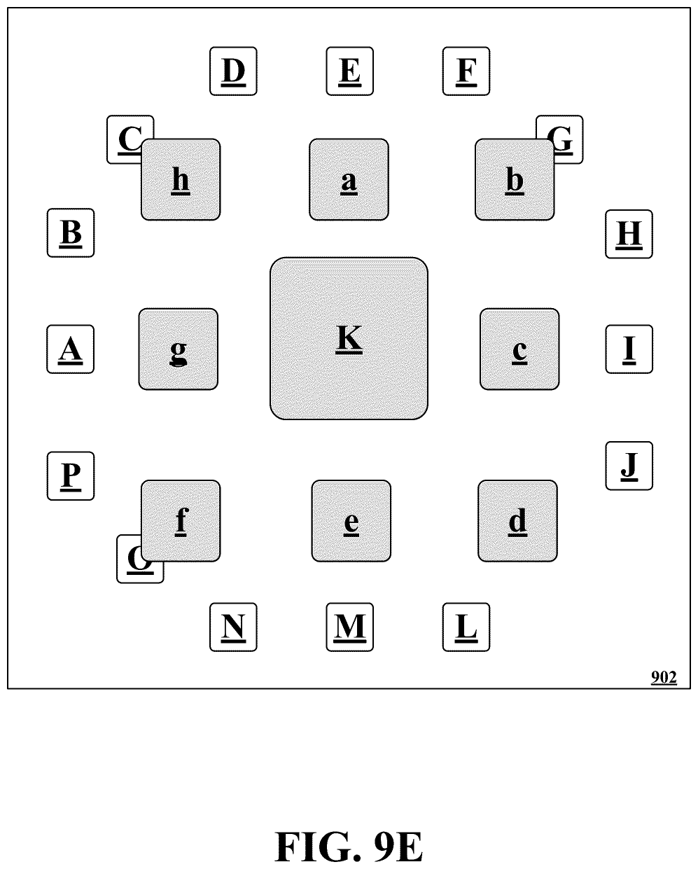

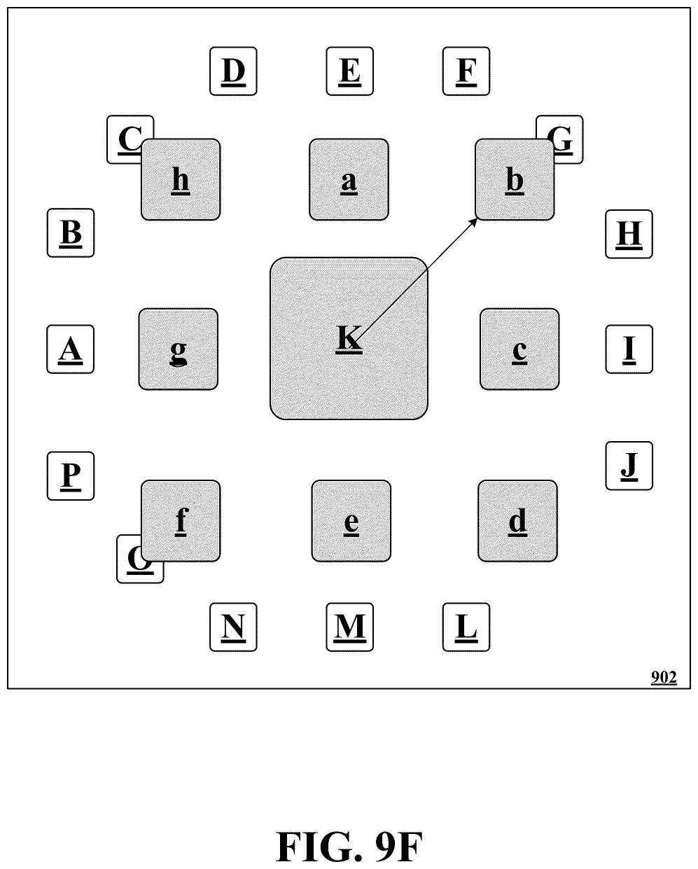

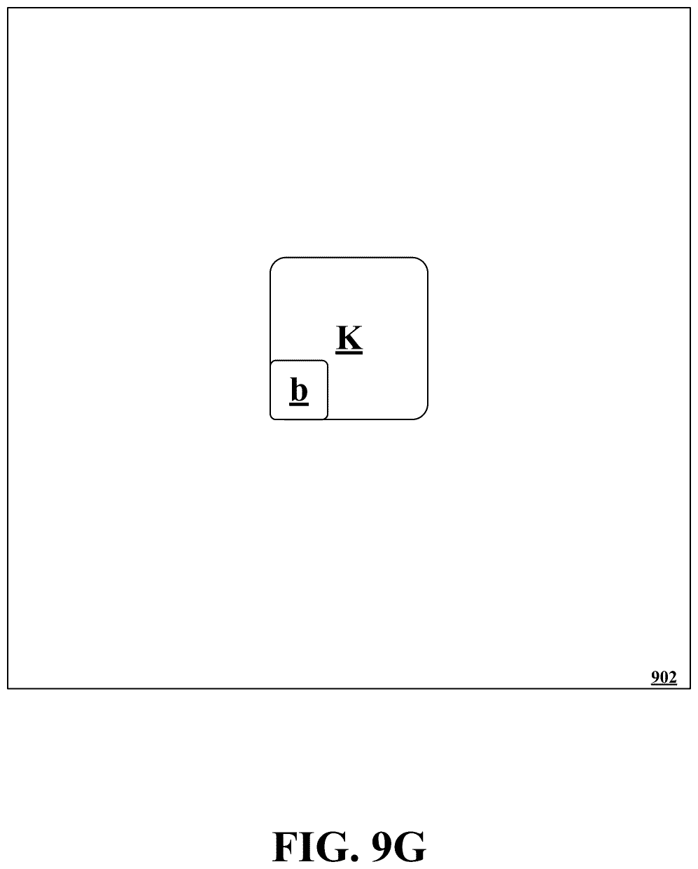

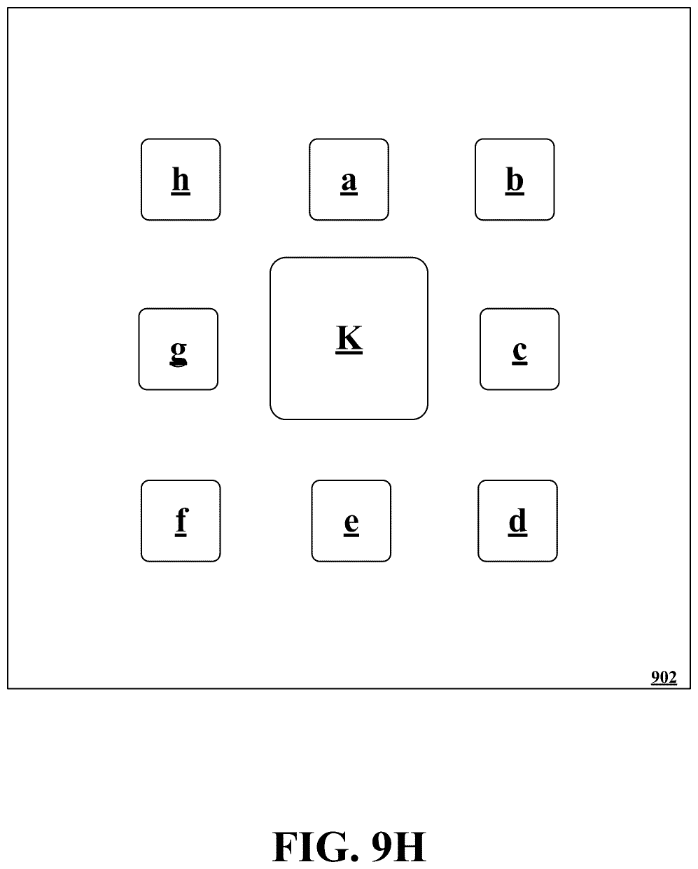

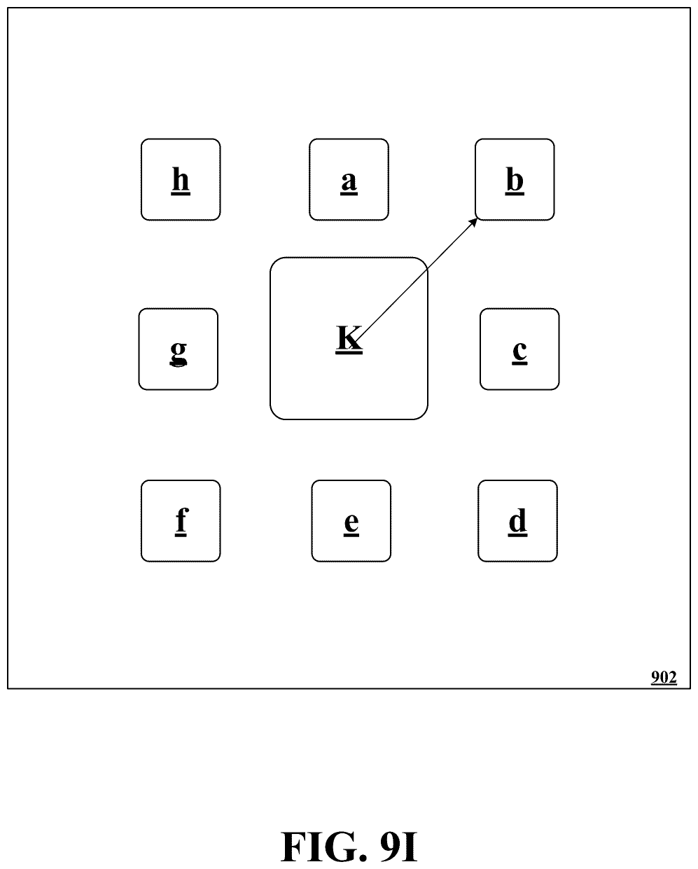

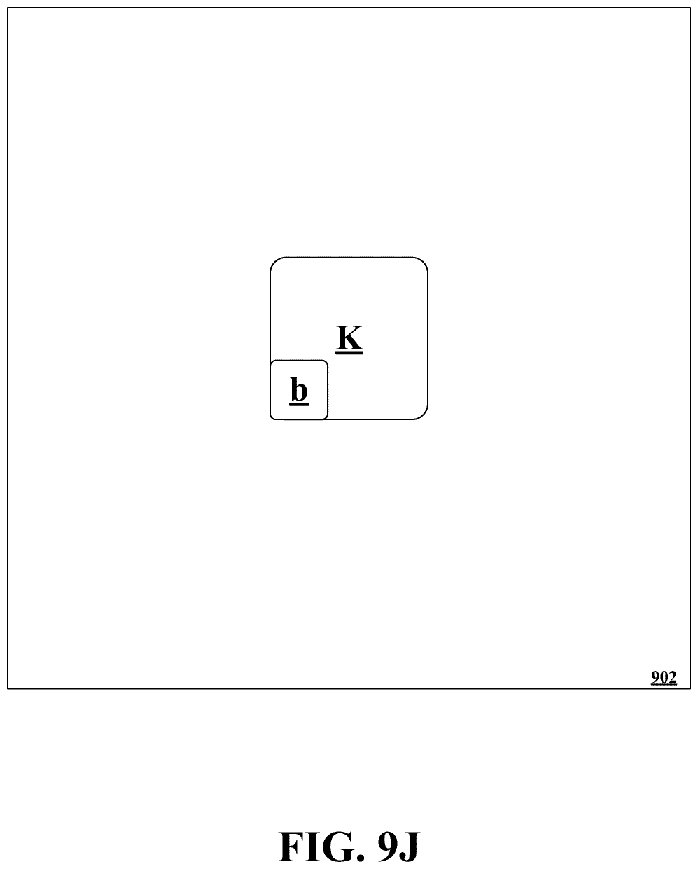

Referring now to FIGS. 5A-D, another embodiment of systems, apparatuses, and/or interfaces using two user feedback devices, generally 500, is shown to include a 3D environment 502 displayed on a display device 504. The entire 3D environment 502 includes a plurality of levels 506₁₋ₐ, where n is an integer as shown in FIG. 5A. Each level 506ᵢ includes a plurality of sublevels 508₁₋ₘ, where m is an integer as shown in FIG. 5B. Each sublevel 508ⱼ includes a plurality of zones 510_{1-q}, where q is an integer as shown in FIG. 5C. Each zone 510ₖ includes three pluralities of objects a-jj, 1-24 and α, β, γ, δ, ε, ζ, and η as shown in FIG. 5D. Traversal through the levels, sublevels, and zones may be affected using a display cursor 512 and/or a eye/head tracking cursor 514. Traversal through the levels, sublevels, and zones may be any selection methodology disclosed herein. Additionally, the levels, sublevels, and/or zone may be presented as a menu or list so that any methodology of this disclosure may be used—scrolling, selecting, activating, attribute adjusting, etc. Moreover, once a zone has been selected, the eye/head tracking glasses may allow a virtual control area or areas to appear superimposed on the environment for control as set forth above.

Referring now to FIG. 6A, an embodiment of a schematic flow chart of a method of training, generally 600, including a start step 602. After starting, the method includes a trainee capturing step 604, where trainee images or a trainee image sequence corresponding to a trainee performing a training exercise involving a game such as golf, baseball, football, soccer, etc. or an exercise routine, a martial art routine, a dance routine, an instrument routine or any other training routine that may be captured by an imaging input device. The method also includes a trainer capturing step 606, where trainer images or a trainer image sequence corresponding to a trainer performing the same training exercise performed by the trainee. The method also includes a constructing step 608, where computer generated trainee and trainer constructs are produced on an image by image basis. In certain embodiments, the construct comprise a polygon (triangles and higher polygons) construct, where all features of the images are represented by a plurality of polygons so that the constructs are capable of scaling so that the trainee images feature may correspond to the trainer images for comparison and overlaying purposes. In other embodiments, the construct comprise a tessellated construct, again capable of being scaled to correspondence. In other embodiments, the construct is a finite element construct, again capable of being scaled to correspondence. The method also includes a scaling step 610, where the trainee and/or trainer constructs are scaled to correspond to each other on an image by image basis. The scaling adjusts corresponding features in the trainee images to corresponding features in the trainer images. For example, the trainee body is scaled to conform to the trainer body so that the movement of the trainee and trainer may be compared. As the images are capture over time, the scaling may include both spatial and temporal scaling. The method also includes a comparing step 612, where the scaled trainee and trainer constructs are compared on an image by image basis and where comparison is on a feature by feature basis as well. The method also includes a determining step 614, where differences between the features on an image by image basis are generated. The method also includes a overlaying step 616, where the scaled trainee construct onto the scaled trainer construct on an image by image basis. The method also includes a displaying step 618, where the overlaid scaled constructs are displayed on a display device so show the difference between the trainee performing the training exercise and the trainer performing the training exercise.

Referring now to FIG. 6B, another embodiment of a schematic flow chart of a method of training, generally 600, including a start step 602. After starting, the method includes a trainee capturing step 604, where trainee images or a trainee image sequence corresponding to a trainee performing a training exercise involving a game such as golf, baseball, football, soccer, etc. or an exercise routine, a martial art routine, a dance routine, an instrument routine or any other training routine that may be captured by an imaging input device. The method also includes a trainer capturing step 606, where trainer images or a trainer image sequence corresponding to a trainer performing the same training exercise performed by the trainee. The method also includes a constructing step 608, where computer generated trainee and trainer constructs are produced on an image by image basis. In certain embodiments, the construct comprise a polygon (triangles and higher polygons) construct, where all features of the images are represented by a plurality of polygons so that the constructs are capable of scaling so that the trainee images feature may correspond to the trainer images for comparison and overlaying purposes. In other embodiments, the construct comprise a tessellated construct, again capable of being scaled to correspondence. In other embodiments, the construct is a finite element construct, again capable of being scaled to correspondence. The method also includes a scaling step 610, where the trainee and/or trainer constructs are scaled to correspond to each other on an image by image basis. The scaling adjusts corresponding features in the trainee images to corresponding features in the trainer images. For example, the trainee body is scaled to conform to the trainer body so that the movement of the trainee and trainer may be compared. As the images are capture over time, the scaling may include both spatial and temporal scaling. The method also includes a comparing step 612, where the scaled trainee and trainer constructs are compared on an image by image basis and where comparison is on a feature by feature basis as well. The method also includes a determining step 614, where differences between the features on an image by image basis are generated. The method also includes a overlaying step 616, where the scaled trainee construct onto the scaled trainer construct on an image by image basis. The method also includes a displaying step 618, where the overlaid scaled constructs are displayed on a display device so show the difference between the trainee performing the training exercise and the trainer performing the training exercise. The method also includes a highlighting step 620, where the differences are displayed on the display device in a highlighted format (color, shade, pulsating, or other highlighting property) as the constructs are being displayed so that the trainee and/or trainer may see the differences.

Referring now to FIG. 6C, another embodiment of a schematic flow chart of a method of training, generally 600, including a start step 602. After starting, the method includes a trainee capturing step 604, where trainee images or a trainee image sequence corresponding to a trainee performing a training exercise involving a game such as golf, baseball, football, soccer, etc. or an exercise routine, a martial art routine, a dance routine, an instrument routine or any other training routine that may be captured by an imaging input device. The method also includes a trainer capturing step 606, where trainer images or a trainer image sequence corresponding to a trainer performing the same training exercise performed by the trainee. The method also includes a constructing step 608, where computer generated trainee and trainer constructs are produced on an image by image basis. In certain embodiments, the construct comprise a polygon (triangles and higher polygons) construct, where all features of the images are represented by a plurality of polygons so that the constructs are capable of scaling so that the trainee images feature may correspond to the trainer images for comparison and overlaying purposes. In other embodiments, the construct comprise a tessellated construct, again capable of being scaled to correspondence. In other embodiments, the construct is a finite element construct, again capable of being scaled to correspondence. The method also includes a scaling step 610, where the trainee and/or trainer constructs are scaled to correspond to each other on an image by image basis. The scaling adjusts corresponding features in the trainee images to corresponding features in the trainer images. For example, the trainee body is scaled to conform to the trainer body so that the movement of the trainee and trainer may be compared. As the images are capture over time, the scaling may include both spatial and temporal scaling. The method also includes a comparing step 612, where the scaled trainee and trainer constructs are compared on an image by image basis and where comparison is on a feature by feature basis as well. The method also includes a determining step 614, where differences between the features on an image by image basis are generated. The method also includes a overlaying step 616, where the scaled trainee construct onto the scaled trainer construct on an image by image basis. The method also includes a displaying step 618, where the overlaid scaled constructs are displayed on a display device so show the difference between the trainee performing the training exercise and the trainer performing the training exercise. The method also includes a highlighting step 620, where the differences are displayed on the display device in a highlighted format (color, shade, pulsating, or other highlighting property) as the constructs are being displayed so that the trainee and/or trainer may see the differences. The method also includes a repeating step 622, where all of the steps are repeated until a stop function is invoked using an input device, which may be the same or different from the image capture device or the differences satisfy at least one completion criteria, where the criteria may comprise conformity or substantially conformity between the trainee scaled construct and the trainer scaled construct on an image by image basis and feature by feature basis or the at least one completion criteria comprise minimizing one, some or all of differences as evidenced by changes in the differences upon repeating the exercise being less than a minimal value, where the minimal value is less than or equal to a 5%, less than or equal to a 2.5%, less than or equal to a 2%, or less than or equal to a 1%. For example, if the training exercise is a golf swing, then the features may include the club and the body and the differences may include the club and hand placement, swing propagation, club angle changes, hand, arm, shoulder, back, hip and leg motion, and/or follow through. All such differences may be highlighted during the play back. By repeating the exercise, the trainee may correct the highlighted differences until the differences are below or completion criteria or minimized.

Referring now to FIGS. 7A-J, graphic representations of several embodiments of this disclosure are shown and described below. Looking at FIG. 7A, the systems, apparatuses, or interfaces and methods for implementing same include a display 702 displaying a plurality of selectable icons or objects A-JJ arranged in a column row configuration and an optional banner 704. Looking at FIG. 7B, the display 702 of FIG. 7A is shown where the eye tracking sensor senses eye movement that is discernibly towards a particular object or icon, here icon O. Looking at FIG. 7C, the display 702 of FIG. 7B is shown wherein icon O expands as the eye motion approaches and/or enters icon O and a microhold on, in, or at the enlarged icon O immediately activates icon O. Looking at FIG. 7D, the activated icon O is now shown surrounded by a plurality of attribute icon a-h, which may be selected and activated and/or adjusted after icon O selection using further eye movement toward and/or on, at, or in one of the attribute icons. Looking at FIG. 7E, the display of FIG. 7C is shown wherein icon O is expanded and a confirmation icon \textcircled{↑} is displayed in an upper right hand area, corner, or quadrant of icon O. Looking at FIG. 7F, the display 702 of FIG. 7E is shown, wherein the eye tracking sensor senses motion toward confirmation icon \textcircled{↑}. Looking at FIG. 7G, activation of icon O is shown due to a microhold at, in, or on confirmation icon \textcircled{↑}. Looking at FIG. 7H, the display 702 of FIG. 7F is shown wherein a microhold at, in or on confirmation icon \textcircled{↑} causes a plurality of attribute objects a-c to be displayed to a left side of icon O. Looking at FIG. 7I, the display 702 of FIG. 7H is shown wherein the eye tracking sensor senses motion towards attribute c, which activates icon O with the attribute c invoked as shown in FIG. 7J. In all of FIG. 7B-J, the optional banner 704 contains information indicating which icon is being processed at any given time and is included simply as an optional secondary information feature.

Referring now to FIG. 8A-J, other graphic representations of several embodiments of this disclosure are shown and described below. Looking at FIG. 8A, a display 802 displays a plurality of selectable icons or objects A-O arranged in a column row configuration and an optional banner 804. Looking at FIG. 8B, the display 802 of FIG. 8A is shown wherein an eye tracking sensor senses eye movement towards a particular object or icon, icon G, where the movement is shown by an arrow headed path or line. Looking at FIG. 8C, the display 802 of FIG. 8B is shown wherein icon G expands as the eye movement approaches and/or enters icon G. Looking at FIG. 8D, the immediate activation of icon G is shown. Looking at FIG. 8E, the display 802 of FIG. 8C is shown wherein the eye tracking sensor senses motion from a center of icon G to a top portion of icon G, which acts to confirm the selection of icon G. Looking at FIG. 8F, the activation icon G is shown surrounded by attributes a-h. Looking at FIG. 8G, the display 802 of FIG. 8F is shown wherein eye tracking sensor senses motion toward attribute h, which activate attribute h or allows the adjustment of attribute h. Looking at FIG. 8H, the display 802 of FIG. 8E is shown wherein icon O is surrounded by attributes a-h. Looking at FIG. 8I, the display 802 of FIG. 8E is shown wherein eye tracking sensor senses motion towards attribute c. Looking at FIG. 8J, the activation icon G with the attribute c invoked is shown. In all of FIG. 8B-J, the banner 804 indicates which icon is being processed at any given time and is included simply as a secondary information feature and is optional.

Referring now to FIG. 9A-J, other graphic representations of several embodiments of this disclosure are shown and described below. Looking at FIG. 9A, a blank display 902 is shown. Looking at FIG. 9B, the display 902 of FIG. 9A is shown wherein an eye tracking sensor senses eye motion/movement above a threshold movement causing the display 902 to display a plurality of selectable icons or objects arranged in a circular configuration about a center of the display 902. Looking at FIG. 9C, the display 902 of FIG. 9B is shown wherein the eye tracking sensor senses eye movement from a center of the display 902 towards icon K. Looking at FIG. 9D, the immediate activation of icon K is shown. Looking at FIG. 9E, the display 902 of FIG. 9C is shown wherein icon K is expanded and centered surrounded by attribute icons a-h. Looking at FIG. 9F, the display 902 of FIG. 9E is shown wherein the eye tracking sensor senses eye motion/movement towards attribute b. Looking at FIG. 9G, the activation of icon K with attribute b invoked is shown. Looking at FIG. 9H, the display of FIG. 9C is shown, wherein icon K is shown surrounded by attribute icon a-h. Looking at FIG. 9I, the display 902 of FIG. 9G is shown wherein the eye tracking sensor senses eye motion/movement towards attribute b. Looking at FIG. 9J, the activation of icon K with the attribute b invoked is shown.

In alternate embodiments, the eye movement comprises a vector movements including speed and direction, and/or acceleration and direction, where all highlighting, selections, confirmation, activation, attribute value selection and confirmation and/or attribute adjustment all occur by simply analysis of eye movement. Additionally, in other embodiments, confirmation may also be performed by using movement of other body parts of an entity or object under control of an entity.

All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

1-28. (canceled)

29. A method, implemented on an apparatus comprising a processor, a display device, at least one motion sensor, an image capture device, and an input device, comprising:
capturing (a) trainee images or a trainee image sequence and trainer images and/or a trainer image sequence corresponding to a trainee and a trainer undertaking a specific task;
constructing (a) a trainee construct from the trainee images or the trainee image sequence on an image by image basis and on a feature by feature basis, and (b) a trainer construct from the trainer images or the trainer image sequence on an image by image basis and on a feature by feature basis;
scaling (a) the trainee construct on an image by image and on a feature by feature basis and (b) the trainer construct on an image by image and on a feature by feature basis so that the trainee and trainer constructs are spatially and temporally conformed to form a scaled trainee construct and a scaled trainer construct;
comparing the scaled trainee construct to the scaled trainer construct on an image by image basis and on a feature by feature basis;
determining differences between the scaled trainee construct and the scaled trainer construct on an image by image basis and on a feature by feature basis;
overlaying the scaled trainee construct onto the scaled trainer construct on an image by image basis; and
displaying the overlaid constructs on an image by image basis.

30. The method of claim 29, further comprising:
highlighting the differences on an image by image basis and on a feature by feature basis.

31. The method of claim 30, further comprising:
repeating the above steps until a stop function is invoked to stop the training exercise or the differences satisfy at least one completion criteria.

32. The method of claim 31, wherein the at least one completion criteria comprises conformity or substantially conformity between the trainee scaled construct and the trainer scaled construct on an image by image basis or the at least one completion criteria comprise minimizing one, some or all of differences as evidenced by changes in the differences upon repeating the exercise being less than a minimal value, where the minimal value is less than or equal to a 5%, less than or equal to a 2.5%, less than or equal to a 2%, or less than or equal to a 1%.

33. The method of claim 32, wherein the start and stop functions may be activated by motion based processing, gesture based processing or a hard select processing.

34. An apparatus comprising:
a processing unit;
a display device;
an image capture device;
at least one motion sensor, and
an input device;
the apparatus configured to:
capture (a) trainee images or a trainee image sequence and trainer images and/or a trainer image sequence corresponding to a trainee and a trainer undertaking a specific task;
construct (a) a trainee construct from the trainee images or the trainee image sequence on an image by image basis and on a feature by feature basis, and (b) a trainer construct from the trainer images or the trainer image sequence on an image by image basis and on a feature by feature basis;
scale (a) the trainee construct on an image by image and on a feature by feature basis and (b) the trainer construct on an image by image and on a feature by feature basis so that the trainee and trainer constructs are spatially and temporally conformed to form a scaled trainee construct and a scaled trainer construct;
compare the scaled trainee construct to the scaled trainer construct on an image by image basis and on a feature by feature basis;
determine differences between the scaled trainee construct and the scaled trainer construct on an image by image basis and on a feature by feature basis;
overlay the scaled trainee construct onto the scaled trainer construct on an image by image basis; and
display the overlaid constructs on an image by image basis.

35. The apparatus of claim 34, wherein the apparatus is further configured to:
highlight the differences on an image by image basis and feature by feature basis.

36. The apparatus of claim 35, wherein the processor is further configured to:
repeat the construct, scale, compare, determine, overlay and display events until the stop function is invoked to stop the training exercise or the differences satisfy at least one completion criteria.

37. The apparatus of claim 36, wherein the at least one completion criteria comprises conformity or substantially conformity between the trainee scaled construct and the trainer scaled construct on an image by image basis or the at least one completion criteria comprise minimizing one, some or all of differences as evidenced by changes in the differences upon repeating the exercise being less than a minimal value, where the minimal value is less than or equal to a 5%, less than or equal to a 2.5%, less than or equal to a 2%, or less than or equal to a 1%.

38. The apparatus of claim 37, wherein the start and stop functions maybe activated by motion based processing, gesture based processing or a hard select processing.

39. The method of claim 29, wherein the trainee construct is a trainee tessellated construct and the trainer construct is a trainer tessellated construct and the scaled tessellated constructs correspond.

40. The method of claim 29, wherein the trainee construct is a trainee finite element construct and the trainer construct is a trainer finite element construct and the scaled finite element constructs correspond.

41. The apparatus of claim 45, wherein the trainee construct is a trainee tessellated construct and the trainer construct is a trainer tessellated construct and the scaled tessellated constructs correspond.

42. The apparatus of claim 45, wherein the trainee construct is a trainee finite element construct and the trainer construct is a trainer finite element construct and the scaled finite element constructs correspond.
